(19) United States
(12) Patent Application Publication
(10) Pub. No.: US 2026/0351284 A1
(43) Pub. Date: Nov. 5, 2026

(54) MAGNETIC RECORDING MEDIUM

(71) Applicant: Sony Group Corporation, Tokyo (JP)

(72) Inventors: Minoru YAMAGA, Tokyo (JP); Takahiro TAKAYAMA, Tokyo (JP)

(21) Appl. No.: 19/104,858

(22) PCT Filed: Sep. 7, 2023
(86) PCT No.: PCT/JP2023/032607

§ 371 Date: Dec. 12, 2025

(30) Foreign Application Priority Data
Sep. 29, 2022 (JP) 2022-155916

(51) Int. Cl. G11B 5/584; G11B 5/008

(52) U.S. Cl. CPC G11B 5/584; G11B 5/00813

(57) ABSTRACT

An object is to provide a tape-shaped magnetic recording medium capable of correcting a width change of the magnetic recording medium by adjusting a traveling tension of the magnetic recording medium even in a case where the magnetic recording medium is stored or travels in a high-temperature environment, and a cartridge including the tape-shaped magnetic recording medium.

A magnetic recording medium formed in a tape shape, the magnetic recording medium comprising a magnetic layer including a plurality of servo bands in which a plurality of servo patterns adjacent in a width direction is recorded, wherein
an absolute value of an average width change amount of the magnetic recording medium before and after being left still for 40 hours in an environment of a temperature of 50 °C and a relative humidity of 40% RH in a state where a tension of 0.55 N per ½ inch of a width of the magnetic recording medium is applied in a longitudinal direction is 170 ppm or less, and an average tension responsiveness to the tension in the longitudinal direction in the environment of a temperature of 50 °C and a relative humidity of 40% RH is 700 ppm/N or more, and
an average value of a difference between two adjacent servo band pitches over an entire length of the magnetic recording medium in the plurality of servo bands is 100 nm or less.

### TECHNICAL FIELD

The present technology relates to a magnetic recording medium.

### BACKGROUND ART

In recent years, a demand for archiving has increased, and a tape-shaped magnetic recording medium with high total capacity has been incorporated in a cloud system. Since a current tape-shaped magnetic recording medium has a narrower environmental temperature range for actual traveling and storage than a hard disk drive (HDD), a semiconductor memory, or the like, it is desired to expand the environmental temperature range for actual traveling and storage of the tape-shaped magnetic recording medium. When the tape-shaped magnetic recording medium can be used in a temperature environment similar to that of an HDD, a semiconductor memory, or the like, it is considered that a use range of the tape-shaped magnetic recording medium is greatly expanded.

In the tape-shaped magnetic recording medium, when a dimension in a width direction of the magnetic recording medium greatly changes due to an environmental change, off-track occurs, and it becomes difficult to secure stable recording/reproducing characteristics. Patent Document 1 proposes a tape-shaped magnetic recording medium capable of correcting a width change by adjusting tension in a longitudinal direction of the tape-shaped magnetic recording medium by a recording/reproducing device even when a dimension in a width direction of the tape-shaped magnetic recording medium changes due to an environmental change.

### CITATION LIST

### Patent Document

Patent Document 1: Japanese Patent Application Laid-Open No. 2020-173882

### SUMMARY OF THE INVENTION

### Problems to be Solved by the Invention

In the HDD, 50 °C is generally assumed as an upper limit temperature of the operation guarantee environment, but in the conventional tape-shaped magnetic recording medium, storage and traveling in such a high-temperature environment are not assumed. Even in Patent Document 1, storage and traveling in such a high-temperature environment are not assumed. For this reason, in a case where a conventional tape-shaped magnetic recording medium is stored or traveled in a high-temperature environment, a change of tape-shaped width exceeds a range that can be corrected by adjustment of a traveling tension, and there is a possibility that it becomes difficult to correct the width change.

In view of the above circumstances, an object of the present technology is to provide a tape-shaped magnetic recording medium capable of correcting a width change of the magnetic recording medium by adjusting a traveling tension of the magnetic recording medium even in a case where the magnetic recording medium is stored or travels in a high-temperature environment, and a cartridge including the tape-shaped magnetic recording medium.

### Solutions to Problems

The present technology provides a magnetic recording medium formed in a tape shape, the magnetic recording medium including a magnetic layer including a plurality of servo bands in which a plurality of servo patterns adjacent in a width direction is recorded,
in which an absolute value of an average width change amount of the magnetic recording medium before and after being left still for 40 hours in an environment of a temperature of 50 °C and a relative humidity of 40% RH in a state where a tension of 0.55 N per ½ inch of a width of the magnetic recording medium is applied in a longitudinal direction is 170 ppm or less, and
an average tension responsiveness to the tension in the longitudinal direction in the environment of a temperature of 50 °C and a relative humidity of 40% RH is 700 ppm/N or more, and
an average value of a difference between two adjacent servo band pitches over an entire length of the magnetic recording medium in the plurality of servo bands is 100 nm or less.

In the magnetic recording medium according to the present technology, the average tension responsiveness may be 715 ppm/N or more and 15000 ppm/N or less.

In the magnetic recording medium according to the present technology, the absolute value of the average width change amount may be 140 ppm or less.

The magnetic recording medium according to the present technology may further include a base, an underlayer, and a magnetic layer sequentially, in which the base may include polyesters.

In the magnetic recording medium according to the present technology, the polyesters may include at least one selected from the group consisting of polyethylene terephthalate and polyethylene naphthalate.

In the magnetic recording medium according to the present technology, an average thickness of the base may be 4.4 μm or less.

In the magnetic recording medium according to the present technology, the magnetic layer may include a vacuum thin film.

In the magnetic recording medium according to the present technology, the magnetic layer may include a coating film.

In the magnetic recording medium according to the present technology, the magnetic layer may include magnetic powder.

In the magnetic recording medium according to the present technology, the magnetic powder may include e iron oxide magnetic powder, hexagonal ferrite magnetic powder, or Co-containing spinel ferrite magnetic powder.

In the magnetic recording medium according to the present technology, an average thickness of the magnetic layer may be 90 nm or less.

In the magnetic recording medium according to the present technology, an average thickness of the underlayer may be 1.0 μm or less.

In the magnetic recording medium according to the present technology, an average thickness of the magnetic recording medium may be 5.3 μm or less.

In the magnetic recording medium according to the present technology, a squareness ratio of the magnetic layer in the longitudinal direction of the magnetic recording medium may be 35% or less.

In the magnetic recording medium according to the present technology, the magnetic layer may include five or more servo bands.

In the magnetic recording medium according to the present technology, a width of each of the servo bands may be 98 μm or less.

In the magnetic recording medium according to the present technology, the magnetic layer may be configured to be able to form a plurality of data tracks, and a width of each of the data tracks may be 1100 nm or less.

In the magnetic recording medium according to the present technology, a Young's modulus may be 8 GPa or less.

The present technology provides a manufacturing method of a magnetic recording medium in which a plurality of servo patterns adjacent in a width direction of the magnetic recording medium is recorded on a magnetic layer of the magnetic recording medium, the manufacturing method of the magnetic recording medium including: running the magnetic recording medium, and individually adjusting temperatures of a plurality of recording sections of a servo write head; and
recording the plurality of servo patterns on the magnetic layer by the plurality of recording sections.

The present technology provides a cartridge including: the magnetic recording medium; and a storage section configured to be able to write adjustment information for adjusting a tension applied in a longitudinal direction of the magnetic recording medium.

### BRIEF DESCRIPTION OF DRAWINGS

FIG. 1 is an exploded perspective view illustrating an example of a configuration of a cartridge according to a first embodiment of the present technology.

FIG. 2 is a cross-sectional view illustrating an example of a configuration of a magnetic recording medium.

FIG. 3 is a schematic diagram of the magnetic recording medium described above as viewed from above (magnetic layer side).

FIG. 4 is an enlarged view illustrating recording tracks in a data band of the magnetic recording medium described above.

FIG. 5 is an enlarged view illustrating a part of a servo pattern written in a servo band of the magnetic recording medium described above.

FIG. 6 is a perspective view illustrating an example of a shape of a particle.

FIG. 7 is a diagram illustrating an example of a TEM photograph of a magnetic layer.

FIG. 8 is a diagram illustrating an example of a TEM photograph of a magnetic layer.

FIG. 9 illustrates a configuration of a measurement device.

FIG. 10 is a schematic diagram illustrating an example of a configuration of a tape drive device.

FIG. 11 is a schematic diagram of a drive head in the tape drive device described above as viewed from below (tape traveling surface).

FIG. 12 is a diagram illustrating a state when a first drive head part in the drive head described above performs recording/reproducing of a data signal.

FIG. 13(A) is a schematic plan view illustrating an arrangement example of servo patterns and FIG. 13(B) is a diagram illustrating a reproduction waveform thereof.

FIGS. 14(A) and 14(B) are schematic views illustrating configuration examples of a servo pattern in which first servo band identification information is embedded and a servo pattern in which second servo band identification information is embedded, respectively.

FIGS. 15(A) and 15(B) are diagrams illustrating a reproduction waveform of a first servo pattern and a reproduction waveform of a second servo pattern, respectively.

FIG. 16 is an explanatory diagram in which the drive head tracks the data band.

FIG. 17 is a diagram explaining a measurement method of a servo trace line.

FIG. 18 is a schematic front view illustrating a servo pattern recording device according to an embodiment of the present technology.

FIG. 19 is a partially enlarged view of a part of the servo pattern recording device described above.

FIG. 20 is a perspective view schematically illustrating a configuration of a servo write head in the servo pattern recording device described above.

FIG. 21 is a schematic cross-sectional view of a main part of the servo write head described above.

FIG. 22 is a schematic plan view of a main part of the servo write head described above.

FIG. 23 is a block diagram illustrating a configuration of a drive section in the servo pattern recording device described above.

FIGS. 24(A) and 24(B) are schematic diagrams illustrating a recording signal waveform of a first servo sub-frame in a first pulse signal and a recording signal waveform of a first servo sub-frame in a second pulse signal, respectively.

FIG. 25 is a perspective view schematically illustrating a pair of guide rollers that guides travel of a magnetic tape in the servo pattern recording device described above.

FIG. 26 is an experimental result illustrating comparison of servo band pitches of data bands measured for the same magnetic tape.

FIG. 27 is an experimental result illustrating a relationship between a magnitude of a recording current of the servo pattern and the servo band pitch.

FIG. 28 is an experimental result illustrating a relationship among the magnitude of the recording current, a temperature change of the servo write head, and the traveling time of the magnetic tape.

FIG. 29 is an experimental result illustrating a change in the servo band pitch when the recording current is alternately changed with a current value of −20%, of a reference current and a current value of +20% of the recording current.

FIG. 30 is a schematic perspective view illustrating a configuration of a servo write head including a blower unit.

FIG. 31 is an experimental result illustrating how the servo pattern pitch changes depending on whether a cooling gas (air) is introduced.

FIG. 32 is a diagram illustrating a maximum value (max) and a minimum value (min) of a servo band pitch which is an interval between two adjacent servo bands, and a difference (servo band pitch difference: SBD) between the maximum value and the minimum value, and is a result of an experiment performed without cooling the servo write head.

FIG. 33 is a diagram similar to FIG. 32, and is a result of an experiment performed while cooling the servo write head.

FIG. 34 is a diagram similar to FIG. 32, and is a result of another experiment performed while cooling the servo write head.

FIG. 35 is a schematic plan view of a servo write head including a plurality of groove portions.

FIG. 36 is an enlarged perspective view illustrating details of each of the groove portions.

FIG. 37 is a schematic plan view illustrating a modification of the configuration of the servo write head illustrated in FIG. 35.

FIG. 38 is a cross-sectional view illustrating an example of a configuration of a magnetic tape according to a second embodiment of the present technology.

FIG. 39 is a schematic diagram illustrating a configuration of a sputtering device.

FIG. 40 is a cross-sectional view illustrating an example of a configuration of a magnetic tape according to a third embodiment of the present technology.

FIG. 41 is an exploded perspective view illustrating an example of a configuration of a cartridge according to a modification of the first embodiment of the present technology.

FIG. 42 is a graph illustrating a measurement result of a width change amount of a magnetic tape according to Example 1.

FIG. 43 is a graph illustrating a width change amount assuming 10 years in each of Examples and Comparative Examples.

FIG. 44 is a schematic diagram for explaining a calculation method of a movement angle of a drive head disposed in an inclined manner.

### MODE FOR CARRYING OUT THE INVENTION

Hereinafter, preferred modes for implementing the present technology will be described. Note that embodiments hereinafter described are representative embodiments of the present technology, and the scope of the present technology is not limited only to these embodiments.

The present technology will be described in the following order.
First embodiment (Example of coating type magnetic tape)
(1) Configuration of cartridge
(2) Configuration of magnetic tape
(3) Manufacturing method of magnetic tape
(4) Configuration of tape drive device
(5) Configuration of servo pattern recording device
(6) Operation and effect
2. Second embodiment (Example of vacuum thin film type magnetic tape)
(1) Configuration of magnetic tape
(2) Configuration of sputtering device
(3) Manufacturing method of magnetic tape
(4) Operation and effect
3. Third embodiment (Example of vacuum thin film type magnetic tape)
(1) Configuration of magnetic tape
(2) Operation and effect
4. Modifications
5. Examples

In the present specification, in a case where a measurement method is described without a particular description of a measurement environment, the measurement is performed under an environment of 25 °C±2 °C and 50% RH±5% RH. Furthermore, in the present specification, a numerical value range indicated by using “from” indicates a range including numerical values described before and after “from” as the minimum value and the maximum value, respectively.

### 1. First Embodiment (Example of Coating Type Magnetic Tape)

### (1) Configuration of Cartridge

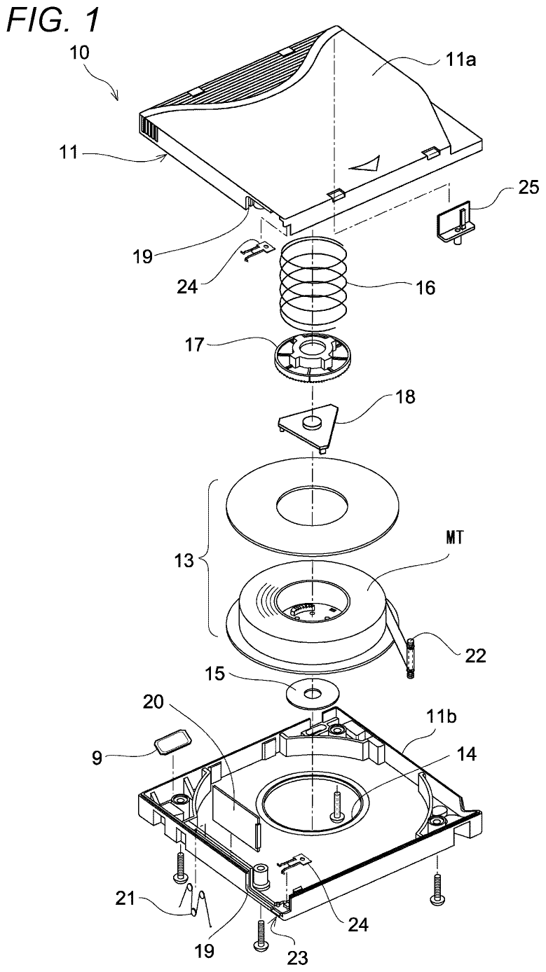

FIG. 1 is an exploded perspective view illustrating a tape cartridge 10 according to an embodiment of the present technology. In the description of the present embodiment, a tape cartridge conforming to the LTO standard will be described as an example of the tape cartridge 10.

As illustrated in FIG. 1, the tape cartridge 10 includes a cartridge case 11, a tape reel 13, and a magnetic tape MT. The cartridge case 11 is configured by coupling an upper shell 11a and a lower shell 11b with a plurality of screw members. A single tape reel 13 around which the magnetic tape MT is wound is rotatably accommodated inside the cartridge case 11.

A chucking gear (not illustrated) to be engaged with a spindle 31 (see FIG. 10) of the tape drive device is annularly formed at a bottom center of the tape reel 13. The chucking gear is exposed to the outside through an opening 14 formed at the center of the lower shell 11b. An annular metal plate 15 magnetically attracted to the spindle 31 is fixed to the inner peripheral side of the chucking gear.

A reel spring 16, a reel lock member 17, and a spider 18 are disposed between an inner surface of the upper shell 11a and the tape reel 13. Therefore, a reel lock mechanism that prevents the tape reel 13 from rotating when the cartridge 10 is not in use is configured.

A tape lead-out port 19 for leading out one end of the magnetic tape MT to the outside is provided in one side wall portion of the cartridge case 11. A slide door for opening and closing the tape lead-out port 19 is arranged inside the side wall portion. The slide door 20 is configured to slide in a direction of opening the tape lead-out port 19 against a biasing force of a torsion spring 21 by engagement with a tape loading mechanism (not illustrated) of the tape drive device 30.

A reader pin 22 is fixed to one end portion of the magnetic tape MT. The reader pin 22 is configured to be detachable from a pin holding portion 23 provided on the inner side of the tape lead-out port 19. The pin holding portion 23 includes an elastic holding tool 24 that elastically holds an upper end portion and a lower end portion of the reader pin 22 on the upper wall inner surface (the inner surface of the upper shell 11a) and the bottom wall inner surface (the inner surface of the lower shell 11b) of the cartridge case 11, respectively.

Then, in addition to a safety tab 25 for preventing erroneous erasure of information recorded on the magnetic tape MT, a cartridge memory 9 capable of reading and writing contents related to data recorded on the magnetic tape MT and information regarding the magnetic tape MT in a non-contact manner is disposed inside the other side wall of the cartridge case 11.

### (2) Configuration of Magnetic Tape

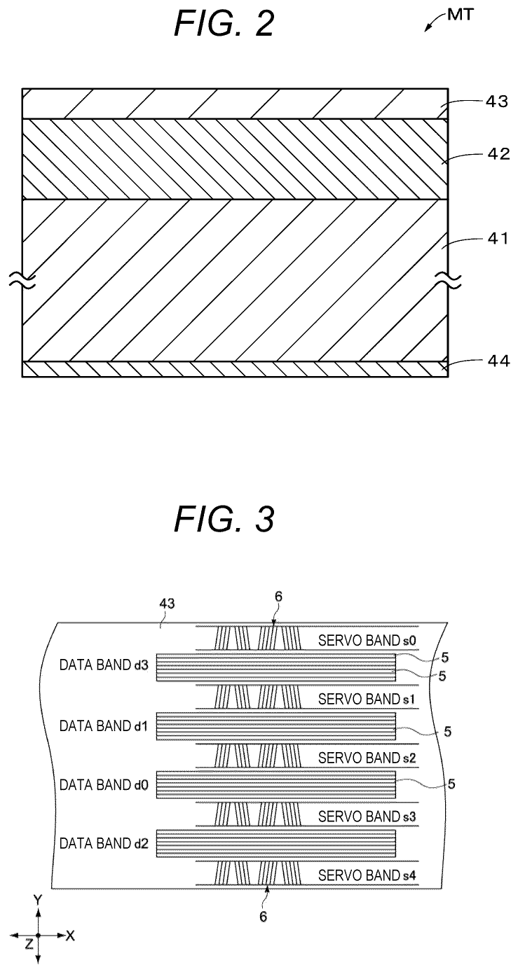

FIG. 2 is a cross-sectional view illustrating an example of a configuration of the magnetic tape MT. The magnetic tape MT is provided with an elongated base 41, an underlayer 42 provided on one principal surface (first principal surface) of the base 41, a magnetic layer 43 provided on the underlayer 42, and a back layer 44 provided on the other principal surface (second principal surface) of the base 41. Note that the underlayer 42 and the back layer 44 are provided as necessary and they are not necessarily provided. The magnetic tape MT may be a perpendicular recording type magnetic recording medium or may be a longitudinal recording type magnetic recording medium. The magnetic tape MT preferably contains a lubricant from the viewpoint of improving traveling performance. The lubricant may be contained in at least one of the underlayer 42 or the magnetic layer 43.

The magnetic tape MT may conform to the LTO standard, or may conform to a standard different from the LTO standard. The width of the magnetic tape MT may be ½ inches, or may be wider than ½ inches. In a case where the magnetic tape MT conforms to the LTO standard, the width of the magnetic tape MT is ½ inches. The magnetic tape MT may have a configuration in which the width of the magnetic tape MT can be kept constant or substantially constant by adjusting tension, applied in the longitudinal direction of the magnetic tape MT during traveling, by the recording/reproducing device (drive).

The magnetic tape MT has an elongated shape and runs in the longitudinal direction during recording and reproducing. The magnetic tape MT is preferably used in a recording/reproducing device provided with a ring head as a recording head. The magnetic tape MT is preferably used in a recording/reproducing device configured to be able to record data with a data track width of 1100 nm or less or 900 nm or less.

### [Base]

The base 41 is a nonmagnetic supporting body which supports the underlayer 42 and the magnetic layer 43. The base 41 has an elongated film shape. An upper limit value of an average thickness of the base 41 is for example 4.4 μm or less, preferably 4.2 μm or less, more preferably 4.0 μm or less, still more preferably 3.8 μm or less, particularly preferably 3.6 μm or less, and most preferably 3.4 μm or less. When the upper limit value of the average thickness of the base 41 is 4.4 μm or less, a recording capacity which may be recorded in one data cartridge may be increased as compared with that in a general magnetic tape. A lower limit value of the average thickness of the base 41 is preferably 3 μm or larger, and more preferably 3.2 μm or larger. When the lower limit value of the average thickness of the base 41 is 3 μm or larger, reduction in strength of the base 41 may be suppressed.

The average thickness of the base 41 is obtained as follows. First, the magnetic tape MT accommodated in the cartridge 10 is unwound, and the magnetic tape MT is cut out into a length of 250 mm from each of a range of 10 m to 20 m, a range of 30 m to 40 m, and a range of 50 m to 60 m in the longitudinal direction from a connection portion 21 between the magnetic tape MT and the reader tape LT to prepare three samples. In the present specification, the “longitudinal direction” in the case of the “longitudinal direction from the connection portion 21 between the magnetic tape MT and the reader tape LT” means a direction from one end on the reader tape LT side toward the other end on the opposite side.

Subsequently, layers (that is, the underlayer 42, the magnetic layer 43, and the back layer 44) other than the base 41 of each sample are removed by a solvent such as methyl ethyl ketone (MEK) or dilute hydrochloric acid. Next, a thickness of each sample (base 41) is measured in five positions using a laser holo gauge (LGH-110C) manufactured by Mitutoyo as a measurement device, and the measured values (a total of 15 sample thicknesses) are arithmetically averaged to calculate the average thickness of the base 41. Note that the five measurement positions described above are randomly selected from each sample so as to be different positions in the longitudinal direction of the magnetic tape MT.

The base 41 includes, for example, at least one of polyesters, polyolefins, cellulose derivatives, vinyl resins, or other polymer resins. In a case where the base 41 includes two or more of the above-described materials, the two or more materials may be mixed, copolymerized, or stacked.

The base 41 preferably contains polyesters among the polymer resins described above. When the base 41 contains polyesters, the storage elastic modulus E′ of the base 41 in the longitudinal direction can be reduced to preferably 9.0 GPa or less, more preferably 7.5 GPa or less, still more preferably 6.0 GPa or less, particularly preferably 5.5 GPa or less, and most preferably 4.5 GPa or less. Therefore, the width of the magnetic tape MT can be kept constant or substantially constant by adjusting the tension in the longitudinal direction of the magnetic tape MT during traveling by the recording/reproducing device.

The polyesters includes at least one of, for example, polyethylene terephthalate (PET), polyethylene naphthalate (PEN), polybutylene terephthalate (PBT), polybutylene naphthalate (PBN), polycyclohexylenedimethylene terephthalate (PCT), polyethylene-p-oxybenzoate (PEB), or polyethylene bisphenoxycarboxylate. In a case where the base 41 includes two or more polyesters, the two or more polyesters may be mixed, copolymerized, or stacked. At least one of the terminal or the side chain of the polyesters may be modified. Polyamide (PA) may be added to polyethylene terephthalate (PET) in order to improve the strength of the base 41.

The inclusion of polyesters in the base 41 is confirmed, for example, as follows. First, the magnetic tape MT accommodated in the cartridge 10 is unwound, and the magnetic tape MT is cut out from a range of 30 m to m in the longitudinal direction from the connection portion 21 between the magnetic tape MT and the reader tape LT to prepare a sample, and thereafter, layers other than the base 41 of the sample are removed. Next, an IR spectrum of the sample (base 41) is acquired by infrared absorption spectroscopy (IR). Based on this IR spectrum, it can be confirmed that polyesters are contained in the base 41.

The polyolefins include, for example, at least one of polyethylene (PE) or polypropylene (PP). The cellulose derivatives include, for example, at least one of cellulose diacetate, cellulose triacetate, cellulose acetate butyrate (CAB), or cellulose acetate propionate (CAP). The vinyl resins include, for example, at least one of polyvinyl chloride (PVC) or polyvinylidene chloride (PVDC), for example.

Other polymer resins include, for example, at least one of polyamide (PA, nylon), aromatic polyamide (aromatic PA, aramid), polyimide (PI), aromatic polyimide (aromatic PI), polyamide imide (PAI), aromatic polyamide imide (aromatic PAI), polybenzoxazole (PBO, for example, ZYLON (registered trademark)), polyether, polyether ketone (PEK), polyether ether ketone (PEEK), polyether ester, polyether sulfone (PES), polyether imide (PEI), polysulfone (PSF), polyphenylene sulfide (PPS), polycarbonate (PC), polyarylate (PAR), and polyurethane (PU).

The base 41 may be biaxially stretched in the longitudinal direction and the width direction. The polymer resin contained in the base 41 is preferably oriented in an oblique direction with respect to the width direction of the base 41.

### [Magnetic Layer]

The magnetic layer 43 is a recording layer for recording a signal by magnetization patterns. The magnetic layer 43 may be a coating film. The magnetic layer 43 may be a perpendicular recording type recording layer or may be a longitudinal recording type recording layer. The magnetic layer 43 includes, for example, magnetic powder, a binder, lubricant, and carbon. The magnetic layer 43 may further include at least one additive of an antistatic agent, an abrasive, a curing agent, a rust-preventive agent, nonmagnetic reinforcing particles, and the like as necessary. The magnetic layer 43 may have a surface having an uneven shape.

As illustrated in FIG. 3, the magnetic layer 43 has a plurality of data bands d (data bands d0 to d3) elongated in a longitudinal direction (X-axis direction) in which data is written and a plurality of servo bands s (servo bands s0 to s4) elongated in a longitudinal direction in which a servo pattern 6 is written. The servo bands s are arranged at positions at which each data band d is interposed therebetween in a width direction (Y-axis direction). Note that the magnetic layer 43 preferably has 5 or more servo bands s.

In the present technology, a ratio of an area of the servo bands s to an area of the entire surface of the magnetic layer 43 is typically 4.0 or less. Note that a width of the servo band s is a tape width of ½ inches, and is, for example, 98 μm or less. The ratio of the area of the servo bands s to the area of the entire surface of the magnetic layer 43 can be measured, for example, by developing the magnetic tape MT using a developer such as a ferricolloid developer or the like, and then observing the developed magnetic tape MT with an optical microscope.

In the example illustrated in FIG. 3, an example in a case where the number of data bands d is four and the number of servo bands s is five is illustrated. Note that the number of data bands d and the number of servo bands s can be appropriately changed.

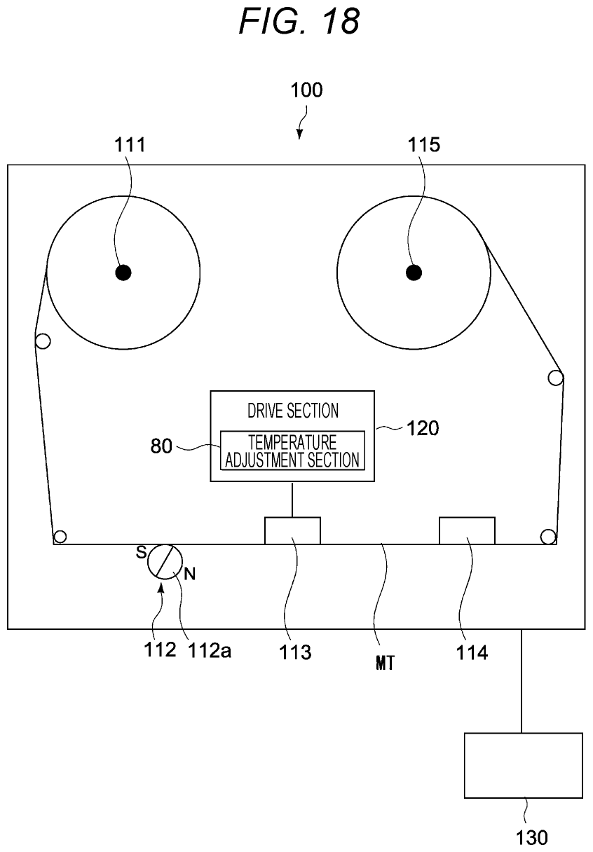

The data band d is long in the longitudinal direction and includes a plurality of recording tracks 5 aligned in the width direction. The number of recording tracks 5 included in one data band d is, for example, about 1,000 to 2,500. The data is recorded in the recording track 5 along the recording track 5. A 1-bit length of the data recorded in the data band d in the longitudinal direction is, for example, 48 nm or less. The servo band s includes a servo pattern 6 having a predetermined shape to be recorded by a servo pattern recording device (see FIG. 18) as described later.

Here, in the magnetic tape MT of the linear tape-open (LTO) standard, the number of recording tracks 5 is increased for each generation, and the recording capacity is dramatically improved. As an example, the number of recording tracks 5 is 384 in the primary LTO-1, and the numbers of recording tracks 5 are 512, 704, 896, 1,280, 2,176, 3,584, and 6,656 in order from LTO-2 to LTO-8, respectively. Similarly, the data recording capacity is 100 gigabyte (GB) in LTO-1, and the data recording capacities are 200 GB, 400 GB, 800 GB, 1.5 terabyte (TB), 2.5 TB, 6.0 TB, and 12 TB in order from LTO-2 to LTO-8, respectively.

In the present embodiment, the number of recording tracks 5 and the recording capacity are not particularly limited, and can be appropriately changed. However, for example, it is advantageous to apply the present technology to the magnetic tape MT that has the number of recording tracks 5 and the recording capacity are large (for example, 6656 or more, 12 TB or more: LTO-8 or later) and is susceptible to the influence of fluctuation in width of the magnetic tape MT. For example, a magnetic tape in which a Young's modulus (Young's modulus in a tape longitudinal direction) of the entire tape is 8 GPa or less is applied as the magnetic tape MT.

### [Data Band and Servo Band]

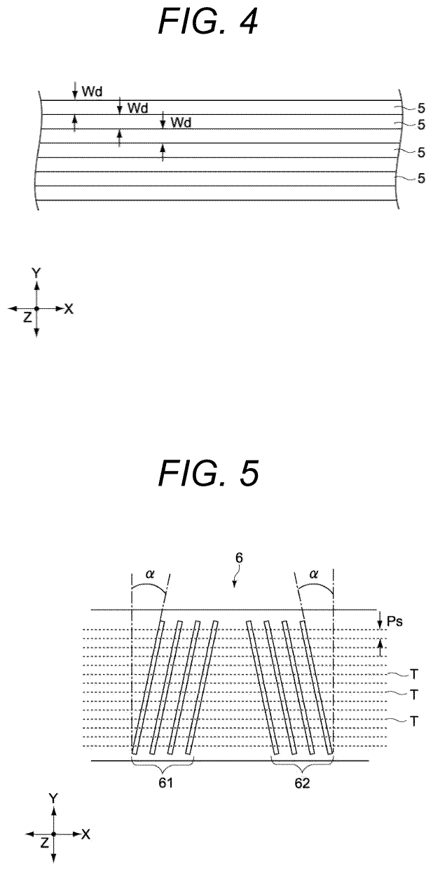

FIG. 4 is an enlarged view illustrating the recording tracks 5 in the data band d. As illustrated in FIG. 4, each of the recording tracks 5 is elongated in the longitudinal direction, is aligned in the width direction, and furthermore, has a predetermined recording track width (track pitch) Wd for each track in the width direction. The recording track width Wd is 2.0 μm or less in LTO-8. Note that such a recording track width Wd can be measured by, for example, developing the magnetic layer 43 of the magnetic tape MT using a developer such as a ferricolloid developer, and then observing the developed magnetic layer 43 of the magnetic tape MT with an optical microscope. Alternatively, as a measurement method using the drive head, the recording track width Wd can be measured from an output change in a case where the drive head is set to the Read While Write (reproduction at the time of recording) state and Azimuth of the drive head is changed in order to ignore the fluctuation during running of the tape. (IEEE_Sept1996_Crosstrack Profiles of Thin Film MR Tape Heads Using the Azimuth Displacement Method)

FIG. 5 is an enlarged view illustrating a part of the servo pattern 6 written in the servo band s. As illustrated in FIG. 5, the servo pattern 6 includes a plurality of stripes inclined at a predetermined azimuth angle α with respect to the width direction (Y-axis direction), which will be described later in detail. The plurality of stripes is classified into a first stripe group 61 inclined clockwise with respect to the width direction (Y-axis direction) and a second stripe group 62 inclined counterclockwise with respect to the width direction. The first stripe group 61 and the second stripe group 62 typically include four or five stripes. Note that the shape and the like of the servo pattern 6 can be measured by, for example, developing the magnetic layer 43 of the magnetic tape MT using a developer such as a ferricolloid developer, and then observing the developed magnetic layer 43 of the magnetic tape MT with an optical microscope.

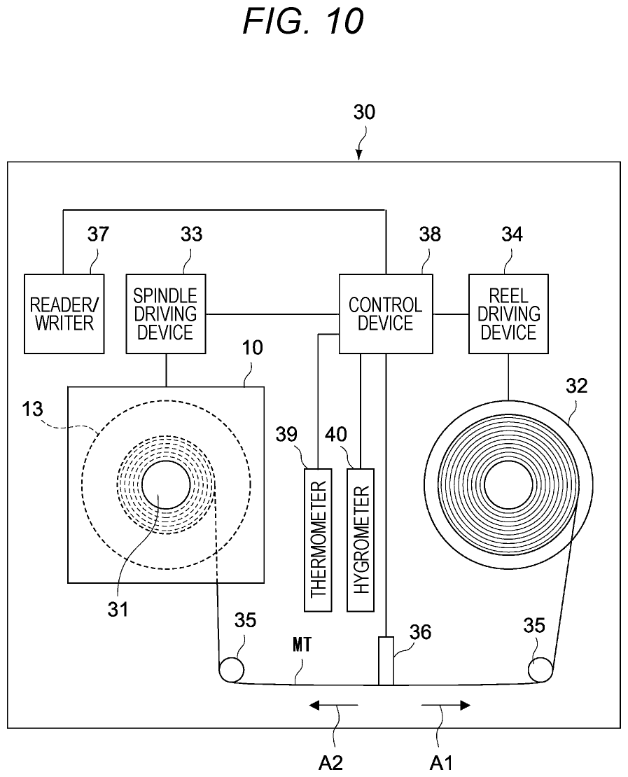

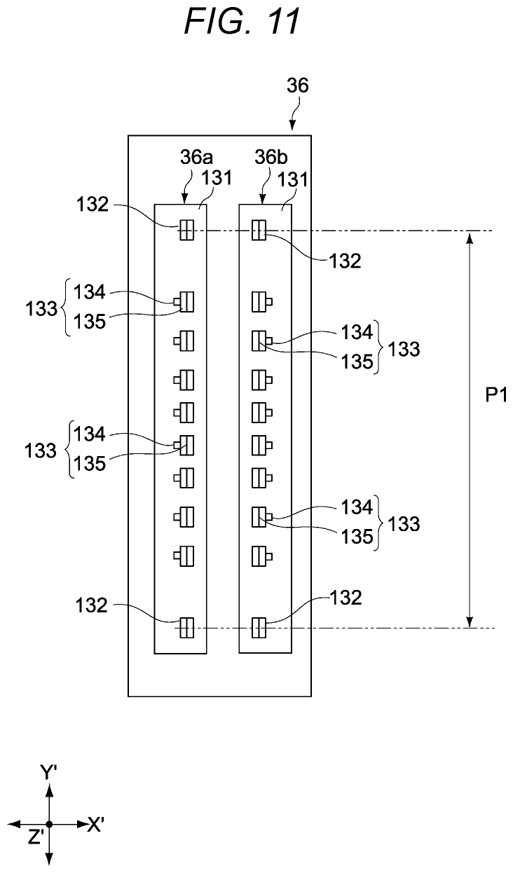

In FIG. 5, a servo trace line T which is a line traced by a servo read head 132 (see FIG. 11) as described later on the servo pattern 6 is indicated by a broken line. The servo trace line T is set in the longitudinal direction (X-axis direction) and is set at a predetermined interval Ps in the width direction.

The number of servo trace lines T per servo band s is, for example, about 30 to 60. An interval Ps between two adjacent servo trace lines T is the same as a value of the recording track width Wd, and is, for example, 2.0 μm or less. Here, the interval Ps between the two adjacent servo trace lines T is a value that determines the recording track width Wd. That is, when the interval Ps between the servo trace lines T is narrowed, the data recording track width Wd is decreased, and the number of recording tracks 5 included in one data band d is increased. As a result, the data recording capacity is increased.

An upper limit value of an average thickness of the magnetic layer 43 is preferably 90 nm or less, more preferably 80 nm or less, still more preferably 70 nm or less, particularly preferably 60 nm or less, and most preferably 50 nm or less. When the upper limit value of the average thickness of the magnetic layer 43 is 90 nm or less, an influence of a demagnetizing field can be reduced in a case where a ring type head is used as a recording head, and therefore more excellent electromagnetic conversion characteristics can be obtained.

A lower limit value of the average thickness of the magnetic layer 43 is preferably 35 nm or more. When the lower limit value of the average thickness of the magnetic layer 43 is 35 nm or more, an output may be secured in a case where an MR type head is used as the reproducing head, and therefore more excellent electromagnetic conversion characteristics can be obtained.

The average thickness of the magnetic layer 43 is obtained as follows. First, the magnetic tape MT accommodated in the cartridge 10 is unwound, and the magnetic tape MT is cut out into a length of 250 mm from each of a range of 10 m to 20 m, a range of 30 m to 40 m, and a range of 50 m to 60 m in the longitudinal direction from a connection portion 21 between the magnetic tape MT and the reader tape LT to prepare three samples. Subsequently, each sample is processed by a FIB method or the like to perform thinning. In a case where the FIB method is used, formation of a carbon layer and a tungsten layer as protective films is performed as pre-processing for observing a TEM image of a cross section described below. The carbon layer is formed on a surface on the magnetic layer 43 side and a surface on the back layer 44 side of the magnetic tape MT by a vapor deposition method, and then the tungsten layer is further formed on the surface of the magnetic layer 43 by a vapor deposition method or a sputtering method. The thinning is performed in the length direction (longitudinal direction) of the magnetic tape MT. That is, a cross section parallel to both the longitudinal direction and the thickness direction of the magnetic tape MT is formed by the thinning.

The above-described obtained cross section of each thinned sample is observed with a transmission electron microscope (TEM) under the following conditions, and thus a TEM image of each thinned sample is obtained. Note that the magnification and the acceleration voltage may be appropriately adjusted according to the type of the device.
Device: TEM (H9000NAR manufactured by Hitachi, Ltd.)
Acceleration voltage: 300 kV
Magnification: 100,000 times

Next, the thickness of the magnetic layer 43 is measured at ten positions of each resulting thinned sample using the obtained TEM image of each thinned sample. Note that the ten measurement positions of each thinned sample are randomly selected from each sample so as to be different positions in the longitudinal direction of the magnetic tape MT. An average value obtained by arithmetically averaging the obtained measured values (the thicknesses of the magnetic layers 43 at thirty points in total) of each thinned sample is defined as an average thickness [nm] of the magnetic layer 43.

### [Magnetic Powder]

The magnetic powder includes a plurality of magnetic particles. The magnetic particles are, for example, particles containing a metal oxide (Hereinafter, the metal oxide particles are referred to as “metal oxide particles”). The metal oxide particles are, for example, particles containing hexagonal ferrite (hereinafter, referred to as “hexagonal ferrite particles”), particles containing epsilon-type iron oxide (ε-iron oxide) (hereinafter, referred to as “ε-iron oxide particles”), or particles containing Co-containing spinel ferrite (hereinafter, referred to as “cobalt ferrite particles”). The magnetic powder is preferably crystal oriented preferentially in the vertical direction of the magnetic tape MT. In the present specification, the vertical direction (thickness direction) of the magnetic tape MT means the thickness direction of the magnetic tape MT in a planar state.

### (Hexagonal Ferrite Particles)

The hexagonal ferrite particles have, for example, a plate-like shape such as a hexagonal plate-like shape or a columnar shape such as a hexagonal columnar shape (however, the thickness or height is smaller than the major axis of the plate surface or the bottom surface). In the present specification, the hexagonal plate-like shape includes a substantially hexagonal plate-like shape. The hexagonal ferrite preferably includes at least one of Ba, Sr, Pb, or Ca, and more preferably at least one of Ba or Sr. Specifically, the hexagonal ferrite may be, for example, barium ferrite or strontium ferrite. Barium ferrite may further include at least one of Sr, Pb, or Ca in addition to Ba. In addition to Sr, strontium ferrite may further include at least one of Ba, Pb, or Ca.

More specifically, the hexagonal ferrite has an average composition represented by general formula MFe₁₂O₁₉. M is at least one metal of Ba, Sr, Pb, or Ca, preferably at least one metal of Ba or Sr, for example. M may be a combination of Ba and one or more metals selected from a group of Sr, Pb, and Ca. Furthermore, M may be a combination of Sr and one or more metals selected from a group of Ba, Pb, and Ca. A part of Fe in the above-described general expression may be substituted with another metal element.

In a case where the magnetic powder includes hexagonal ferrite particles, the average particle size of the magnetic powder is preferably 13 nm or more and 22 nm or less, more preferably 13 nm or more and 19 nm or less, still more preferably 13 nm or more and 18 nm or less, particularly preferably 14 nm or more and 17 nm or less, and most preferably 14 nm or more and 16 nm or less. When the average particle size of the magnetic powder is 22 nm or less, more excellent electromagnetic conversion characteristics (for example, SNR) may be obtained in the magnetic tape MT of high recording density. On the other hand, when the average particle size of the magnetic powder is 13 nm or more, the dispersibility of the magnetic powder is further improved, and more excellent electromagnetic conversion characteristics (for example, SNR) can be obtained.

In a case where the magnetic powder includes a powder of hexagonal ferrite particles, an average aspect ratio of the magnetic powder can be preferably 1.0 or more and 3.0 or less, more preferably 1.5 or more and 2.8 or less, and still more preferably 1.8 or more and 2.7 or less. When the average aspect ratio of the magnetic powder is within a range of 1.0 or more and 3.0 or less, aggregation of the magnetic powder can be suppressed. Furthermore, when the magnetic powder is vertically oriented in a process of forming the magnetic layer 43, resistance applied to the magnetic powder can be suppressed. Therefore, vertical orientation of the magnetic powder may be improved.

In a case where the magnetic powder includes a hexagonal ferrite particle powder, the average particle size and the average aspect ratio of the magnetic powder are determined as follows. First, the magnetic tape MT accommodated in the cartridge 10 is unwound, and the magnetic tape MT is cut out from a range of 30 m to 40 m in the longitudinal direction from the connection portion 21 between the magnetic tape MT and the reader tape LT. Subsequently, the cut out magnetic tape MT is processed by an FIB method or the like to be thinned. In a case where the FIB method is used, formation of a carbon layer and a tungsten layer as protective films is performed as pre-processing for observing a TEM image of a cross section described below. The carbon layer is formed on a surface on the magnetic layer 43 side and a surface on the back layer 44 side of the magnetic tape MT by a vapor deposition method, and then the tungsten layer is further formed on the surface of the magnetic layer 43 by a vapor deposition method or a sputtering method. The thinning is performed in the length direction (longitudinal direction) of the magnetic tape MT. That is, a cross section parallel to both the longitudinal direction and the thickness direction of the magnetic tape MT is formed by the thinning.

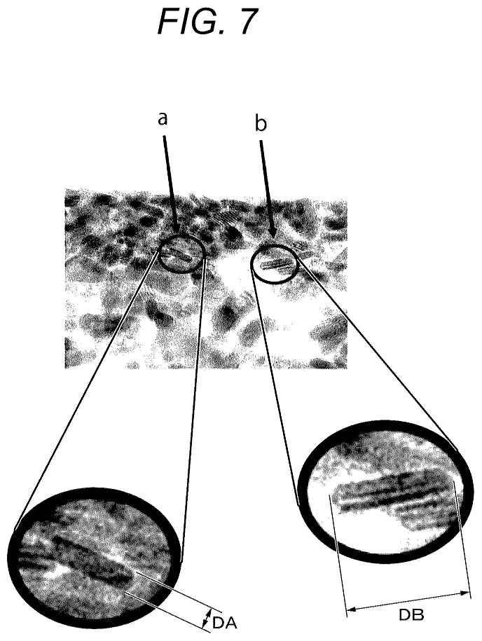

Using a transmission electron microscope (H-9500 manufactured by Hitachi High-Technologies Corporation), the above-described cross section of the obtained thin piece sample is observed at an acceleration voltage of 200 kV and a total magnification of 500,000 times so that the entire magnetic layer 43 is included in the thickness direction of the magnetic layer 43, and a TEM photo is imaged. The number of TEM photos prepared is such that 50 particles can be extracted in which the plate diameter DB and the plate thickness DA (see FIG. 7) shown below can be measured.

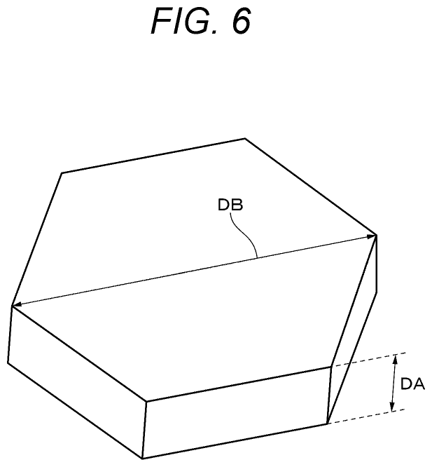

In the present specification, in a case where a particle observed in the TEM photo has a plate shape or a columnar shape as illustrated in FIG. 6 (note that the thickness or height is smaller than the long diameter of the plate surface or the bottom surface), the value of the long diameter of the plate surface or the bottom surface is a value of the plate diameter DB. The value of the thickness or height of the particle observed in the TEM photo is the value of the plate thickness DA. In a case where the thickness or height of one particle is not constant in the particle, the maximum thickness or height of the particle is the plate thickness DA.

Next, 50 particles to be extracted from the imaged TEM photo are selected according to the following criteria. A particle having a part out of the visual field of the TEM photo is not to be measured, and a particle having a clear outline and existing separately is to be measured. In a case where particles overlap, each particle is to be measured as a single particle when the boundary between the particles is clear and the entire shape of each particle can be determined, but a particle in which the boundary is not clear and the entire shape of the particle cannot be determined is not to be measured as the shape of the particle cannot be determined.

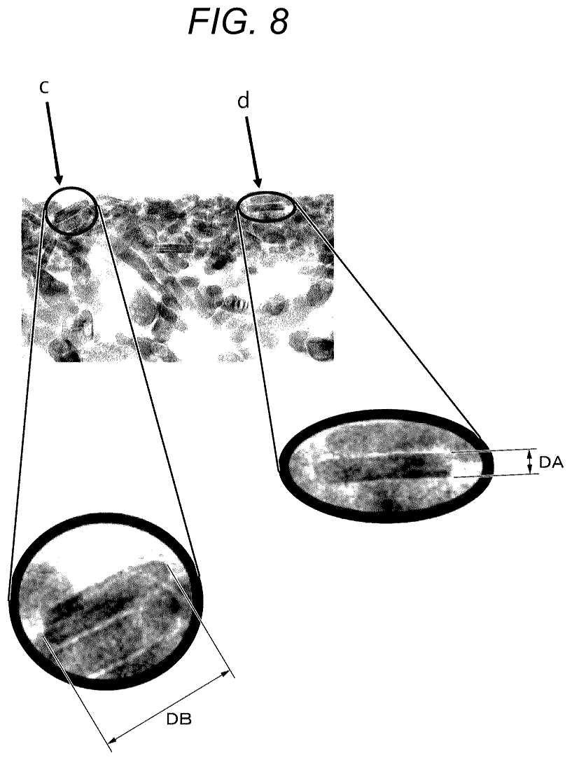

FIGS. 7 and 8 illustrate an example of a TEM photo. In FIGS. 7 and 8, for example, the particles indicated by arrows a and d are selected because the plate thickness (thickness or height of the particles) DA of the particles can be clearly confirmed. The plate thickness DA of each of the selected 50 particles is measured. The plate thicknesses DA thus obtained are arithmetically averaged to obtain an average plate thickness DAₐᵥₑ. The average plate thickness DAₐᵥₑ is an average particle plate thickness. Subsequently, the plate diameter DB of each magnetic powder is measured. In order to measure the plate diameter DB of the particles, 50 particles in which the plate diameter DB of each particle can be clearly recognized are selected from the imaged TEM photo. For example, in FIGS. 7 and 8, for example, the particles indicated by arrows b and c are selected because the plate diameter DB of the particles can be clearly confirmed. The plate diameter DB of each of the selected 50 particles is measured. The plate diameters DB thus obtained are simply averaged (arithmetically averaged) to obtain an average plate diameter DBₐᵥₑ. The average plate diameter DBₐᵥₑ is an average particle size. Then, an average aspect ratio (DBₐᵥₑ/DAₐᵥₑ) of the particle is obtained from the average plate thickness DA_{abv} and the average plate diameter DBₐᵥₑ.

In a case where the magnetic powder includes hexagonal ferrite particles, an average particle volume of the magnetic powder is preferably 500 nm³ or more and 2500 nm³ or less, more preferably 500 nm³ or more and 1600 nm³ or less, still more preferably 500 nm³ or more and 1500 nm³ or less, particularly preferably 600 nm³ or more and 1200 nm³ or less, and most preferably 600 nm³ or more and 1000 nm³ or less. When the average particle volume of the magnetic powder is 2500 nm³ or less, an effect similar to that in a case where the average particle size of the magnetic powder is 22 nm or less may be obtained. On the other hand, when the average particle volume of the magnetic powder is 500 nm³ or more, an effect similar to that in a case where the average particle size of the magnetic powder is 13 nm or more may be obtained.

The average particle volume of the magnetic powder is obtained as follows. First, as described above regarding the above-described method of calculating the average particle size of the magnetic powder, the average plate thickness DAₐᵥₑ and the average plate diameter DBₐᵥₑ are obtained. Next, an average volume V of the magnetic powder is obtained by the following formula.

$$[ Math . 1 ]$$

$$V = \frac{3 \sqrt{3}}{8} \times {DA}_{ave} \times {DB}_{ave} \times {DB}_{ave}$$

### [ε-Iron Oxide Particles]

The ε iron oxide particles are hard magnetic particles capable of obtaining a high coercive force even with fine particles. The ε iron oxide particles have a spherical shape or a cubic shape. In the present specification, the spherical shape includes a substantially spherical shape. Furthermore, the cubic shape includes a substantially cubic shape. Since the ε-iron oxide particles have the shape as described above, in a case where ε-iron oxide particles are used as the magnetic particles, a contact area between the particles in the thickness direction of the magnetic tape MT can be reduced and aggregation of the particles can be suppressed as compared with a case where barium ferrite particles having a hexagonal plate shape are used as magnetic particles. Therefore, dispersibility of the magnetic particles is increased, and a more excellent electromagnetic conversion characteristic (for example, a signal-to-noise ratio (SNR)) can thus be obtained.

The ε-iron oxide particles may have a structure of composite particles. More specifically, the ε-iron oxide particle includes an ε-iron oxide portion and a portion having soft magnetism or a portion having magnetism in which a saturation magnetization amount σs is higher than that of ε-iron oxide and a coercive force Hc is smaller than that of ε-iron oxide (hereinafter, referred to as a “portion having soft magnetism or the like”).

The ε-iron oxide portion contains ε-iron oxide. The ε-iron oxide contained in the ε-iron oxide portion preferably includes an ε-Fe₂O₃ crystal as a main phase, and more preferably includes a single-phase ε-Fe₂O₃.

The portion having soft magnetism and the like are in contact with at least a part of the ε-iron oxide portion. Specifically, the portion having soft magnetism and the like may partially cover the ε-iron oxide portion, and may partially cover an entire periphery of the ε-iron oxide portion.

The portion having soft magnetism (portion having magnetism in which the saturation magnetization amount σs is higher than that of ε-iron oxide and the coercive force Hc is smaller than that of ε-iron oxide) includes, for example, a soft magnetic material such as α-Fe, a Ni—Fe alloy, an Fe—Si—Al alloy, or the like. The α-Fe may be obtained by reducing the ε-iron oxide contained in the ε-iron oxide portion.

Furthermore, the portion having soft magnetism may contain, for example, Fe₃O₄, γ-Fe₂O₃, spinel ferrite, or the like.

The ε-iron oxide particle includes the portion having soft magnetism described above or the like, such that the coercive force Hc of the ε-iron oxide particles (composite particles) as a whole can be adjusted to a coercive force Hc suitable for recording while maintaining the coercive force Hc of the ε-iron oxide portion alone at a large value in order to ensure thermal stability.

The ε-iron oxide particle may contain an additive instead of the structure of the composite particles described above, or may have the structure of the composite particles and may contain an additive as well. In this case, a part of Fe of the ε-iron oxide particle is substituted with the additive. The coercive force Hc of all the ε-iron oxide particles can be adjusted to the coercive force Hc suitable for recording also when the ε-iron oxide particle includes the additive, so that the ease of recording can be improved. The additive is a metal element other than iron, preferably a trivalent metal element, more preferably at least one selected from the group consisting of Al, Ga, and In, and still more preferably at least one selected from the group consisting of Al and Ga.

Specifically, the ε-iron oxide containing the additive is an ε-Fe₂₋ₓMₓO₃ crystal (where M is a metal element other than iron, preferably a trivalent metal element, more preferably at least one selected from the group consisting of Al, Ga, and In, and still more preferably at least one selected from the group consisting of Al and Ga, and x is, for example, 0<x<1).

In a case where the magnetic particles are ε-iron oxide particles, an average particle size of the magnetic particles is preferably 10 nm or more and 20 nm or less, more preferably 10 nm or more and 18 nm or less, still more preferably 10 nm or more and 16 nm or less, particularly preferably 10 nm or more and 15 nm or less, and most preferably 10 nm or more and 14 nm or less. In the magnetic tape MT, a region having a size of ½ of a recording wavelength is an actual magnetization region. Therefore, a more excellent electromagnetic conversion characteristic (for example, SNR) can be obtained by setting the average particle size of the magnetic particles to half or smaller of the shortest recording wavelength. Accordingly, when the average particle size of the magnetic particles is 20 nm or less, in the magnetic tape MT having a high recording density (for example, the magnetic tape MT configured to be able to record a signal at the shortest recording wavelength of nm or less), a more excellent electromagnetic conversion characteristic (for example, SNR) can be obtained. On the other hand, when the average particle size of the magnetic particles is 10 nm or more, the dispersibility of the magnetic particles is further improved, and a more excellent electromagnetic conversion characteristic (for example, SNR) can be obtained.

In a case where the magnetic particles are ε-iron oxide particles, an average aspect ratio of the magnetic particles is preferably 1.0 or more and 3.0 or less, more preferably 1.0 or more and 2.5 or less, still more preferably 1.0 or more and 2.1 or less, and particularly preferably 1.0 or more and 1.8 or less. When the average aspect ratio of the magnetic particles is within the range of 1.0 or more and 3.0 or less, aggregation of the magnetic particles can be suppressed. Furthermore, when the magnetic particles are vertically oriented in a process of forming the magnetic layer 43, resistance applied to the magnetic particles can be suppressed. Therefore, vertical orientation of the magnetic particles can be improved.

In a case where the magnetic particles are ε-iron oxide particles, an average particle size and an average aspect ratio of the magnetic particles are determined as follows. First, the magnetic tape MT accommodated in the cartridge 10 is unwound, and the magnetic tape MT is cut out at a position of 30 m to 40 m in the longitudinal direction from the connection portion between the magnetic tape MT and the reader tape LT. Subsequently, the magnetic tape MT to be measured is processed by a focused ion beam (FIB) method or the like to be thinned. In a case where the FIB method is used, a carbon layer and a tungsten layer are formed as protective layers as a pre-treatment for observing a TEM image of a cross section described later. The carbon layer is formed on a surface on the magnetic layer 43 side and a surface on the back layer 44 side of the magnetic tape MT by a vapor deposition method, and then the tungsten layer is further formed on the surface of the magnetic layer 43 side by a vapor deposition method or a sputtering method. The thinning is performed in the length direction (longitudinal direction) of the magnetic tape MT. That is, a cross section parallel to both the longitudinal direction and the thickness direction of the magnetic tape MT is formed by the thinning.

Using a transmission electron microscope (H-9500 manufactured by Hitachi High-Technologies Corporation), the cross section described above of the obtained thin piece sample is observed at an acceleration voltage of 200 kV and a total magnification of 500,000 times so that the entire magnetic layer 43 is included in the thickness direction of the magnetic layer 43, and a TEM image is captured. Next, 50 particles whose shapes can be clearly confirmed are selected from the captured TEM image, and a long axis length DL and a short axis length DS of each particle are measured. Here, the long axis length DL means the largest one of the distances between two parallel lines drawn from all angles so as to be in contact with a contour of each particle (so-called maximum Feret's diameter). Meanwhile, the short axis length DS means the largest one of the lengths of a particle in a direction orthogonal to the long axis (DL) of the particle. Subsequently, the measured long axis lengths DL of the 50 particles are simply averaged (arithmetically averaged) to determine the average long axis length DLₐᵥₑ. The average long axis length DLₐᵥₑ obtained as described above is defined as the average particle size of the magnetic particles. Furthermore, the measured short axis lengths DSs of the 50 particles are simply averaged (arithmetically averaged) to determine an average short axis length DSₐᵥₑ. Then, an average aspect ratio (DLₐᵥₑ/DSₐᵥₑ) of the particles is obtained from the average long axis length DLₐᵥₑ and the average short axis length DSₐᵥₑ.

In a case where the magnetic particles are ε-iron oxide particles, an average particle volume of the magnetic particles is preferably 500 nm³ or more and 4000 nm³ or less, more preferably 500 nm³ or more and 3000 nm³ or less, still more preferably 500 nm³ or more and 2000 nm³ or less, particularly preferably 600 nm³ or more and 1600 nm³ or less, and most preferably 600 nm³ or more and 1300 nm³ or less. In general, since a noise of the magnetic tape MT is inversely proportional to a square root of the number of particles (that is, proportional to the square root of the particle volume), a more excellent electromagnetic conversion characteristic (for example, SNR) can be obtained by reducing the particle volume. Therefore, when the average particle volume of the magnetic particles is 4000 nm³ or less, similar to a case where the average particle size of the magnetic particles is 20 nm or less, a more excellent electromagnetic conversion characteristic (for example, SNR) can be obtained. On the other hand, when the average particle volume of the magnetic particles is 500 nm³ or more, the effect similar to that in a case where the average particle size of the magnetic particles is 10 nm or more is obtained.

In a case where the ε-iron oxide particle has a spherical shape, the average particle volume of the magnetic particles is determined as follows. First, the average long axis length DLₐᵥₑ is determined in a manner similar to the method of calculating the average particle size of the magnetic particles described above. Next, an average volume V of the magnetic particles is determined by the following formula.

V=(π/6)×DLₐᵥₑ³

In a case where the ε-iron oxide particle has a cubic shape, the average volume of the magnetic particles is determined as follows. First, the magnetic tape MT accommodated in the cartridge 10 is unwound, and the magnetic tape MT is cut out at a position of 30 m to 40 m in the longitudinal direction from the connection portion 21 between the magnetic tape MT and the reader tape LT. Subsequently, the cut out magnetic tape MT is processed by a focused ion beam (FIB) method or the like to be thinned. In a case where the FIB method is used, a carbon film and a tungsten thin film are formed as protective films as a pre-treatment for observing a TEM image of a cross section described later. The carbon film is formed on a surface on the magnetic layer 43 side and a surface on the back layer 44 side of the magnetic tape MT by a vapor deposition method, and then the tungsten thin film is further formed on the surface on the magnetic layer 43 side by a vapor deposition method or a sputtering method. The thinning is performed in the length direction (longitudinal direction) of the magnetic tape MT. That is, a cross section parallel to both the longitudinal direction and the thickness direction of the magnetic tape MT is formed by the thinning.

Using a transmission electron microscope (H-9500 manufactured by Hitachi High-Technologies Corporation), the obtained thin piece sample is observed at an acceleration voltage of 200 kV and a total magnification of 500,000 times so that the entire magnetic layer 43 is included in the thickness direction of the magnetic layer 43, and a TEM image is obtained. Note that the magnification and the acceleration voltage may be appropriately adjusted according to the type of the device. Next, 50 particles whose shapes can be clearly confirmed are selected from the captured TEM image, and a side length DC of each particle is measured. Subsequently, the measured side lengths DC of the 50 particles are simply averaged (arithmetically averaged) to determine the average side length DCₐᵥₑ. Next, an average volume Vₐᵥₑ of the magnetic particles (particle volume) is determined from the following formula using the average side length DCₐᵥₑ.

Vₐᵥₑ=DCₐᵥₑ³

### [Cobalt Ferrite Particles]

The cobalt ferrite particle preferably has uniaxial crystal anisotropy. Since the cobalt ferrite particles have the uniaxial crystal anisotropy, the magnetic powder can be preferentially crystal-oriented in the vertical direction of the magnetic tape MT. The cobalt ferrite particle has, for example, a cubic shape. In the present specification, the cubic shape includes a substantially cubic shape. Co-containing spinel ferrite may further include at least one of Ni, Mn, Al, Cu, or Zn in addition to Co.

Co-containing spinel ferrite has, for example, an average composition represented by following formula:

CoₓM_{y}Fe₂O_{z}
(where, in the formula, M is, for example, at least one metal of Ni, Mn, Al, Cu, or Zn. x is a value within a range of 0.4≤x≤1.0. y is a value within a range of 0≤y≤0.3. However, x and y satisfy a relationship of (x+y)≤1.0. z is a value within a range of 3≤z≤4. A part of Fe may be substituted with another metal element.)

In a case where the magnetic powder includes cobalt ferrite particle powder, the average particle size of the magnetic powder is preferably 8 nm or more and 16 nm or less, more preferably 8 nm or more and 13 nm or less, and still more preferably 8 nm or more and 10 nm or less. When the average particle size of the magnetic powder is 16 nm or less, more excellent electromagnetic conversion characteristics (for example, SNR) can be obtained in the magnetic tape MT of high recording density. On the other hand, when the average particle size of the magnetic powder is 8 nm or more, the dispersibility of the magnetic powder is further improved, and more excellent electromagnetic conversion characteristics (for example, SNR) can be obtained. The method of calculating the average particle size of the magnetic powder is similar to the method of calculating the average particle size of the magnetic powder in a case where the magnetic powder includes ε-iron oxide particles.

In a case where the magnetic powder includes cobalt ferrite particle powder, the average aspect ratio of the magnetic powder is preferably 1.0 or more and 2.5 or less, more preferably 1.0 or more and 2.1 or less, and still more preferably 1.0 or more and 1.8 or less. When the average aspect ratio of the magnetic powder is within a range of 1.0 or more and 2.5 or less, aggregation of the magnetic powder can be suppressed. Furthermore, when the magnetic powder is vertically oriented in a process of forming the magnetic layer 43, resistance applied to the magnetic powder can be suppressed. Therefore, vertical orientation of the magnetic powder may be improved. The method of calculating the average aspect ratio of the magnetic powder is similar to the method of calculating the average aspect ratio of the magnetic powder in a case where the magnetic powder includes ε-iron oxide particle powder.

In a case where the magnetic powder includes a cobalt ferrite particle powder, the average particle volume of the magnetic powder is preferably 500 nm³ or more and 4000 nm³ or less, more preferably 600 nm³ or more and 2000 nm³ or less, and still more preferably 600 nm³ or more and 1000 nm³ or less. When the average particle volume of the magnetic powder is 4000 nm³ or less, an effect similar to that in a case where the average particle size of the magnetic powder is made 16 nm or less can be obtained. On the other hand, when the average particle volume of the magnetic powder is 500 nm³ or more, an effect similar to that in a case where the average particle size of the magnetic powder is 8 nm or more can be obtained. The method of calculating the average particle volume of the magnetic component is similar to the method of calculating the average particle volume in a case where the r-iron oxide particles have a cubic shape.

### [Binder]

Examples of the binder include a thermoplastic resin, a thermosetting resin, and a reactive resin. Examples of the thermoplastic resin include vinyl chloride, vinyl acetate, vinyl chloride-vinyl acetate copolymer, vinyl chloride-vinylidene chloride copolymer, vinyl chloride-acrylonitrile copolymer, acrylic acid ester-acrylonitrile copolymer, acrylic acid ester-vinyl chloride-vinylidene chloride copolymer, acrylic acid ester-acrylonitrile copolymer, acrylic acid ester-vinylidene chloride copolymer, methacrylic acid ester-vinylidene chloride copolymer, methacrylic acid ester-vinyl chloride copolymer, methacrylic acid ester-ethylene copolymer, polyvinyl fluoride, vinylidene chloride-acrylonitrile copolymer, acrylonitrile-butadiene copolymer, polyamide resin, polyvinyl butyral, cellulose derivative (cellulose acetate butyrate, cellulose diacetate, cellulose triacetate, cellulose propionate, nitrocellulose), styrene-butadiene copolymer, polyurethane resin, polyester resin, amino resin, synthetic rubber and the like.

Examples of the thermosetting resin include a phenol resin, an epoxy resin, a polyurethane curable resin, a urea resin, a melamine resin, an alkyd resin, a silicone resin, a polyamine resin, a urea formaldehyde resin and the like.

For the purpose of improving the dispersibility of the magnetic particles, polar functional groups such as —SO₃M, —OSO₃M, —COOM, P═O(OM)₂ (where M represents a hydrogen atom or an alkali metal such as lithium, potassium, or sodium), a side chain type amine having an end group represented by —NR1R2 or —NR1R2R3⁺X⁻, a main chain type amine represented by >NR1R2⁺X⁻ (where R1, R2, and R3 represent a hydrogen atom or a hydrocarbon group, and X− represents a halogen element ion such as fluorine, chlorine, bromine, or iodine, an inorganic ion, or an organic ion), —OH, —SH, —CN, and an epoxy group may be introduced into all the binders described above. An amount of these polar functional groups to be introduced into the binder is preferably 10⁻¹ mol/g or more and 10⁻⁸ mol/g or less, and more preferably 10⁻² mol/g or more and 10⁻⁶ mol/g or less.

### [Lubricant]

The lubricant contains, for example, at least one selected from fatty acid and fatty acid ester, preferably both fatty acid and fatty acid ester. The fact that the magnetic layer 43 contains a lubricant, in particular, the fact that the magnetic layer 43 contains both a fatty acid and a fatty acid ester contributes to improvement of traveling stability of the magnetic tape MT.

The fatty acid may be preferably a compound represented by the following general Formula (1) or (2). For example, one or both of the compound represented by the following general Formula (1) and the compound represented by the general Formula (2) may be contained as the fatty acid.

Moreover, the fatty acid ester may be preferably a compound represented by the following general Formula (3) or (4). For example, one or both of the compound represented by the following general Formula (3) and the compound represented by the general Formula (4) may be contained as the fatty acid ester.

With the lubricant including either one or both of a compound represented by the general Formula (1) and a compound represented by the general Formula (2) and either one or both of a compound represented by the general Formula (3) and a compound represented by the general Formula (4), an increase in dynamic frictional coefficient due to repeated recording or reproduction on the magnetic tape MT can be restrained.

CH₃(CH₂)ₖCOOH (1)
(where, in the general Formula (1), k is an integer selected from a range of 14 or more and 22 or less, and more preferably a range of 14 or more and 18 or less.)

CH₃(CH₂)ₙCH═CH(CH₂)ₘCOOH (2)
(where, in the general Formula (2), the sum of n and m is an integer selected from a range of 12 or more and 20 or less, and more preferably a range of 14 or more and 18 or less.)

CH₃(CH₂)ₚCOO(CH₂)_{q}CH₃ (3)

(Here, in the general Formula (3), p is an integer selected from a range of 14 or more and 22 or less, and more preferably a range of 14 or more and 18 or less, and q is an integer selected from a range of 2 or more and 5 or less, and more preferably a range of 2 or more and 4 or less.)

CH₃(CH₂)ᵣCOO—(CH₂)ₛCH(CH₃)₂ (4)
(where, in the general Formula (4), r is an integer selected from a range of 14 or more and 22 or less, and s is an integer selected from a range of 1 or more and 3 or less.)

CH₃(CH₂)ₜCOO—(CH)(CH₃)CH₂(CH₃)ᵤ (5)
(where, in the general Formula (5), t is an integer selected from a range of 14 or more and 22 or less, and u is an integer selected from a range of 1 or more and 3 or less.)

### [Carbon]

The carbon contained in the magnetic layer 43 may function as an antistatic agent, a lubricant, and the like. A part of carbon contained in the magnetic layer 43 is exposed from the surface of the magnetic layer 43. The irregularities on the surface of the magnetic layer 43 may include carbon, an abrasive, or the like.

The carbon is specifically carbon particles. The carbon particles include, for example, one or more selected from the group consisting of carbon black, acetylene black, Ketjen black, carbon nanotubes, and graphene.

### [Antistatic Agent]

Examples of the antistatic agent include natural surfactants, nonionic surfactants, and cationic surfactants.

### [Abrasive]

Examples of the abrasive includes α-alumina having an a conversion rate of 90% or more, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide prepared by subjecting a raw material of magnetic iron oxide to dehydration and an annealing treatment, materials obtained by subjecting these to a surface treatment with aluminum and/or silica, as required, and the like.

### [Curing Agent]

Examples of the curing agent include polyisocyanate and the like. Examples of the polyisocyanate include aromatic polyisocyanates such as an adduct of tolylene diisocyanate (TDI) and an active hydrogen compound, aliphatic polyisocyanates such as an adduct of hexamethylene diisocyanate (HMDI) and an active hydrogen compound, and the like. A weight average molecular weight of these polyisocyanates is desirably in a range of 100 or more and 3000 or less.

### [Rust-Preventive Agent]

Examples of the rust-preventive agent include phenols, naphthols, quinones, heterocyclic compounds containing a nitrogen atom, heterocyclic compounds containing an oxygen atom, heterocyclic compounds containing a sulfur atom, and the like.

### [Nonmagnetic Reinforcing Particle]

Examples of the nonmagnetic reinforcing particle include aluminum oxide (α, β, or γ alumina), chromium oxide, silicon oxide, diamond, garnet, emery, boron nitride, titanium carbide, silicon carbide, titanium carbide, titanium oxide (rutile type or anatase type titanium oxide), and the like.

### [Underlayer]

The underlayer 42 relaxes the irregularities on the surface of the base 41 and adjusts the irregularities on the surface of the magnetic layer 43. The underlayer 42 is a nonmagnetic layer including nonmagnetic powder, a binder, and a lubricant. The underlayer 42 supplies a lubricant to the surface of the magnetic layer 43. The underlayer 42 may further include at least one type of additive of an antistatic agent, a curing agent, a rust-preventive agent, and the like, as necessary.

An upper limit value of the average thickness of the underlayer 42 is preferably 1.0 μm or less, more preferably 0.9 μm or less, still more preferably 0.8 μm or less, particularly preferably 0.7 μm or less, and most preferably 0.6 μm or less. When the upper limit value of the average thickness of the underlayer 42 is 1.0 μm or less, since the thickness of the magnetic tape MT can be decreased, a recording capacity which may be recorded in one data cartridge can be increased. Furthermore, when the average thickness of the underlayer 42 is 1.0 μm or less, stretchability of the magnetic tape MT due to an external force further increases, so that adjustment of the width of the magnetic tape MT by tension adjustment is further facilitated. A lower limit value of the average thickness of the underlayer 42 is preferably 0.3 μm or more. When the lower limit value of the average thickness of the underlayer 42 is 0.3 μm or more, deterioration of the function as the underlayer 42 can be suppressed. Note that the average thickness of the underlayer 42 may be obtained in a manner similar to that of the average thickness of the magnetic layer 43. However, magnification of the TEM image is appropriately adjusted according to the thickness of the underlayer 42.

### [Nonmagnetic Powder]

The nonmagnetic powder includes, for example, at least any one of inorganic particle powder or organic particle powder. Furthermore, the nonmagnetic powder may include carbon powder such as carbon black. Note that one type of nonmagnetic powder may be used alone, or two or more types of nonmagnetic powders may be used in combination. The inorganic particle includes, for example, metal, metal oxide, metal carbonate, metal sulfate, metal nitride, metal carbide, metal sulfide and the like. A shape of the nonmagnetic powder may be, for example, various shapes such as a needle shape, a spherical shape, a cubic shape, a plate shape and the like, but is not limited these shapes.

### [Binder, Lubricant]

The binder and the lubricant are similar to that of the magnetic layer 43 described above.

### [Additive]

The antistatic agent, the curing agent, and the rust-preventive agent are each similar to those of the magnetic layer 43 described above.

### [Back Layer]

The back layer 44 includes a binder and nonmagnetic powder. The back layer 44 may further include at least one type of additive of a lubricant, a curing agent, an antistatic agent, and the like, as necessary. The binder and the nonmagnetic powder are similar to those of the underlayer 42 described above. The curing agent and the antistatic agent are similar to those of the magnetic layer 43 described above.

An average particle size of the nonmagnetic powder is preferably 10 nm or larger and 150 nm or smaller, and more preferably 15 nm or larger and 110 nm or smaller. The average particle size of the nonmagnetic powder is obtained in a manner similar to that of the average particle size of the magnetic powder described above. The nonmagnetic powder may also include the nonmagnetic powder having two or more particle size distribution.

An upper limit value of an average thickness of the back layer 44 is preferably 0.6 μm or smaller. When the upper limit value of the average thickness of the back layer 44 is 0.6 μm or less, the thicknesses of the underlayer 42 and the base 41 can be kept thick even in a case where the average thickness of the magnetic tape MT is 5.3 μm or less, so that the traveling stability of the magnetic tape MT in the recording/reproducing device can be maintained. A lower limit value of the average thickness of the back layer 44 is not especially limited; this is, for example, 0.2 μm or more.

The average thickness t_{b} of the back layer 44 is obtained as follows. First, an average thickness t_{T} of the magnetic tape MT is measured. The method of measuring the average thickness t_{T} is as described in the following “Average thickness of magnetic tape”. Subsequently, the magnetic tape MT accommodated in the cartridge 10 is unwound, and the magnetic tape MT is cut out into a length of 250 mm from each of a range of 10 m to 20 m, a range of 30 m to 40 m, and a range of 50 m to 60 m in the longitudinal direction from the connection portion 21 between the magnetic tape MT and the reader tape LT to prepare three samples. Next, the back layer 44 of each sample is removed with a solvent such as methyl ethyl ketone (MEK) or dilute hydrochloric acid. Next, a thickness of each sample is measured at five positions using a laser holo gauge (LGH-110C) manufactured by Mitutoyo Corporation, and these measured values (a total of 15 sample thicknesses) are arithmetically averaged to calculate an average value t_{B} [μm]. Thereafter, an average thickness t_{b} [μm] of the back layer 44 is obtained by the following formula. Note that the five measurement positions described above are randomly selected from each sample so as to be different positions in the longitudinal direction of the magnetic tape MT.

t_{b}[μm]=t_{T}[μm]−t_{B}[μm]

### [Average Width Change Amount ΔA]

The absolute value of the average width change amount ΔA of the magnetic tape MT before and after the magnetic tape MT is left standing for 40 hours in an environment at a temperature of 50 °C and a relative humidity of 40% RH in a state where a tension of 0.55 N per ½ inch of the width of the magnetic tape MT is applied in the longitudinal direction is 0 ppm or more and 170 ppm or less, preferably 0 ppm or more and 140 ppm or less, more preferably 0 ppm or more and 70 ppm or less, and still more preferably 0 ppm or more and 40 ppm or less. When the absolute value of the average width change amount ΔA of the magnetic tape MT exceeds 170 ppm, a creep change of the magnetic tape MT when the magnetic tape MT wound around the cartridge 10 is stored under a high-temperature environment for a long period of time and a creep change of the magnetic tape MT when the magnetic tape MT travels under a high-temperature environment for a long period of time become large. Therefore, the width change of the magnetic tape MT stored under a high-temperature environment for a long period of time in a state of being wound around the cartridge 10 and the width change of the magnetic tape MT traveling under a high-temperature environment for a long period of time exceed a range that can be corrected by adjusting the traveling tension in the longitudinal direction. Therefore, it is difficult to correct the width change by adjusting the traveling tension in the longitudinal direction. In the present specification, the high-temperature environment refers to an environment of 35 °C or higher and 50 °C or lower.

In a conventional magnetic tape, a shape change due to creep characteristics is large under a high-temperature environment. Therefore, it is difficult to correct the width change of the magnetic tape by adjusting the traveling tension of the magnetic tape. On the other hand, in the magnetic tape MT according to the first embodiment, since the absolute value of the average width change amount ΔA of the magnetic tape MT is 170 ppm or less, in addition to the deformation of the magnetic tape MT caused by the environment, the creep deformation under the high-temperature environment can be reduced. Therefore, the width change of the magnetic tape MT can be corrected by adjusting the traveling tension of the magnetic tape MT.

The absolute value of the average width change amount ΔA may be set to a desired value by selecting at least one of the base 41 and the underlayer 42. For example, the absolute value of the average width change amount ΔA may be set to a desired value by selecting at least one of the thickness of the base 41 and the material of the base 41. Furthermore, the absolute value of the average width change amount ΔA may be set to a desired value by adjusting the stretching strength in the width direction and the longitudinal direction of the base 41. Furthermore, the absolute value of the average width change amount ΔA may be set to a desired value by selecting the type of the magnetic layer 43 from the coating film and the sputtered film.

Furthermore, the absolute value of the average width change amount DA may be set to a desired value by including a strain relaxation step after the calendering step and before the cutting step, and adjusting the environmental temperature and the storage time in the strain relaxation step (for example, storage in an environment at a temperature of 65 °C for 48 hours). Furthermore, the absolute value of the average width change amount ΔA may be set to a desired value by including a strain relaxation step after the demagnetization step and before the servo pattern writing step, and adjusting the environmental temperature and the storage time in the strain relaxation step (for example, storage in an environment at a temperature of 55 °C for 48 hours).

Note that the absolute value of the average width change amount ΔA may be set to a desired value by selecting one of the plurality of selection examples described above, or the absolute value of the average width change amount ΔA may be set to a desired value by selecting two or more.

The average width change amount ΔA of the magnetic tape MT is obtained as follows. First, the ½ inch wide magnetic tape MT accommodated in the cartridge 10 is unwound, and the magnetic tape MT is cut out into a length of 250 mm from each of a range of 10 m to 20 m, a range of 30 m to 40 m, and a range of 50 m to 60 m in the longitudinal direction from the connection portion 21 between the magnetic tape MT and the reader tape LT to obtain three samples.

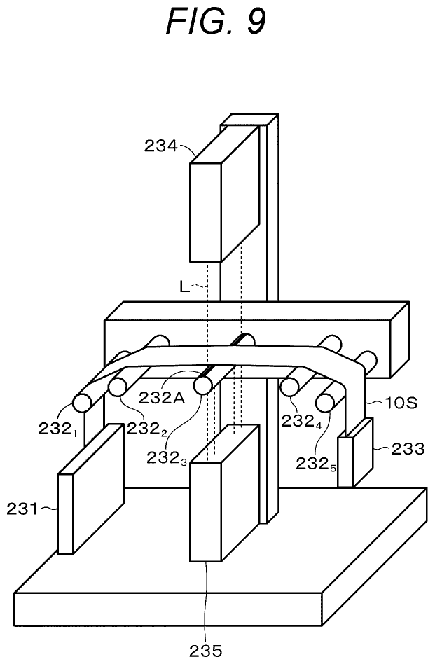

Next, the absolute values of the width change amounts ΔA of the three samples are obtained as follows. First, as a measurement device, a measurement device illustrated in FIG. 9 into which a digital dimension measurement instrument LS-7000 manufactured by Keyence Corporation is incorporated is prepared, and the sample 10S is set in the measurement device. Specifically, one end of the elongated sample (magnetic tape MT) 10S is fixed by a fixing part 231. Next, as illustrated in FIG. 9, the sample 10S is placed on five substantially cylindrical and rod-shaped support members 232₁ to 232₅. The sample 10S is placed on these support members 232₁ to 232₅ so that a back surface thereof is in contact with the five support members 232₁ to 232₅. The five support members 232₁ to 232₅ (particularly, surfaces thereof) all include stainless steel SUS304, and have a surface roughness Rz (maximum height) of 0.15 μm to 0.3 μm.

The arrangement of the five rod-shaped support members 232₁ to 232₅ will be described with reference to FIG. 9. As illustrated in FIG. 9, the sample 10S is placed on the five support members 232₁ to 232₅. Hereinafter, the five support members 232₁ to 232₅ are referred to as, starting from the side closest to the fixing part 231, a “first support member 232₁”, a “second support member 232₂”, a “third support member 232₃” (including a slit 232A), a “fourth support member 232₄”, and a “fifth support member 232₅” (closest to a weight 233). All of the five first to fifth support members 232₁ to 232₅ have a diameter of 7 mm. A distance d1 between the first support member 232₁ and the second support member 232₂ (in particular, a distance between the centers of these support members) is 20 mm. A distance d2 between the second support member 232₂ and the third support member 232₃ is 30 mm. A distance d3 between the third support member 232₃ and the fourth support member 232₄ is 30 mm. A distance d4 between the fourth support member 232₄ and the fifth support member 232₅ is 20 mm.

Furthermore, these three support members 232₂ to 232₄ are disposed so that portions of the sample 10S placed between the second support member 232₂, the third support member 232₃, and the fourth support member 232₄ form a substantially perpendicular plane with respect to the direction of gravity. Furthermore, the first support member 232₁ and the second support member 232 are disposed so that the sample 10S forms an angle of θ1=30° with respect to the substantially perpendicular plane between the first support member 232₁ and the second support member 232₂. Moreover, the fourth support member 232₄ and the fifth support member 232E are disposed so that the sample 10S forms an angle of θ2=30° with respect to the substantially perpendicular plane between the fourth support member 232₄ and the fifth support member 232₅. Furthermore, among the five first to fifth support members 232₁ to 232₅, the third support member 232₃ is fixed so as not to rotate, while the other four first, second, fourth and fifth support members 232₁, 232₂, 232₄, and 232₅ are all rotatable. Since the support member 232₃ is fixed so as not to rotate as described above, the contact angle between the support 232₃ and the sample 10S is made small in consideration of reduction of friction between the support 232₃ and the sample 10S.

The sample 10S is held on the support members 232₁ to 232₅ so as not to move in a width direction of the sample 10S. Note that, among the support members 232₁ to 232₅, the support member 232₃ located between a light emitter 234 and a light receiver 235 and located substantially at the center between the fixing part 231 and a portion at which a load is applied is provided with the slit 232A. Light L is radiated from the light emitter 234 to the light receiver 235 through the slit 232A. A slit width of the slit 232A is 1 mm and the light L may pass through the slit 232A, without being blocked by a frame of the slit 232A.

Subsequently, after the measurement device is accommodated in a chamber in a room temperature environment (temperature: 25 °C, relative humidity: 50% RH), a weight 233 for applying a load of 0.55 N per ½ inch of width of the sample 10S is attached to the other end of the sample 10S. That is, the load applied to the sample 10S is set to 0.55 N in a case where the width is ½ inches, and the load proportional to the width is set in a case where the width is not ½ inches. After attaching the weight 233, the sample 10S is allowed to stand in the room temperature environment for 30 minutes. After standing for 30 minutes, the temperature in the chamber is raised, and the measurement of the width of the sample 10S is started at the time when the inside of the chamber becomes a specified environment (temperature: 50 °C, relative humidity: 40% RH). The measurement of the width of the sample 10S is continued until more than 40 hours from the start of the measurement while maintaining the inside of the chamber in the specified environment (temperature: 50 °C, relative humidity: 40% RH).

In a state where a load of 0.55 N is applied in the specified environment, the light L is radiated from the light emitter 234 toward the light receiver 235, and the width of the sample 10S to which the load is applied in the longitudinal direction is measured. The measurement of the width is performed in a state where the sample 10S is not curled. The light emitter 234 and the light receiver 235 are provided in the digital dimension measurement instrument LS-7000.

Next, using the measurement result of the width of the sample 10S acquired as described above, the absolute value of the width change amount ΔA of the sample 10S after the lapse of 40 hours from the measurement start time point is calculated with reference to the width of the sample 10S after the lapse of 1 hour from the measurement start time point (that is, after a lapse of one hour from a time point at which the inside of the chamber becomes the prescribed environment,). That is, the absolute value of the width change amount LA of the sample 10S is obtained by subtracting the width of the sample 10S after 1 hour from the width of the sample 10S after 40 hours have elapsed. The positive or negative of the value of the width change amount ΔA of the sample 10S means the direction of the width change. In a case where the width change amount ΔA is positive, it indicates that the width of the sample 10S has changed in a direction of widening, and in a case where the width change amount ΔA is negative, it indicates that the width of the sample 10S has changed in a direction of narrowing. Next, the absolute values of the width change amounts ΔA of the three samples 10S calculated as described above are arithmetically averaged to obtain the absolute value of the average width change amount ΔA of the magnetic tape MT.

### [Average Tension Responsiveness ΔW]

The lower limit value of the average tension responsiveness ΔW to tension in the longitudinal direction under an environment of a temperature of 50 °C and a relative humidity of 40% RH is 700 ppm/N or more, preferably 715 ppm/N or more, more preferably 750 ppm/N or more, and still more preferably 800 ppm/N or more. If the average tension responsiveness ΔW is less than 700 ppm/N, since the average tension responsiveness ΔW in a high-temperature environment is low, it is difficult to correct the creep change of the magnetic tape MT when the magnetic tape MT wound around the cartridge 10 is stored in a high-temperature environment for a long period of time and the creep change of the magnetic tape MT when the magnetic tape MT travels in a high-temperature environment for a long period of time by adjusting the traveling tension. As described above, in the present specification, the high-temperature environment refers to an environment of 35 °C or higher and 50 °C or lower.

The upper limit value of the average tension responsiveness ΔW is preferably 20000 ppm/N or less, 15000 ppm/N or less, more preferably 8000 ppm/N or less, 5000 ppm/N or less, 4000 ppm/N or less, 3000 ppm/N or less, or 2000 ppm/N or less. When the average tension responsiveness ΔW is 15000 ppm/N or less, even in a case where there is a variation in the tension control of the recording/reproducing device, the amount of change in the width of the magnetic tape MT with respect to the variation can be reduced.

The average tension responsiveness ΔW may be set to a desired value by selecting at least one of the base 41 and the underlayer 42. For example, the average tension responsiveness ΔW may be set to a desired value by selecting at least one of the thickness of the base 41 and the material of the base 41. Furthermore, the average tension responsiveness ΔW may be set to a desired value by adjusting the stretching strength in the width direction and the longitudinal direction of the base 41. For example, the average tension responsiveness ΔW decreases by increasing the stretching of the base 41 in the width direction, and conversely, the average tension responsiveness ΔW increases by increasing the stretching of the base 41 in the longitudinal direction. Furthermore, the average tension responsiveness ΔW may be set to a desired value by selecting the type of the magnetic layer 43 from the coating film and the sputtered film.

Furthermore, the average tension responsiveness ΔW may be set to a desired value by including a strain relaxation step after the calendering step and before the cutting step, and adjusting the environmental temperature and the storage time in the strain relaxation step (for example, storage in an environment at a temperature of 65 °C for 48 hours). Furthermore, the average tension responsiveness ΔW may be set to a desired value by including a strain relaxation step after the demagnetization step and before the servo pattern writing step, and adjusting the environmental temperature and the storage time in the strain relaxation step (for example, storage in an environment at a temperature of 55 °C for 48 hours).

Note that the average tension responsiveness ΔW may be set to a desired value by selecting one of the plurality of selection examples described above, or the average tension responsiveness ΔW may be set to a desired value by selecting two or more.

The average tension responsiveness ΔW is obtained as follows. First, the magnetic tape MT accommodated in the cartridge 10 is unwound, and the magnetic tape MT is newly cut out into a length of 250 mm from each of a range of 10 m to 20 m, a range of 30 m to 40 m, and a range of 50 m to 60 m in the longitudinal direction from a connection portion 21 between the magnetic tape MT and the reader tape LT to prepare three samples. That is, when the average width change amount ΔA is measured, a sample different from the cut out sample is newly cut out. A measurement device used for the measurement is the same as that used for the measurement of the average width change amount ΔA of the magnetic recording medium described above.

Next, the tension responsiveness ΔW of the three samples is obtained as follows. Next, loads are applied in the order of 0.2 N, 0.6 N, and 1.0 N in the longitudinal direction of each of the samples 10S, and widths of the samples 10S at the loads of 0.2 N, 0.6 N, and 1.0 N are measured. Subsequently, the tension responsiveness ΔW is obtained from the following formula. Note that the measurement in a case where a load of 0.6 N is applied is performed in order to confirm whether or not an abnormality has not occurred in the measurement (particularly, in order to confirm that these three measurement results are linear), and the measurement result is not used in the following formula.

$$[ Math . 2 ]$$

$$Δ w [ ppm / N ] = \frac{D ( 0.2 N ) [ mm ] - D ( 1. N ) [ mm ]}{D ( 0.2 N ) [ mm ]} \times \frac{1 , 000 , 000}{( 1. [ N ] ) - ( 0.2 [ N ] )}$$

(Here, in the formula, D(0.2 N) and D(1.0 N) represent widths of the sample 10S when loads of 0.2 N and 1.0 N are applied in the longitudinal direction of the sample 10S, respectively.)

Next, the average tension responsiveness ΔW is obtained by arithmetically averaging the tension responsiveness ΔW of the three samples obtained as described above. Note that, in the above description, the value of the load applied to the sample 10S is a value in a case where the width of the magnetic tape MT (sample 10S) is ½ inches. In a case where the width of the magnetic tape MT (sample 10S) is not ½ inches, a load proportional to the width is applied. That is, the tension responsiveness ΔW of the three samples is obtained under the condition that a load proportional to the width is applied, and the average tension responsiveness ΔW is calculated by arithmetically averaging the tension responsiveness ΔW.

The width of the sample 10S when each load is applied is measured as follows. First, as a measurement device, a measurement device illustrated in FIG. 9 into which a digital dimension measurement instrument LS-7000 manufactured by Keyence Corporation is incorporated is prepared, and the sample 10S is set in the measurement device. The specific configuration of the measurement device is similar to the method for measuring the absolute value of the average width change amount ΔA. Furthermore, the procedure of the specific set of the sample 10S with respect to the measurement device is also similar to the method of measuring the absolute value of the average width change amount ΔA described above.

Subsequently, after the measurement device is accommodated in a chamber controlled at a constant environment of a temperature of 50 °C and a relative humidity of 40% RH, the weight 233 for applying a load of 0.2 N is attached to the other end of the sample 10S, and the sample 10S is allowed to stand in the environment described above for 2 hours. After standing for 2 hours, a width of the sample 10S is measured. Next, the weight for applying the load of 0.2 N is changed to a weight 233 for applying a load of 0.6 N, and the width of the sample 10S is measured 5 minutes after the change. Finally, the weight is changed to a weight 233 for applying a load of 1.0 N, and the width of the sample 10S is measured 5 minutes after the change.

As described above, the load applied in the longitudinal direction of the sample 10S may be changed by adjusting the weight of the weight 233. Note that when the width of the magnetic tape MT is not ½ inches, the load is adjusted in proportion to the width of the magnetic tape MT. In a state where each load is applied at the constant environment of a temperature of 50 °C and a relative humidity of 40% RH, light L is radiated from the light emitter 234 toward the light receiver 235, and the width of the sample 10S to which the load is applied in the longitudinal direction is measured. The measurement of the width is performed in a state where the sample 10S is not curled. The light emitter 234 and the light receiver 235 are provided in the digital dimension measurement instrument LS-7000.

### [Average Storage Elastic Modulus of Base in Longitudinal Direction]

An upper limit value of the average storage elastic modulus in the longitudinal direction of the base 41 in an environment at a temperature of 50 °C is preferably 9.0 GPa or less, more preferably 7.5 GPa or less, still more preferably 6.0 GPa or less, particularly preferably 5.5 GPa or less, and most preferably 4.5 GPa or less. When the upper limit value of the storage elastic modulus is 9.0 GPa or less, the stretchability of the magnetic tape MT against tension in the longitudinal direction increases under a high-temperature environment, so that the average tension responsiveness ΔW can be improved.

A lower limit value of the average storage elastic modulus in the longitudinal direction of the base 41 in an environment at a temperature of 50 °C is preferably 3.0 GPa or more, and more preferably 3.5 GPa or more. When the upper limit value of the storage elastic modulus is 3.0 GPa or more, it is possible to suppress excessive increase in stretchability of the magnetic tape MT against tension in the longitudinal direction. Therefore, a decrease in traveling stability can be suppressed.

The average storage elastic modulus of the magnetic tape MT in the longitudinal direction is a value indicating the difficulty of expansion and contraction of the magnetic tape MT in the longitudinal direction due to an external force. The larger this value, the more difficult the magnetic tape MT is expanded and contracted in the longitudinal direction due to the external force. The smaller this value, the easier the magnetic tape MT is expanded and contracted in the longitudinal direction due to the external force.

Note that the average storage elastic modulus of the magnetic tape MT in the longitudinal direction is a value relating to the magnetic tape MT in the longitudinal direction, and however, is correlated with the difficulty of expansion and contraction of the magnetic tape MT in the width direction. That is, the larger this value, the more difficult the magnetic tape MT is expanded and contracted in the width direction due to an external force. The smaller this value, the easier the magnetic tape MT is expanded and contracted in the width direction due to the external force. Therefore, from the viewpoint of tension adjustment, it is advantageous that the average storage elastic modulus of the magnetic tape MT in the longitudinal direction is small as described above and is 9.0 GPa or less.

The average storage elastic modulus in the longitudinal direction of the magnetic tape MT is obtained as follows. First, the ½ inch wide magnetic tape MT accommodated in the cartridge 10 is unwound, and the magnetic tape MT is punched to a specified size from each of a range of 10 m to 20 m, a range of 30 m to 40 m, and a range of 50 m to 60 m in the longitudinal direction from the connection portion 21 between the magnetic tape MT and the reader tape LT to obtain three samples. Next, the storage elastic modulus E′ in the longitudinal direction of the base 41 in an environment at a temperature of 50 °C is measured for each of the above three samples. Next, the average storage elastic modulus in the longitudinal direction of the base 41 in an environment at a temperature of 50 °C is obtained by arithmetically averaging the storage elastic moduli E′ of the measured three samples.

The storage elastic modulus E′ described above is measured by dynamic viscoelasticity measurement. The dynamic viscoelasticity measurement is temperature-dependent measurement, and is specifically performed as follows. The magnetic tape MT is punched by a punching device to obtain a sample having a length of 22.0 mm in the tape longitudinal direction and a width of 4.0 mm in the width direction. Both ends in the longitudinal direction of the sample are clamped by a measurement section of a dynamic viscoelasticity measurement device (RSAII, manufactured by TA Instruments). Then, the dynamic viscoelasticity measurement is performed under the following measurement conditions.
Measurement temperature range: −10 °C or higher and 140 °C or lower
Heating rate: 2 °C/min
Amplitude: expanded and contracted at an amplitude of 0.1% with respect to an initial length of the tape
Measurement frequency: 10 Hz
Test Type: “Strain-Controlled”
Measurement Type: “Dynamic”
Environment in which the device is placed: temperature 25 °C, relative humidity 50 RH %
Humidity control of measurement unit: none

More detailed settings regarding the measurement conditions of the device are as follows. That is, as described below, in the measurement, the tension is adjusted so that the tension does not become 0 or less, and the strain is adjusted so as not to fall below a lower limit value of a transducer. The measurement conditions for these adjustments may be appropriately set by those skilled in the art, but for example, the following settings may be adopted for the dynamic viscoelasticity measurement device described above.

### Option Settings

Delay Before Test: OFF
Auto Tension
Mode Static Force Tracking Dynamic Force
Auto Tension Direction Tension
Initial Static Force 10.0 g
Static>Dynamic Force by 5.0%
Minimum Static Force 1.0 g
Auto Tension Sensitivity 1.0 g
Auto Strain
Max Applied Strain 0.1%
Max Allowed Force 100.0 g
Min allowed Force 2.0 g
Strain Adjustment 3.0%
Meas Ops: Default setting

By performing the dynamic viscoelasticity measurement described above on the sample, a value of the storage elastic modulus E′ at each measurement temperature is obtained. A storage elastic modulus E′ at a measurement temperature of 50 °C is also obtained. Using the values of the storage elastic modulus E′ obtained at each measured temperature, the tendency of the change in storage elastic modulus E′ with temperature change can be read by plotting against the measured temperature.

The storage elastic modulus E′ of the magnetic tape MT can be adjusted, for example, by changing the type of material forming the base 41 and/or the composition of the magnetic layer 43, the underlayer 42, and the back layer 44 (in particular, the underlayer 42 which is often the thickest of these three layers) and combinations thereof.

For example, the storage elastic modulus E′ can be adjusted by using PEN, PET, or PEEK as a material for forming the base 41. Furthermore, the selection of these resins may change the shape of the graph plotting the storage elastic modulus E′ against temperature change.

Furthermore, for example, the storage elastic modulus E′ can be adjusted by changing the type of resin component contained in the coating material forming the magnetic layer 43, the underlayer 42, and the back layer 44 (particularly, the underlayer 42) and/or adjusting the resin composition. For example, the storage elastic modulus E′ can be adjusted by adjusting the glass transition temperature Tg of the binder that can be contained in these layers. From the viewpoint of ease of adjustment of the glass transition temperature Tg, the binder contains, for example, a polyurethane-based resin. More preferably, the underlayer 42 contains a polyurethane-based resin, which makes it easier to adjust the storage elastic modulus E′. Still more preferably, the glass transition temperature Tg of the polyurethane-based resin contained in the underlayer 42 is preferably °C or higher and 140 °C or lower, more preferably 30 °C or higher and 130 °C or lower, still more preferably 30 °C or higher and 120 °C or lower, and particularly preferably 55 °C or higher and 120 °C or lower. In a case where the glass transition temperature Tg is too low, there is a possibility that adhesion occurs during storage at a high temperature. In a case where the glass transition temperature Tg is too high, it may be difficult to treat with surface smoothing (calender).

### [Average Thickness of Magnetic Tape]

An upper limit value of the average thickness (average total thickness) t_{T} of the magnetic tape MT is preferably 5.3 μm or less, more preferably 5.1 μm or less, still more preferably 4.9 μm or less, particularly preferably 4.6 μm or less, and most preferably 4.4 μm or less. When the average thickness t_{T} of the magnetic tape MT is 5.3 μm or less, the recording capacity that can be recorded in one data cartridge can be increased as compared with a general magnetic tape. The lower limit value of the average thickness t_{T} of the magnetic tape MT is not particularly limited, and is, for example, 3.5 μm or more.

The average thickness t_{T} of the magnetic tape MT is obtained as follows. First, the magnetic tape MT accommodated in the cartridge 10 is unwound, and the magnetic tape MT is cut out into a length of 250 mm from each of a range of 10 m to 20 m, a range of 30 m to 40 m, and a range of 50 m to 60 m in the longitudinal direction from a connection portion 21 between the magnetic tape MT and the reader tape LT to prepare three samples. Next, a thickness of each sample is measured in five positions using a laser holo gauge (LGH-110C) manufactured by Mitutoyo as a measurement device, and the measured values (a total of 15 sample thicknesses) are arithmetically averaged to calculate the average thickness t_{T} [μm]. Note that the five measurement positions described above are randomly selected from each sample so as to be different positions in the longitudinal direction of the magnetic tape MT.

### [Arithmetic Average Roughness Rₐ of Surface of Magnetic Layer]

Arithmetic average roughness Rₐ of the surface of the magnetic layer 43 is 1.9 nm or less, preferably 1.6 nm or less, more preferably 1.3 nm or less. When the average value of the arithmetic average roughness Rₐ is 1.9 nm or less, a decrease in output due to spacing loss can be suppressed, and therefore excellent electromagnetic conversion characteristics can be obtained. A lower limit value of the arithmetic average roughness Rₐ of the surface of the magnetic layer 43 is preferably 1.0 nm or more, and more preferably 1.2 nm or more. When the lower limit value of the arithmetic average roughness Rₐ of the surface of the magnetic layer 43 is 1.0 nm or more, it is possible to suppress a decrease in traveling performance due to an increase in friction.

The average value of the arithmetic average roughness Rₐ is obtained as follows. First, the magnetic tape MT accommodated in the cartridge 10 is unwound, and the magnetic tape MT is cut out into a length of 250 mm from each of a range of 10 m to 20 m, a range of 30 m to 40 m, and a range of 50 m to 60 m in the longitudinal direction from a connection portion 21 between the magnetic tape MT and the reader tape LT to prepare three samples. Next, the surface of the magnetic layer 43 of each sample is observed with an atomic force microscope (AFM) to obtain an AFM image of 40 μm×40 μm. As the AFM, Nano Scope IIIa D3100 manufactured by Digital Instruments is used, and as the cantilever, a cantilever including silicon single crystal is used (Note 1). The measurement is performed by tuning from 200 Hz to 400 Hz as a tapping frequency. Next, each AFM image is divided into 512×512 (=262,144) measurement points, the height Z(i) (i: measurement point number, i=1 to 262,144) is measured at each measurement point, and the measured heights Z(i) at the measurement points are simply averaged (arithmetically averaged) to obtain an average height (average surface) Zₐᵥₑ(=(Z(1)+Z(2)+ . . . +Z(262,144))/262,144). Subsequently, a deviation Z″(i) (=Z(i)−Zₐᵥₑ) from the average center line at each measurement point is determined, and an arithmetic average roughness Rₐ [nm](=(Z″(1)+Z″(2)+ . . . +Z″(262,144))/262,144) is calculated. At this time, as the image processing, data obtained by performing filtering processing by Flatten order2 and planefit order 3 XY is used. (Note 1) SPM probe NCH normal type PointProbe L (cantilever length) manufactured by Nano World=125 μm

Next, the arithmetic mean roughness Rₐ of the three samples is arithmetically averaged to calculate an average value of the arithmetic mean roughness Rₐ.

### [Surface Roughness R_{b} of Back Surface]

An average value of the surface roughness R_{b} of the back surface (surface roughness of the back layer 44) preferably meets R_{b}≤6.0 [nm]. When the surface roughness R_{b} of the back surface is in the above range, more excellent electromagnetic conversion characteristics can be obtained.

The surface roughness R_{b} of the back surface is obtained as follows. First, the magnetic tape MT accommodated in the cartridge 10 is unwound, and the magnetic tape MT is cut out into a length of 100 mm from each of a range of 10 m to 20 m, a range of 30 m to 40 m, and a range of 50 m to 60 m in the longitudinal direction from the connection portion 21 between the magnetic tape MT and the reader tape LT to prepare three samples. Next, the sample is placed on a slide glass so that a surface to be measured (surface on the magnetic layer side) of the sample is oriented upwardly, and an end of the sample is fixed with a mending tape. The surface shape is measured using VertScan as a measurement device, and the surface roughness R_{b} of the back surface is obtained from the following formula on the basis of the standard of ISO 25178.

The measurement conditions are as follows.
Device: non-contact roughness meter using optical interference
(Non-contact surface/layer cross-sectional profile measurement system “VertScan R5500GL-M100-AC” manufactured by Ryoka Systems Inc.)
Objective lens: 20 times
Measurement region: 640×480 pixels (field of view: about 237 μm×178 μm field of view)
Measurement mode: phase
Wavelength filter: 520 nm
CCD: ⅓ inch
Noise removal filter: Smoothing 3×3
Surface correction: correction on quadratic polynomial approximated surface
Measurement software: VS-Measure Version 5.5.2
Analysis software: VS-viewer Version 5.5.5

$$[ Math . 3 ]$$

$${S}_{a} = \frac{1}{A} \int {\int }_{A} \vert Z ( x , y ) \vert dxdy$$

For each sample, after measuring the surface roughness at five points in the longitudinal direction of the magnetic tape MT as described above, an average value of arithmetic average roughnesses Sa (nm) automatically calculated from the surface profile obtained at each position is taken as the surface roughness R_{b} (nm) of the back surface. Note that the five measurement positions described above are randomly selected from each sample so as to be different positions in the longitudinal direction of the magnetic tape MT. Next, the surface roughness Rz obtained from the three samples is arithmetically averaged to calculate an average value of the surface roughness R_{b}.

### [Average Value of Coercive Force Hc2]

An upper limit value of an average value of the coercive force Hc2 of the magnetic layer 43 in the longitudinal direction of the magnetic tape MT is preferably 3000 Oe or less, more preferably 2000 Oe or less, still more preferably 1900 Oe or less, and particularly preferably 1800 Oe or less. When the average value of the coercive force Hc2 of the magnetic layer 43 in the longitudinal direction of the magnetic tape MT is 3000 Oe or less, sufficient electromagnetic conversion characteristics can be achieved even at a high recording density.

A lower limit value of the average value of the coercive force Hc2 of the magnetic layer 43 measured in the longitudinal direction of the magnetic tape MT is preferably 1000 Oe or more. When the average value of the coercive force Hc2 of the magnetic layer 43 measured in the longitudinal direction of the magnetic tape MT is 1000 Oe or more, it is possible to suppress demagnetization due to a leakage flux from the recording head.

The average value of the coercive force Hc2 described above is obtained as follows. First, the magnetic tape MT accommodated in the cartridge 10 is unwound, and the magnetic tape MT is cut out into a length of 250 mm from each of a range of 10 m to 20 m, a range of 30 m to 40 m, and a range of 50 m to 60 m in the longitudinal direction from a connection portion 21 between the magnetic tape MT and the reader tape LT. Three of the cut magnetic tapes MT are stacked with a double-sided tape such that the longitudinal directions of the magnetic tapes MT are the same, and then punched out with a punch of φ 6.39 mm to prepare a measurement sample. At this time, marking is performed with an arbitrary ink having no magnetism so that the longitudinal direction (traveling direction) of the magnetic tape MT can be recognized. Then, an M-H loop of the measurement sample (the entire magnetic tape MT) corresponding to the longitudinal direction (traveling direction) of the magnetic tape MT is measured using a vibrating sample magnetometer (VSM). Next, the coating film (underlayer 42, magnetic layer 43, back layer 44, and the like) of the magnetic tape MT cut out as described above is wiped off using acetone, ethanol, or the like, leaving only the base 41. Then, three sheets of the bases 41 obtained are stacked by use of a double-sided adhesive tape, and then punched out with a punch of φ 6.39 mm to prepare a sample for background correction (hereinafter referred to simply as “correction sample”). Thereafter, the M-H loop of the correction sample (base 41) corresponding to the longitudinal direction of the base 41 (longitudinal direction of the magnetic tape MT) is measured using the VSM.

In the measurement of the M-H loop of the measurement sample (the entire magnetic tape MT) and the M-H loop of the correction sample (the base 41), a high-sensitivity vibrating sample magnetometer “VSM-P7-15 model” manufactured by Toei Industry Co., Ltd. is used. The measurement conditions are measurement mode: full loop, maximum magnetic field: 15 kOe, magnetic field step: 40 bit, Time constant of Locking amp: 0.3 sec, Waiting time: 1 sec, and MH average number: 20.

After the M-H loop of the measurement sample (the entire magnetic tape MT) and the M-H loop of the correction sample (base 41) are obtained, the M-H loop of the correction sample (base 41) is subtracted from the M-H loop of the measurement sample (the entire magnetic tape MT), so that background correction is performed, and an M-H loop after the background correction is obtained. For calculation of the background correction, a measurement/analysis program attached to “VSM-P7-15 model” is used. The coercive force Hc2 is obtained from the obtained M-H loop after the background correction. Note that for this calculation, the measurement and analysis program attached to “VSM-P7-15 model” is used. Note that it is assumed that every measurement of the M-H loop described above is performed at 25 °C±2 °C and 50% RH±5% RH. Furthermore, it is assumed that “demagnetizing field correction” when measuring the M-H loop in the longitudinal direction of the magnetic tape MT is not performed. Next, the coercive forces Hc2 of the three samples are arithmetically averaged to calculate an average value of the coercive forces Hc2.

### [Average Value of Squareness Ratios S1 and S2]

An average value of the squareness ratio S1 of the magnetic layer 43 in the vertical direction of the magnetic tape MT is preferably 65% or more, more preferably 70% or more, still more preferably 75% or more, particularly preferably 80% or more, and most preferably 85% or more. When the average of the squareness ratio S1 is 65% or more, the vertical orientation of the magnetic powder is sufficiently high, so that more excellent electromagnetic conversion characteristics can be obtained.

The average value of the squareness ratio S1 of the magnetic tape MT in the vertical direction is obtained as follows. First, the magnetic tape MT accommodated in the cartridge 10 is unwound, and the magnetic tape MT is cut out into a length of 250 mm from each of a range of 10 m to 20 m, a range of 30 m to 40 m, and a range of 50 m to 60 m in the longitudinal direction from a connection portion 21 between the magnetic tape MT and the reader tape LT. Three of the cut magnetic tapes MT are stacked with a double-sided tape such that the longitudinal directions of the magnetic tapes MT are the same, and then punched out with a punch of φ 6.39 mm to prepare a measurement sample. At this time, marking is performed with an arbitrary ink having no magnetism so that the longitudinal direction (traveling direction) of the magnetic tape MT can be recognized. Then, the M-H loop of the measurement sample (the entire magnetic tape MT) corresponding to the vertical direction (thickness direction) of the magnetic tape MT is measured using a VSM. Next, the coating film (underlayer 42, magnetic layer 43, back layer 44, and the like) of the magnetic tape MT cut out as described above is wiped off using acetone, ethanol, or the like, leaving only the base 41. Then, three sheets of the bases 41 obtained are stacked by use of a double-sided adhesive tape, and then punched out with a punch of φ 6.39 mm to prepare a sample for background correction (hereinafter referred to simply as “correction sample”). Thereafter, the M-H loop of the correction sample (base 41) corresponding to the vertical direction of the base 41 (vertical direction of the magnetic tape MT) is measured using the VSM.

In the measurement of the M-H loop of the measurement sample (the entire magnetic tape MT) and the M-H loop of the correction sample (the base 41), a high-sensitivity vibrating sample magnetometer “VSM-P7-15 model” manufactured by Toei Industry Co., Ltd. is used. The measurement conditions are measurement mode: full loop, maximum magnetic field: 15 kOe, magnetic field step: 40 bit, Time constant of Locking amp: 0.3 sec, Waiting time: 1 sec, and MH average number: 20.

After the M-H loop of the measurement sample (the entire magnetic tape MT) and the M-H loop of the correction sample (base 41) are obtained, the M-H loop of the correction sample (base 41) is subtracted from the M-H loop of the measurement sample (the entire magnetic tape MT), so that background correction is performed, and an M-H loop after the background correction is obtained. For calculation of the background correction, a measurement/analysis program attached to “VSM-P7-15 model” is used.

The squareness ratio S1(%) is calculated by substituting saturation magnetization Ms (emu) and residual magnetization Mr (emu) of the obtained M-H loop after the background correction into the following formula. Note that it is assumed that every measurement of the M-H loop described above is performed at 25 °C±2 °C and 50% RH±5% RH. Furthermore, it is assumed that “demagnetizing field correction” when measuring the M-H loop in the vertical direction of the magnetic tape MT is not performed. Note that for this calculation, the measurement and analysis program attached to “VSM-P7-15 model” is used.

Squareness ratio S1(%)=(Mr/Ms)×100

Next, the squareness ratios S1 of the three samples are arithmetically averaged to calculate an average value of the squareness ratios Si.

An average value of the squareness ratio S2 of the magnetic layer 43 in the longitudinal direction (traveling direction) of the magnetic tape MT is preferably 35 or less, more preferably 30% or less, still more preferably 25% or less, especially preferably 20% or less, and most preferably 15% or less. When the average value of the squareness ratio S2 is 35% or less, the vertical orientation of the magnetic powder is sufficiently high, so that more excellent electromagnetic conversion characteristics can be obtained.

The average value of the squareness ratio S2 of the magnetic tape MT in the longitudinal direction is obtained in a manner similar to that of the squareness ratio S1 except that the M-H loop is measured in the longitudinal direction (traveling direction) of the magnetic tape MT and the base 41.

### [Average Young's Modulus of Magnetic Tape in Longitudinal Direction]

The upper limit value of the average Young's modulus of the magnetic tape MT in the longitudinal direction is preferably 9.0 GPa or less, more preferably 8.0 GPa or less, still more preferably 7.5 GPa or less, and particularly preferably 7.1 GPa or less. When the average Young's modulus of the magnetic tape MT in the longitudinal direction is 9.0 GPa or less, the stretchability of the magnetic tape MT due to an external force further increases, so that adjustment of the width of the magnetic tape MT by tension adjustment is further facilitated. Therefore, off-track can be more suitably suppressed, and data recorded on the magnetic tape MT can be more accurately reproduced. A lower limit value of the average Young's modulus of the magnetic tape MT in the longitudinal direction is preferably 3.0 GPa or more, and more preferably 4.0 GPa or more. When the lower limit value of the average Young's modulus of the magnetic tape MT in the longitudinal direction is 3.0 GPa or more, a decrease in traveling stability can be suppressed.

The average Young's modulus of the magnetic tape MT in the longitudinal direction is a value indicating the difficulty of expansion and contraction of the magnetic tape MT in the longitudinal direction due to an external force. The larger this value, the more difficult the magnetic tape MT is expanded and contracted in the longitudinal direction due to the external force. The smaller this value, the easier the magnetic tape MT is expanded and contracted in the longitudinal direction due to the external force.

Note that the average Young's modulus of the magnetic tape MT in the longitudinal direction is a value relating to the magnetic tape MT in the longitudinal direction, and however, is correlated with the difficulty of expansion and contraction of the magnetic tape MT in the width direction. That is, the larger this value, the more difficult the magnetic tape MT is expanded and contracted in the width direction due to an external force. The smaller this value, the easier the magnetic tape MT is expanded and contracted in the width direction due to the external force. Therefore, from the viewpoint of tension adjustment, it is advantageous that the average Young's modulus of the magnetic tape MT in the longitudinal direction is small as described above and is 9.0 GPa or less.

The average Young's modulus of the magnetic tape MT in the longitudinal direction is obtained as follows. First, the magnetic tape MT accommodated in the cartridge is unwound, and the magnetic tape MT is cut out into a length of 180 mm from each of a position of 10 m to 20 m, a position of 30 m to 40 m, and a position of 50 m to 60 m in the longitudinal direction from the connection portion 21 between the magnetic tape MT and the reader tape LT to obtain three samples. Next, the Young's modulus in the longitudinal direction of each of the three samples is measured, and the measured values are arithmetically averaged to obtain the average Young's modulus in the longitudinal direction of the magnetic tape MT.

The Young's modulus of each sample is measured as follows using a tensile tester (AG-100D manufactured by Shimadzu Corporation). A jig capable of fixing the tape width (½ inch) is attached to the tensile tester to fix the top and bottom of the tape width. The distance (length of the tape between chucks) is set to 100 mm. After chucking the data sample, stress is gradually applied in a direction (sample longitudinal direction) of pulling the sample. The tensile speed is 0.1 mm/min. The Young's modulus is calculated using the following formula on the basis of the change in stress and the amount of elongation at this time.

E(GPa)=((ΔN/S)/(Δx/L))×10⁻³
ΔN: change in stress (N)
S: cross-sectional area of test piece (mm²)
Δx: elongation amount (mm)
L: distance between gripping jigs (mm)

A cross-sectional area S of the measurement sample described above is a cross-sectional area before tensile operation, and is obtained by a product of the width (½ inch) of the measurement sample and the thickness of the measurement sample. For a range of tensile stress at the time of measurement, the range of the tensile stress in a linear region is set according to the thickness of the magnetic tape MT or the like. In this case, the stress range is 0.5 N to 1.0 N, and the change in stress (ΔN) and the amount of elongation (Δx) at this time are used for calculation. Note that the measurement of the Young's modulus described above is performed at 25 °C±2 °C and 50% RH±5% RH.

### [Average Young's Modulus of Base in Longitudinal Direction]

An average Young's modulus of the base 41 in the longitudinal direction is preferably 7.8 GPa or less, more preferably 7.0 GPa or less, still more preferably 6.6 GPa or less, and particularly preferably 6.4 GPa or less. When the average Young's modulus of the base 41 in the longitudinal direction is 7.8 GPa or less, the stretchability of the magnetic tape MT due to an external force further increases, so that adjustment of the width of the magnetic tape MT by tension adjustment is further facilitated. Therefore, off-track can be more suitably suppressed, and data recorded on the magnetic tape MT can be more accurately reproduced. A lower limit value of the average Young's modulus of the base 41 in the longitudinal direction is preferably 2.5 GPa or more, and more preferably 3.0 GPa or more. When the lower limit value of the average Young's modulus of the base 41 in the longitudinal direction is 2.5 GPa or more, the decrease in traveling stability can be suppressed.

The average Young's modulus of the base 41 described above in the longitudinal direction is obtained as follows. First, the magnetic tape MT accommodated in the cartridge 10 is unwound, and the magnetic tape MT is cut out into a length of 180 mm from each of a position of 10 m to 20 m, a position of 30 m to 40 m, and a position of 50 m to 60 m in the longitudinal direction from the connection portion 21 between the magnetic tape MT and the reader tape LT to prepare three samples. Subsequently, the underlayer 42, the magnetic layer 43, and the back layer 44 are removed from the cut out magnetic tape MT to obtain the base 41. Using the base 41 of these three samples, the average Young's modulus of the base 41 in the longitudinal direction is obtained in a similar procedure to the above-mentioned average Young's modulus of the magnetic tape MT described above in the longitudinal direction.

The thickness of the base 41 is half or more of the thickness of the entire magnetic tape MT. Therefore, the average Young's modulus of the base 41 in the longitudinal direction is correlated with the difficulty of expansion and contraction of the magnetic tape MT due to an external force. The larger this value, the more difficult the magnetic tape MT is expanded and contracted in the width direction due to the external force. The smaller this value, the easier the magnetic tape MT is expanded and contracted in the width direction due to the external force.

Note that the average Young's modulus of the base 41 in the longitudinal direction is a value relating to the magnetic tape MT in the longitudinal direction, and however, is correlated with the difficulty of expansion and contraction of the magnetic tape MT in the width direction. That is, the larger this value, the more difficult the magnetic tape MT is expanded and contracted in the width direction due to an external force. The smaller this value, the easier the magnetic tape MT is expanded and contracted in the width direction due to the external force. Therefore, from the viewpoint of tension adjustment, it is advantageous that the average Young's modulus of the base 41 in the longitudinal direction is small as described above and is 7.8 GPa or less.

### (3) Manufacturing Method of Magnetic Tape

Next, an example of a method of manufacturing the magnetic tape MT having the configuration described above will be described.

### [Step of Preparing Paint]

First, nonmagnetic powder, a binder, and the like are kneaded and dispersed in a solvent, to prepare an underlayer forming paint. Next, the magnetic powder, the binder, the lubricant and the like are kneaded and dispersed in the solvent to prepare a magnetic layer forming paint. For the preparation of the magnetic layer forming paint and the underlayer forming paint, for example, the following solvents, dispersing device, and kneading device can be used.

Examples of the solvent used for the paint preparation described above include, for example, ketone solvents such as acetone, methyl ethyl ketone, methyl isobutyl ketone, and cyclohexanone, alcohol solvents such as methanol, ethanol, and propanol, ester solvents such as methyl acetate, ethyl acetate, butyl acetate, propyl acetate, ethyl lactate, and ethylene glycol acetate, ether solvents such as diethylene glycol dimethyl ether, 2-ethoxyethanol, tetrahydrofuran, and dioxane, aromatic hydrocarbon solvents such as benzene, toluene, and xylene, halogenated hydrocarbon solvents such as methylene chloride, ethylene chloride, carbon tetrachloride, chloroform, and chlorobenzene. They may be used alone, or they may be mixed appropriately.

As the kneading device used for the paint preparation described above, for example, kneading devices such as a continuous two-axis kneader, a continuous two-axis kneader capable of diluting in multiple stages, a kneader, a pressure kneader, and a roll kneader may be used, but this is not especially limited to such devices. Furthermore, as the dispersing device used for the paint preparation described above, for example, dispersing devices such as a roll mill, a ball mill, a horizontal sand mill, a vertical sand mill, a spike mill, a pin mill, a tower mill, a pearl mill (for example, “DCP mill” manufactured by Eirich Co., Ltd. and the like), a homogenizer, and an acoustic wave dispersing device may be used, but it is not especially limited to these devices.

### [Applying Step]

Next, the underlayer forming paint is applied to one principal surface of the base 41 and dried to form the underlayer 42. Subsequently, the magnetic layer forming coating material is applied onto the underlayer 42 and dried to form the magnetic layer 43 on the underlayer 42. Note that, at the time of drying, magnetic powder is magnetically oriented in the thickness direction of the base 41 by, for example, a solenoid coil. Furthermore, at the time of drying, it is also possible to perform the magnetic field orientation of the magnetic powder in the thickness direction of the base 41 after the magnetic field orientation in the traveling direction (longitudinal direction) of the base 41 by, for example, the solenoid coil. By performing the treatment of temporarily orienting the magnetic powder in the longitudinal direction as described above, the degree of perpendicular orientation (that is, the squareness ratio S1) of the magnetic powder can be further improved. After the magnetic layer 43 is formed, the back layer 44 is formed on the other principal surface of the base 41. Therefore, the magnetic tape MT is obtained.

The squareness ratios S1 and S2 are, for example, set to desired values by adjusting strength of the magnetic field applied to the coating of the magnetic layer forming paint, concentration of a solid content in the magnetic layer forming paint, and a drying condition of the coating of the magnetic layer forming paint (drying temperature and drying time). The strength of the magnetic field applied to the coating is preferably twice and larger and three times or smaller of the coercive force of the magnetic powder. In order to further increase the squareness ratio S1 (that is, to further decrease the squareness ratio S2), it is preferable to improve the dispersion state of the magnetic powder in the magnetic layer forming paint. Furthermore, in order to further increase the squareness ratio S1, it is also effective to magnetize the magnetic powder at a stage before the magnetic layer forming paint enters an orienting device for performing the magnetic field orientation of the magnetic powder. Note that, the methods of adjusting the squareness ratios S1 and S2 may be used alone, or two or more methods may be used in combination.

### [Curing Step]

Next, after the magnetic tape MT is wound into a roll shape, the magnetic tape MT is heated in this state to cure the underlayer 42 and the magnetic layer 43.

### [Calendering Step]

Next, the obtained magnetic tape MT is subjected to calender treatment to smooth the surface of the magnetic layer 43.

### [Cutting Step]

Next, the magnetic tape MT is cut into a predetermined width (for example, ½ inch width).

Thus, the magnetic tape MT is obtained.

### [Demagnetization Step and Servo Pattern Writing Step]

Next, after demagnetization of the magnetic tape MT is performed as necessary, a plurality of servo patterns adjacent to each other in the width direction of the magnetic tape MT may be written on the magnetic layer 43 of the magnetic tape MT. Note that the magnetic tape MT may be caused to travel, temperatures of a plurality of recording units of the servo write head may be individually arranged, and a plurality of servo patterns may be written in the magnetic layer 43 by the plurality of recording units.

### (4) Configuration of Tape Drive Device

FIG. 10 is a diagram illustrating the tape drive device 30. The tape drive device 30 is a data recording/reproducing device capable of recording data on the magnetic tape MT or reproducing data recorded on the magnetic tape MT.

As illustrated in FIG. 10, the tape drive device 30 is configured to be able to load the cartridge 10. The tape drive device 30 is configured to be able to load one cartridge 10, but may be configured to be able to load a plurality of cartridges 10 at the same time.

The tape drive device 30 includes a spindle 31, a winding reel 32, a spindle driving device 33, a reel driving device 34, a plurality of guide rollers 35, a drive head 36, a reader/writer 37, and a control device 38. The tape drive device 30 may further include a thermometer 39, a hygrometer 40, and the like.

The spindle 31 has a head portion that engages with a chucking gear of a tape reel 13 via an opening 14 formed in a lower shell 11b of the cartridge 10. The spindle 31 raises the tape reel 13 by a predetermined distance against a biasing force of a reel spring 16 and releases a reel lock function by a reel lock member 17. Therefore, the tape reel 13 is rotatably supported inside a cartridge case 11 by the spindle 31.

The spindle driving device 33 rotates the spindle 31 according to a command from the control device 38. The winding reel 32 is configured to be able to fix a tip (reader pin 22) of the magnetic tape MT pulled out from the cartridge 10 via a tape loading mechanism (not illustrated).

The plurality of guide rollers 35 guides the traveling of the magnetic tape MT so that a tape bus formed between the magnetic recording cartridge 10 and the winding reel 32 has a predetermined relative positional relationship with respect to the drive head 36. The reel driving device 34 rotates the winding reel 32 according to a command from the control device 38.

When data is recorded/reproduced on the magnetic tape MT, the spindle 31 and the winding reel 32 are rotated by the spindle driving device 33 and the reel driving device 34, and the magnetic tape MT runs. As for the traveling direction of the magnetic tape MT, the magnetic tape MT can reciprocate in the forward direction (direction of unwinding from the tape reel 13 to the winding reel 32) indicated by the arrow A1 and the reverse direction (direction of rewinding from the winding reel 32 to the tape reel 13) indicated by the arrow A2 in FIG. 10.

Note that, in the present embodiment, the tension in the longitudinal direction (X-axis direction) of the magnetic tape MT at the time of data recording/reproduction can be adjusted by controlling the rotation of the spindle 31 by the spindle driving device 33 and the rotation of the winding reel 32 by the reel driving device 34. Note that the adjustment of the tension of the magnetic tape MT may be performed by control of the movement of the guide roller 35, a tension control unit including a dancer roller, or the like, instead of control of the rotation of the spindle 31 and the winding reel 32 (alternatively, in addition to the control).

The tension of the magnetic tape MT during traveling is typically set to the same value as the tension when the servo pattern 6 is recorded on the magnetic tape MT by a servo pattern recording device 100 as described later (hereinafter, also referred to as a reference tension). Furthermore, since the tape drive device 30 is configured to be able to adjust tension, it is also possible to cope with a change in the width dimension of the magnetic tape MT due to internal distortion of the magnetic tape MT or a change over time. Specifically, the tension is adjusted to be higher than the reference tension in a case where the width dimension of the magnetic tape MT is changed in a widening direction, and the tension is adjusted to be lower than the reference tension in a case where a servo band pitch is changed in a narrowing direction. Information regarding the reference tension at the time of servo pattern recording, the width dimension of the magnetic tape MT at the time of reference tension, or the like is stored in a cartridge memory 9.

The reader/writer 37 is configured to be able to record management information in the cartridge memory 9 in response to a command from the control device 38. Furthermore, the reader/writer 37 is configured to be able to read management information from the cartridge memory 9 in response to a command from the control device 38. Examples of the management information include product information of the tape cartridge 10 and the magnetic tape MT, use history information, an outline of information recorded on the magnetic tape MT, and the like. The product information includes manufacturing information, and unique information such as the number of recording tracks 5 of the magnetic tape MT, ID, and the like. The use history information includes access date and time, address information, communication history with the reader/writer 37, the presence or absence of abnormality at the time of loading/unloading the tape drive device 30, and the like. As a communication method between the reader/writer 37 and the cartridge memory 9, for example, an ISO14443 method is adopted.

The control device 38 includes, for example, a control section, a storage section, a communication section, and the like. The control section includes, for example, a central processing unit (CPU) and the like, and comprehensively controls each section of the tape drive device 30 according to a program stored in the storage section.

The storage section includes a nonvolatile memory in which various data or various programs are recorded, and a volatile memory used as a work area of the control section. The various programs described above may be read from a portable recording medium such as an optical disk, a semiconductor memory, or the like, or may be downloaded from a server device on a network. The storage section temporarily or non-temporarily stores information of the cartridge memory 9 read from the reader/writer 37, output of the thermometer 39 and the hygrometer 40, and the like. The communication section is configured to be able to communicate with other devices such as a personal computer (PC), a server device, and the like.

The drive head 36 is configured to be able to record data on the magnetic tape MT according to a command from the control device 38. Furthermore, the drive head 36 is configured to be able to reproduce data written in the magnetic tape MT in response to a command from the control device 38.

The drive head 36 includes, for example, a head unit including two servo read heads, a plurality of data write/read heads, and the like. FIG. 11 is a schematic diagram of the drive head 36 as viewed from below (tape traveling surface).

As illustrated in FIG. 11, the drive head 36 has a first drive head part 36a and a second drive head part 36b. The first drive head part 36a and the second drive head part 36b are configured symmetrically in an X′-axis direction (the traveling direction of the magnetic tape MT (X-axis direction in FIG. 3)). The first drive head part 36a and the second drive head part 36b are configured to be able to move in a width direction of the magnetic tape MT (Y-axis direction in FIG. 3)).

The first drive head part 36a is a drive head used when the magnetic tape MT travels in the forward direction (A1 direction in FIG. 10). On the other hand, the second drive head part 36b is a drive head used when the magnetic tape MT travels in the reverse direction (A2 direction in FIG. 10). Since the first drive head part 36a and the second drive head part 36b have basically similar configurations, the first drive head part 36a will be representatively described.

The first drive head part 36a includes a head body 131, two servo read heads 132, and a plurality of data write/read heads 133.

The servo read head 132 is configured to be able to reproduce a servo signal by reading magnetic flux generated from magnetic information recorded in the servo band s of the magnetic tape MT with a magneto resistive effect element (MR) or the like. That is, the servo signal is reproduced by reading the servo pattern 6 recorded in the servo band s by the servo read head 132.

Each of the servo read heads 132 is provided on each of both end sides of the head body 131 in the width direction (Y′-axis direction in FIG. 11). Examples of the MR element include an anisotropic magneto resistive effect element (AMR), a giant magneto resistive effect element (GMR), a tunnel magneto resistive effect element (TMR), and the like. A servo read head pitch P1 which is an interval in the width direction (Y′-axis direction) of the two servo read heads 132 is set to a center value (2858.8 μm) of a standard value of a distance (servo band pitch) between two adjacent servo bands s in the magnetic tape MT.

The data write/read heads 133 are arranged at equal intervals in the width direction (Y′-axis direction). Furthermore, the data write/read heads 133 are arranged at a position interposed between the two servo read heads 132. The number of data write/read heads 133 is, for example, about 20 to 40, but the number thereof is not particularly limited, and is 32 (32 channels) in the present embodiment.

The data write/read head 133 includes a data write head 134 and a data read head 135. The data write head 134 is configured to be able to record a data signal in the data band d of the magnetic tape MT by a magnetic field generated from a magnetic gap. Furthermore, the data read head 135 is configured to be able to reproduce a data signal by reading magnetic field generated from magnetic information recorded in the data band d of the magnetic tape MT with a magneto resistive effect element (MR) or the like. As the MR element, an anisotropic magneto resistance effect element (AMR), a giant magneto resistance effect element (GMR), a tunnel magneto resistance effect element (TMR), and the like are included.

In the first drive head part 36a, the data write head 134 is disposed on the left side of the data read head 135 (upstream side in a case where the magnetic tape 1 flows in the forward direction). On the other hand, in the second drive head part 36b, the data write head 134 is arranged on the right side of the data read head 135 (upstream side in a case where the magnetic tape MT flows in the reverse direction). Note that the data read head 135 can reproduce a data signal immediately after the data write head 134 writes the data signal to the magnetic tape MT. Note that, instead of the above, the data signal written by the data write head 134 of the first drive head part 36a may be reproduced by the data read head 135 of the second drive head part 36b.

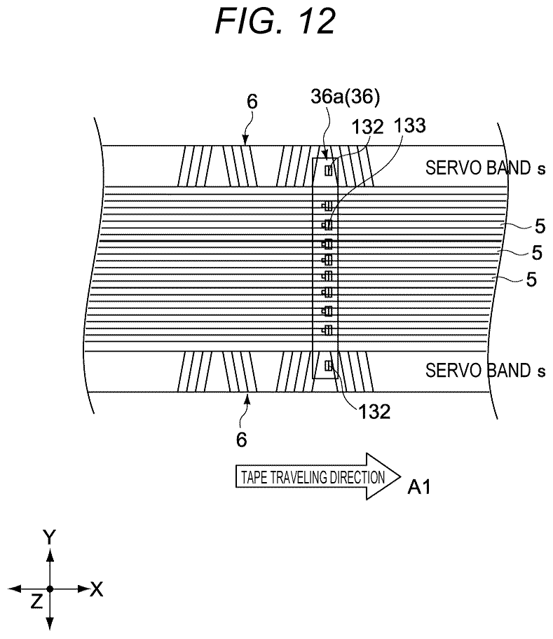

FIG. 12 is a diagram illustrating a state where the first drive head part 36a performs recording/reproducing of a data signal. Note that, in the example illustrated in FIG. 12, a state when the magnetic tape MT travels in the forward direction (A1 direction) is illustrated.

As illustrated in FIG. 12, when the first drive head part 36a performs recording/reproducing of a data signal, one servo read head 132 of the two servo read heads 132 is positioned on one servo band s of the two adjacent servo bands s and reads the servo pattern 6 on the servo band s. Furthermore, the other servo read head 132 of the two servo read heads 132 is positioned on the other servo band s of the two adjacent servo bands s and reads the servo pattern 6 on the servo band s.

The control device 38 determines whether or not the servo read head 132 accurately traces the target servo trace line T (see FIG. 5) on the basis of the reproduction waveform of the servo pattern 6.

The principle will be described. As illustrated in FIG. 5, in the servo pattern 6, a first stripe group 61 and a second stripe group 62 are inclined in opposite directions with respect to the width direction (Y-axis direction). Therefore, in the servo trace line T on the upper side, a distance between the first stripe group 61 and the second stripe group 62 in the longitudinal direction (X-axis direction) is relatively narrow. On the other hand, on the servo trace line T on the lower side, a distance between the first stripe group 61 and the second stripe group 62 in the longitudinal direction (X-axis direction) is relatively wide. Therefore, when a difference between the time when the reproduction waveform of the first stripe group 61 is detected and the time when the reproduction waveform of the second stripe group 62 is detected is determined, it is possible to know where the servo read head 132 is currently positioned with respect to the magnetic tape MT in the width direction (Y-axis direction).

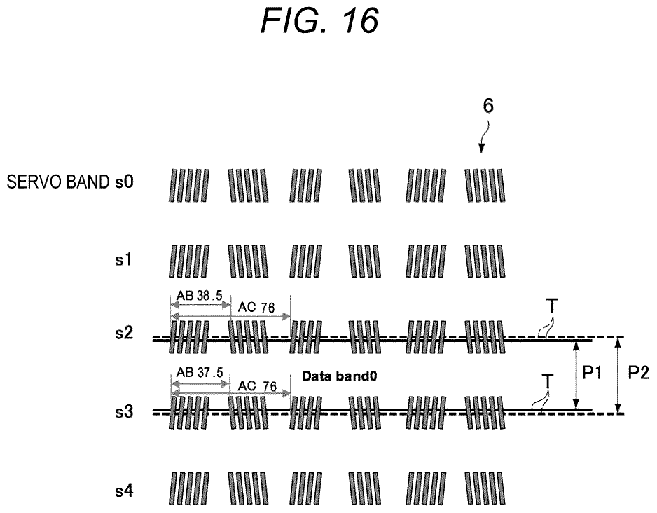

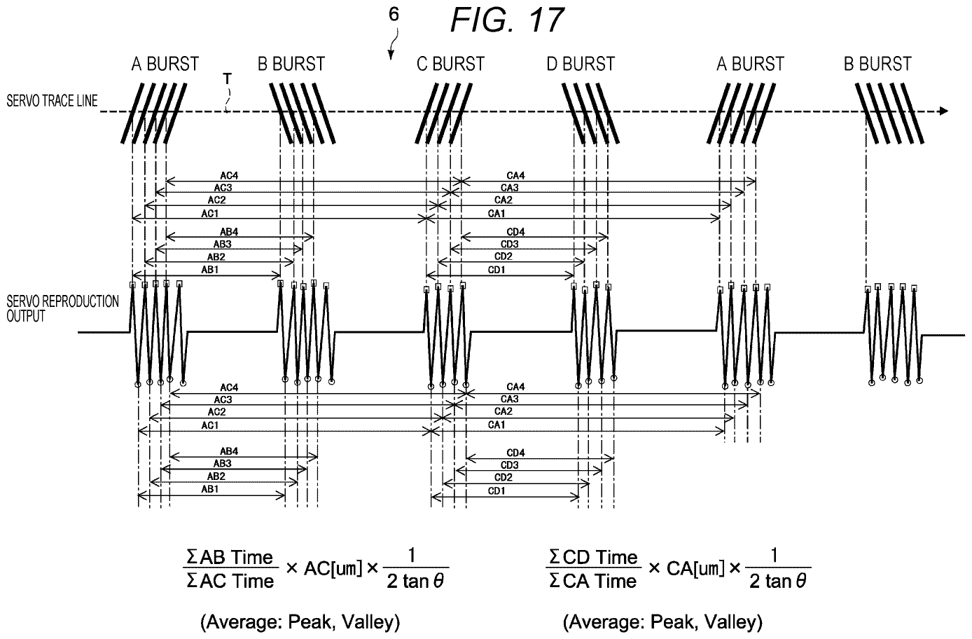

Accordingly, the control device 38 can determine whether or not the servo read head 132 accurately traces on the target servo trace line T on the basis of the reproduction waveform of the servo pattern 6. Then, in a case where the servo read head 132 does not accurately trace on the target servo trace line T, the control device 38 moves the drive head 36 in the width direction (Y′-axis direction) to adjust the position or tracking of the drive head 36. Note that a method of measuring the servo trace line T on which the servo read head 132 traces will be described later (see FIGS. 16 and 17).

Returning to FIG. 12, in a case where the magnetic tape MT fluctuates in the width direction during running of the magnetic tape MT, the data write/read head 133 adjusts the position along the servo trace line T and records a data signal in the recording track 5.

Here, when the entire magnetic tape MT is pulled out from the tape cartridge 10, the magnetic tape MT travels in the reverse direction (A2 direction). At this time, the second drive head part 36b is used as the drive head 36. As the servo trace line T, a servo trace line T adjacent to the previous servo trace line T is used. In this case, the drive head 36 is moved by the interval Ps of the servo trace line T (=recording track width Wd) in the width direction (Y′-axis direction). In this case, the data signal is recorded by the data write head 134 of the second drive head part 36b in the recording track 5 adjacent to the recording track 5 on which the data signal is previously recorded.

As described above, in the magnetic tape MT, the data signal is recorded in the recording track 5 while the magnetic tape MT is reciprocated several times by changing the traveling direction in the forward direction and the reverse direction. For example, it is assumed that the number of servo trace lines T is 100 and the number of data write/read heads 133 included in the first drive head part 36a (alternatively, the second drive head part 36b) is 32. In this case, the number of recording tracks 5 included in one data band d is 100×32, that is, 3200, and in order to record a data signal on all the recording tracks 5, the magnetic tape MT is reciprocated 50 times.

### [Servo Pattern]

Next, the servo pattern 6 will be described in detail. The servo pattern 6 has a data structure conforming to the “ECMA-319 standard”. FIG. 13(A) is a schematic plan view illustrating an arrangement example of the servo patterns 6, and FIG. 13(B) is a diagram illustrating a reproduction waveform thereof.

In a timing-based servo type head tracking servo, the servo pattern includes a plurality of azimuthal slope patterns having two or more different shapes. The position of the servo read head 132 is recognized by the time interval at which two inclined patterns having different shapes are read and the time interval at which two inclined patterns having the same shape are read. On the basis of the position of the servo read head 132 thus recognized, the position of the drive head 36 in the width direction (Y-axis direction) of the magnetic tape MT is controlled (see FIGS. 11 and 12).

As illustrated in FIG. 13(A), the servo pattern 6 forms a servo frame SF including a first servo sub-frame SSF1 and a second servo sub-frame SSF2. The servo frames SF are arranged in the longitudinal direction of the magnetic tape MT at predetermined intervals in the tape longitudinal direction. Each servo frame SF encodes a single bit of “1” or “0”. That is, one servo frame SF corresponds to one bit.

The first servo sub-frame SSF1 is constituted by an A burst 6a and a B burst 6b. The A burst 6a includes five linear patterns (corresponding to the first stripe group 61 in FIG. 5) inclined in a first direction with respect to the tape longitudinal direction, and the B burst 6b includes five linear patterns (corresponding to the second stripe group 62 in FIG. 5) inclined in a second direction opposite to the first direction described above with respect to the tape longitudinal direction.

On the other hand, the second servo sub-frame SSF2 is constituted by a C burst 6c and a D burst 6d. The C burst 6c includes four linear patterns (corresponding to the first stripe group 61 in FIG. 5) inclined in the first direction described above, and the D burst 6d includes four linear patterns (corresponding to the second stripe group 62 in FIG. 5) inclined in the second direction.

The lengths of the servo frame SF and each of the servo sub-frames SSF1 and SSF2, the arrangement intervals of the inclined portions that incline the respective bursts 6a to 6d, and the like can be arbitrarily set according to the type, specification, and the like of the magnetic tape.

The reproduction waveform of the servo pattern 6 typically shows a burst waveform as illustrated in FIG. 13(B), and a signal S6a corresponds to the A burst 6a, a signal S6b corresponds to the B burst 6b, a signal S6c corresponds to the C burst 6c, and then a signal S6d corresponds to the D burst 6d.

In the timing-based servo type head tracking servo, a position error signal (PES) is generated by reading the servo pattern 6 on two servo bands adjacent to one data band, and a recording and reproducing head with respect to a recording track in the corresponding data band is appropriately positioned. Typically, the servo pattern 6 is read from the magnetic tape MT traveling at a predetermined speed, a ratio of a distance (the time interval) AC between the A burst 6a and the C burst 6c that are arrays of the inclined patterns having the same shapes as each other to a distance (the time interval) AB between the A burst 6a and the B burst 6b that are arrays of the inclined patterns having the different shapes from each other (or a ratio of a distance CA between the C burst 6c and the A burst 6a to a distance CD between the C burst 6c and the D burst 6d) is calculated, and the drive head 36 is moved in the tape width direction (Y′-axis direction) so that the value is a setting value set for each recording track (see FIG. 12).

### [Identification of Data Band]

In each of the servo bands s (s0 to s4), servo band identification information in a different combination is written for each data band. For example, a combination of servo band identification information obtained from two servo bands s2 and s3 adjacent to the data band d0 is different from a combination of servo band identification information obtained from the servo bands s1 and s2 adjacent to the data band d1, a combination of servo band identification information obtained from the servo bands s3 and s4 adjacent to the data band d2, and a combination of servo band identification information obtained from two servo bands s0 and s1 adjacent to the data band d3. As described above, the servo band identification information obtained from two servo bands adjacent to one data band is set to be different from the servo band identification information obtained from two servo bands adjacent to the other data band, such that the individual data bands can be identified.

In the present embodiment, two types of servo bands are used to identify the data bands d0 to d4 to be recorded and reproduced. As described above, servo band identification information is embedded in the servo band. The servo band identification information is information of a plurality of bits, and is typically 4 bits, but may be 8 bits or a plurality of bits other than 4 bits and 8 bits.

In the present embodiment, the two types of servo bands described above include a first servo band in which first servo band identification information is recorded and a second servo band in which second servo band identification information is recorded. The first servo band identification information is 4-bit information (for example, “1001”), and the second servo band identification information is 4-bit information (for example, “0111”) different from the first servo band identification information.

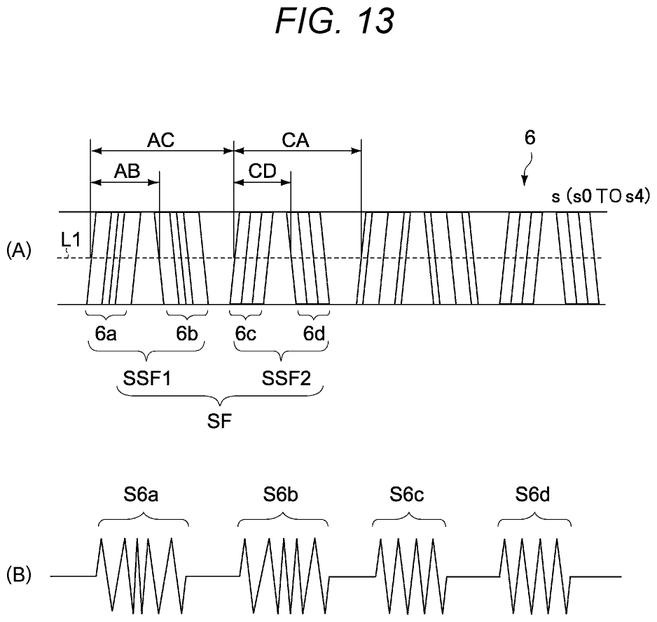

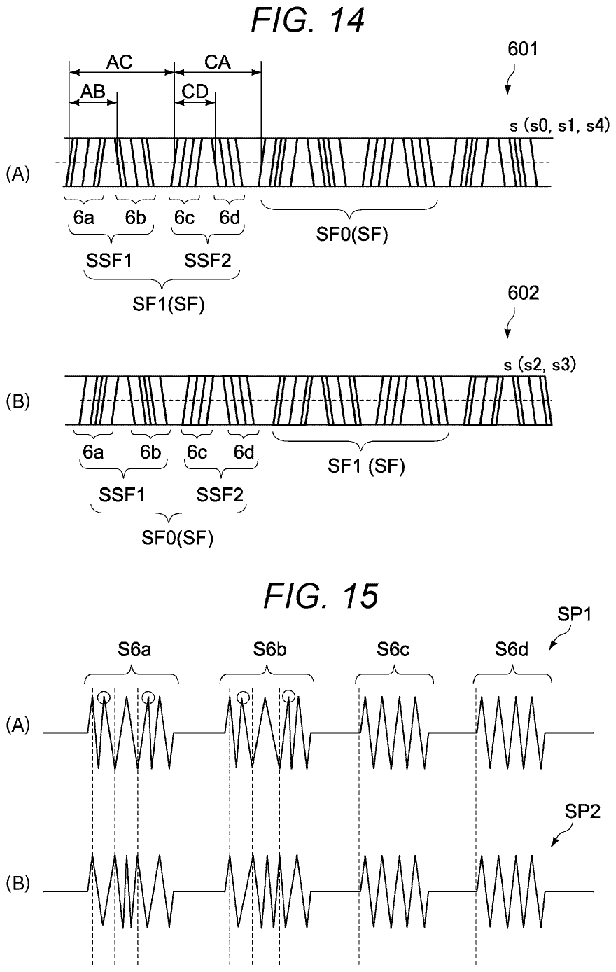

The combination of the signs “0” and “1” constituting the first and second servo band identification information is identified from the reproduction waveform of the servo pattern 6. That is, the reproduction waveform of the servo pattern 6 corresponds to modulated waves of the signs “0” and “1”, and the first and second servo band identification information are read by demodulating the reproduction waveform and combining, for example, four bits. Hereinafter, the first and second servo band identification information will be described with reference to FIGS. 14 and 15.

FIGS. 14(A) and 14(B) are schematic views illustrating configuration examples of a servo pattern in which first servo band identification information is embedded (hereinafter, also referred to as a first servo pattern 601) and a servo pattern in which second servo band identification information is embedded (hereinafter, also referred to as a second servo pattern 602), respectively. As illustrated in the same drawing, the first servo pattern 601 and the second servo pattern 602 are both constituted by a combination of two types of servo frames SF including a servo frame SF1 representing one sign (for example, “1”) and a servo frame SF0 representing the other sign (for example, “0”). The servo frames SF1 and SF0 are common in that the servo frame SF including the first servo sub-frame SSF1 and the second servo sub-frame SSF2 is used as a constituent unit, but the first servo sub-frames SSF1 (A burst 6a and B burst 6b) are different from each other.

As illustrated in FIG. 14(A), in the servo frame SF1 indicating the sign “1”, when five inclined patterns respectively constituting the A burst 6a and the B burst 6b are defined as a first inclined portion, a second inclined portion, a third inclined portion, a fourth inclined portion, and a fifth inclined portion in order from the left side in the drawing, the second and fourth inclined portions are arranged at positions biased toward the first and fifth inclined portions, respectively. On the other hand, as illustrated in FIG. 14(B), in the servo frame SF0 representing the sign “0”, the arrangement intervals of some of the inclined patterns constituting the A burst 6a and the B burst 6b are different from those of the servo frame SF1. In the illustrated example, in the five inclined patterns constituting each of the A burst 6a and the B burst 6b, the second and fourth inclined portions are arranged at positions biased toward the third inclined portion, respectively. Therefore, as for the A burst 6a and the B burst 6b in the servo frame SF0, the interval between the second inclined portion and the third inclined portion and the interval between the third inclined portion and the fourth inclined portion are shortest, and the interval between the first inclined portion and the second inclined portion and the interval between the fourth inclined portion and the fifth inclined portion are longest.

FIGS. 15(A) and 15(B) illustrate reproduction waveforms SP1 and SP2 of the first servo pattern 601 and the second servo pattern 602, respectively. The reproduction waveform of each of the servo frames SF1 and SF0 is constituted by a burst signal having a peak at a position corresponding to the inclined portion of each of the burst portions 6a to 6d. As described above, in the servo frame SF0, since the configurations of the A burst 6a and the B burst 6b are different from those of the A burst 6a and the B burst 6b of the servo frame SF1, the peak positions of the burst signals S6a and S6b are shifted corresponding to the interval between the different inclined portions. Therefore, it is possible to read the information written in the servo frame SF by detecting the portion where a deviation of the peak position occurs, a deviation amount thereof, and a deviation direction. Here, for example, the servo frame SF1 illustrated in FIG. 15(A) represents one bit “1”, and the servo frame SF0 illustrated in FIG. 15(B) represents another one bit “0”. The first and second servo band identification information can be configured by arbitrarily combining the two servo frames SF1 and SF0, for example, four bits.

### [Measurement Method of Servo Band Pitch]

Subsequently, a method of measuring the servo band pitch of the magnetic tape MT will be described. Here, the servo band pitch is an index indicating a distance between two servo bands (servo bands s2 and s3) adjacent to one data band (for example, data band d0). More specifically, the servo band pitch refers to a distance between the center of the servo pattern recorded in one servo band of the two servo bands described above and the center of the servo pattern recorded in the other servo band. Furthermore, in the following description, the servo band pitch may be used as a difference from a servo read head pitch P1 (see FIG. 11). In the present embodiment, an average value of differences between two adjacent servo band pitches in a plurality of servo bands over the entire length of the magnetic tape MT is 100 nm or less, preferably 95 nm or less, more preferably 90 nm or less, and still more preferably 85 nm or less.

The servo band pitch is measured by the tape drive device 30. Here, as illustrated in FIG. 16, an example in which the drive head 36 tracks the data band d0 interposed between the servo band s2 and the servo band s3 will be described.

As described above, in the method of measuring the servo band pitch using the tape drive device 30, the magnetic tape MT is caused to run by the tape drive device 30, the servo trace line T on each servo band of the two servo read heads 132 is measured, and the servo band pitch is measured from the relative position of each measured servo trace line T with respect to the servo pattern 6.

The interval between the servo trace lines T indicated by a solid line in FIG. 16 indicates a servo band pitch (servo read head pitch P1 which is an arrangement interval of two servo read heads 132 of the drive head 36) when the width of the magnetic tape MT does not change. Furthermore, an interval between the servo trace lines T indicated by a broken line in FIG. 16 corresponds to a servo band pitch (P2) when the width of the magnetic tape MT is increased.

FIG. 17 is a diagram explaining a measurement method of the servo trace line T. The tape drive device outputs a servo reproduction signal having a waveform according to the position of the servo trace line T with respect to the servo pattern 6 (see FIG. 15). Typically, a distance AC between the A burst and the C burst that are arrays of the inclined patterns having the same shapes as each other, and a distance AB between the A burst and the B burst that are arrays of the inclined patterns having different shapes from each other are calculated, and the position of the servo trace line T of each servo read head 132 is measured by the following formula [Math. 4]. Note that θ is an azimuth angle of each of the inclined patterns described above corresponding to an angle α in FIG. 5, and is 12° in the present example.

$$[ Math . 4 ]$$

$$\frac{\sum AB Time}{\sum AC Time} \times AC [ um ] \times \frac{1}{2 tan θ}$$

Here, the distance AC may be a distance AC1 between the first inclined portions of the A burst and the C burst, a distance AC2 between the second inclined portions thereof, a distance AC3 between the third inclined portions thereof, or a distance AC4 between the fourth inclined portions thereof. These distances AC (AC1 to AC4) refer to distances between positions (upper peak positions) indicating a positive maximum value of an amplitude in the servo reproduction waveform.

Similarly, the distance AB also may be a distance AB1 between the first inclined portions of the A burst and the B burst, a distance AB2 between the second inclined portions thereof, a distance AB3 between the third inclined portions thereof, or a distance AB4 between the fourth inclined portions thereof. Typically, the distance AB1 is adopted in a case where the distance AC1 is adopted, the distance AB2 is adopted in a case where the distance AC2 is adopted, the distance AB3 is adopted in a case where the distance AC3 is adopted, and the distance AB4 is adopted in a case where the distance AC4 is adopted.

Then, the servo band pitch is determined from a difference between the numerical values representing the positions of the respective servo trace lines T on the servo pattern obtained from the ratios of the distance AB and the distance AC calculated using the formula described above [Math. 4]. Here, the difference between the measured value of the servo band (servo band s2) in the tape center and the measured value of the servo band (servo band s3) on the tape edge of the two servo bands to be measured is taken. A positive or negative value thereof means a direction of change in tape width. A case where it is a positive value corresponds to narrowing of the servo band pitch, and a case where it is a negative value corresponds to widening of the servo band pitch. A case where the difference described above is zero means that there is no fluctuation in the tape width.

The servo band pitch is preferably determined from a difference between a large number of servo frames, and may be, for example, an average value of measured values calculated from differences between 100 to 100000 servo frames. The tape tension at the time of measurement is a tension (reference tension, for example, 0.55 N) at the time of recording of the servo pattern 6, and measurement is performed at a constant tension over the entire length of the magnetic tape MT.

Note that the method of measuring the servo trace line T is not limited to the example described above, and for example, the distance CA between the C burst and the A burst and the distance CD between the C burst and the D burst may be calculated, and the position of the servo trace line T may be measured by the following formula [Math. 5].

$$[ Math . 5 ]$$

$$\frac{\sum CD Time}{\sum CA Time} \times CA [ um ] \times \frac{1}{2 tan θ}$$

Here, the distance CA may be a distance CA1 between the first inclined portions of the C burst and the A burst, a distance CA2 between the second inclined portions thereof, a distance CA3 between the third inclined portions thereof, or a distance CA4 between the fourth inclined portions thereof. These distances CA (CA1 to CA4) refer to distances between positions indicating a positive maximum value of an amplitude in the servo reproduction waveform.

Similarly, the distance CD also may be a distance CD1 between the first inclined portions of the C burst and the D burst, a distance CD2 between the second inclined portions thereof, a distance CD3 between the third inclined portions thereof, or a distance CD4 between the fourth inclined portions thereof. Typically, the distance CD1 is adopted in a case where the distance CA1 is adopted, the distance CD2 is adopted in a case where the distance CA2 is adopted, the distance CD3 is adopted in a case where the distance CA3 is adopted, and the distance CD4 is adopted in a case where the distance CA4 is adopted.

Moreover, for the measurement of the servo band pitch, an average value of the measured value using the formula [Math. 4] and the measured value using the formula [Math. 5] may be used. Moreover, as the distances AC and AB in the formula [Math. 4] and the distances CA and CD in the formula [Math. 5], the distances between the positions (lower peak positions) indicating the negative maximum value of the amplitude in the servo reproduction waveform may be adopted. Alternatively, as the distances AC and AB in the formula [Math. 4] and the distances CA and CD in the formula [Math. 5], an average value of the distances between the positions (upper peak positions) indicating the positive maximum value and the distances between the positions (lower peak positions) indicating the negative maximum value of the amplitudes in the servo reproduction waveform may be adopted.

As illustrated in FIG. 16, in a case where the servo trace line T is at a position indicated by a broken line, the distance AB is 38.5 μm and the distance AC is 76 μm in the servo band s2, and the distance AB is 37.5 μm and the distance AC is 76 μm in the servo band s3.

In the servo band s2, (38.5/76)×(76/2 tan 12°)=90.5641 [μm], and in the servo band s3, (37.5/76)×(76/2 tan 12°)=88.2118 [μm]. A difference between these values is 88.2118−90.5641=−2.3523 [μm].

Therefore, the servo band pitch P2 in this case is determined as a value wider than the servo read head pitch P1 by 2.3523 μm.

Note that, as illustrated in FIG. 16, in a case where the servo trace line T is at a position indicated by a broken line, in both the servo band s2 and the servo band s3, the distance AB is 38 μm and the distance AC is 76 μm. In this case, both the servo band s2 and the servo band s3 are 89.3880 [μm], and a difference therebetween is 0 [μm]. That is, the servo band pitch in this case means that it is the same as the servo read head pitch P1.

### (Tension Control)

The tape drive device 30 controls the tension of the magnetic tape MT so that the measured servo pattern pitch is the same as the servo read head pitch P1 based on the servo pattern pitch measured as described above.

In the present embodiment, before recording data on the magnetic tape MT or reproducing data from the magnetic tape MT, servo signals are read from two servo bands interposing one data band for recording or reproducing data, and it is determined from each read servo signal whether or not the two servo band pitches are wider or narrower than the servo read head pitch P1. In a case where the servo band pitch is wider than the servo read head pitch P1, the tension is increased, and in a case where the servo band pitch is narrower than the servo read head pitch P1, the tension is decreased. By adjusting a magnitude of the tension according to a magnitude of the servo band pitch in this manner, desired tracking control for the corresponding data band can be stably performed.

The tape drive device 30 acquires the relationship between the servo band pitch and the tension for one data band by one round trip tape traveling, and records the acquired data in the cartridge memory 9. The tape drive device 30 similarly applies the relationship between the servo band pitch and the tension measured for the one data band described above to the recording and reproducing of data for another data band.

### [Head Azimuth Angle Control]

Furthermore, in the tape drive device 30, the longitudinal direction (Y′-axis direction) of the drive head 36 may be arranged to be inclined at a predetermined angle θ (azimuth angle θ) with respect to the width direction (Y-axis direction) of the magnetic tape MT. The azimuth angle θ of the drive head 36 is adjusted to cope with the variation in the width of the magnetic tape MT. Typically, when the width of the magnetic tape MT becomes relatively wide, the azimuth angle θ of the data write head 36 is decreased, and conversely, when the width of the magnetic tape MT becomes relatively narrow, the azimuth angle θ of the data write head 36 is increased. The control device 38 acquires information on the width of the magnetic tape MT from a width measurement unit (not illustrated) (Alternatively, the width of the magnetic tape MT is predicted from the servo signal.), and adjusts the azimuth angle θ of the drive head 36 by an angle adjustment unit (not illustrated) on the basis of the information on the width of the magnetic tape MT.

### (5) Configuration of Servo Pattern Recording Device

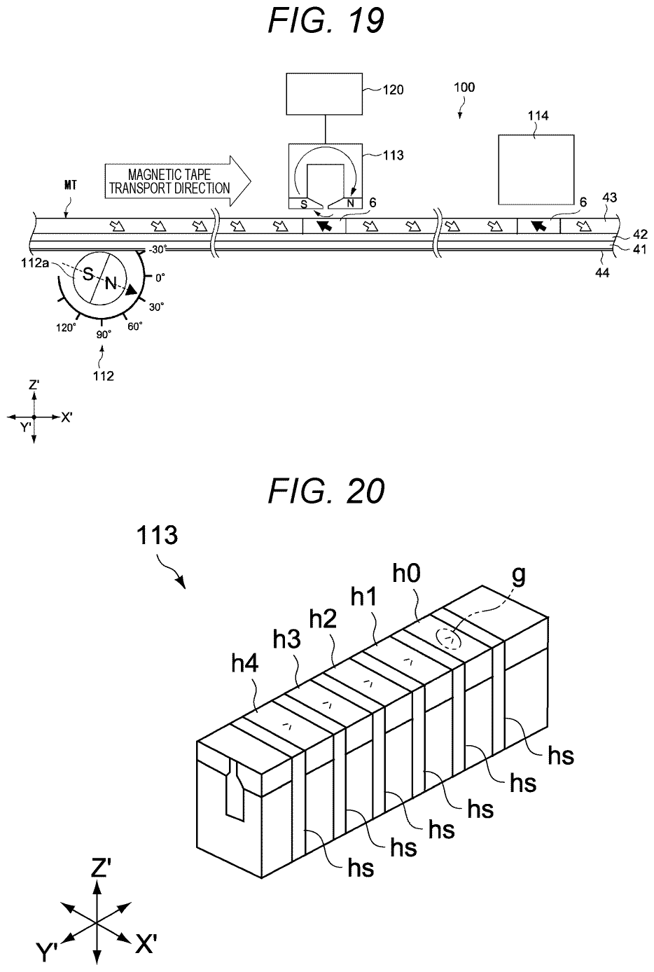

Next, a configuration of a servo pattern recording device that records the servo pattern 6 on the servo band s of the magnetic tape MT will be described. FIG. 18 is a schematic front view illustrating a servo pattern recording device 100 according to an embodiment of the present technology. FIG. 19 is a partially enlarged view of a part of the servo pattern recording device 100.

The servo pattern recording device 100 includes a feed roller 111, a pre-processing section 112, a servo write head 113, a reproducing head unit 114, and a winding roller 115 in this order from the upstream side in a transport direction of the magnetic tape MT. The servo pattern recording device 100 further includes a drive section 120 and a controller 130. The controller 130 includes a control section that comprehensively controls each section of the servo pattern recording device 100, a storage section that stores various programs and various types of data required for processing of the control section, a display section that displays data, an input section that inputs data, and the like.

The feed roller 111 can rotatably support the roll-shaped magnetic tape MT (before the servo pattern 6 is recorded). The feed roller 111 is rotated in accordance with driving of a drive source such as a motor or the like, and feeds the magnetic tape MT toward the downstream side in accordance with the rotation.

The winding roller 115 can rotatably support the roll-shaped magnetic tape MT (after the servo pattern 6 is recorded). The winding roller 115 rotates in synchronization with the feed roller 111 in accordance with driving of the drive source such as a motor or the like, and winds the magnetic tape MT in which the servo pattern 6 is recorded in accordance with the rotation. The feed roller 111 and the winding roller 115 can move the magnetic tape MT at a constant speed on a transport path.

The servo write head 113 is disposed, for example, above the magnetic tape MT (magnetic layer 43 side). Note that the servo write head 113 may be disposed below the magnetic tape MT (base 41 side). The servo write head 113 generates a magnetic field at a predetermined timing according to a rectangular wave pulse signal, and applies the magnetic field to a part of the magnetic layer 43 (after preprocessing) included in the magnetic tape MT.

Therefore, the servo write head 113 magnetizes a part of the magnetic layer 43 in a first direction and records the servo pattern 6 in the magnetic layer 43 (for the magnetization direction, see the black arrow in FIG. 19). When the magnetic layer 43 passes under the servo write head 113, the servo write head 113 can record the servo pattern 6 for each of the five servo bands s0 to s4.

The first direction that is the magnetization direction of the servo pattern 6 includes a component in a direction perpendicular to the upper surface of the magnetic layer 43. That is, in the present embodiment, the magnetic layer 43 contains magnetic powder vertically oriented or not oriented, and thus the servo pattern 6 to be recorded in the magnetic layer 43 includes a magnetization component in the vertical direction.

The pre-processing section 112 is arranged, for example, below (base 41 side) of the magnetic tape MT on the upstream side of the servo write head 113. The pre-processing section 112 may be arranged above the magnetic tape MT (magnetic layer 43 side). The pre-processing section 112 includes a permanent magnet 112a rotatable about a center axis of rotation in the Y′-axis direction (the width direction of the magnetic tape MT in FIG. 15. A shape of the permanent magnet 112a is, for example, a cylindrical shape or a polygonal columnar shape, but is not limited thereto.

Before the servo pattern 6 is recorded by the servo write head 113, the permanent magnet 112a applies a magnetic field to the entire magnetic layer 43 by a direct-current magnetic field to demagnetize the entire magnetic layer 43. Therefore, the permanent magnet 112a can magnetize the magnetic layer 43 in advance in the second direction opposite to the magnetization direction of the servo pattern 6 (in FIG. 19, see the white arrow). As described above, the two magnetization directions are set to be opposite directions, respectively, such that the reproduction waveforms of the servo signals obtained by reading the servo pattern 6 can be symmetrical in a vertical direction (t).

Note that, as a method of adjusting the second direction described above, for example, a rotation angle of the permanent magnet 112a may be arbitrary, the servo pattern 6 may be recorded in the magnetic layer 43 after the entire magnetic layer 43 is demagnetized, and the rotation angle of the permanent magnet 112a with the width direction of the magnetic tape MT as a center may be adjusted on the basis of the inclination of the reproduction waveform.

The reproducing head unit 114 is disposed above the magnetic tape MT (magnetic layer 43 side) on the downstream side of the servo write head 113. The reproducing head unit 114 reads the servo pattern 6 described above from the magnetic layer 43 of the magnetic tape MT in which the servo pattern 6 is pre-processed by the pre-processing section 112 and is recorded by the servo write head 113. The reproduction waveform of the servo pattern 6 read by the reproducing head unit 114 is displayed on a screen of the display unit. Typically, the reproducing head unit 114 detects the magnetic flux generated from the surface of the servo band s when the magnetic layer 43 passes under the reproducing head unit 114. The magnetic flux detected at this time becomes a reproduction waveform of the servo pattern 6 as a servo signal.

FIG. 20 is a perspective view schematically illustrating a configuration of the servo write head 113, FIG. 21 is a schematic cross-sectional view of a main part of the servo write head 113, and FIG. 22 is a schematic plan view of a main part of the servo write head 113.

As illustrated in FIGS. 20 and 21, the servo write head 113 includes a plurality of magnetic cores h0 to h4 for recording the servo pattern 6 on each of the servo bands s0 to s4 of a magnetic tape MT, and adhesive layers hs joining the magnetic cores h0 to h4.

Each of the magnetic cores h0 to h4 includes a head block 402 including a soft magnetic material such as sendust, permalloy, ferrite, or the like, and a coil 70 wound around a head block 402. Each of the magnetic cores h0 to h4 constitutes a recording section 401 disposed corresponding to each of the servo bands s0 to s4 of the magnetic tape MT, and has a magnetic gap g for recording the servo pattern 6 in each servo band s.

The magnetic gap g is constituted by a pair of straight line portions (“/” and “\”) that are inclined in opposite directions. One straight line portion “/” and the other straight line portion “\” record the A burst 6a and the C burst 6c, and the B burst 6b and the D burst 6d, respectively. The magnetic gaps g of head blocks h1 to h5 are arranged so as to be aligned on an axis parallel to the longitudinal direction (Y′-direction) of the servo write head 113. An arrangement interval of the magnetic gaps g is a distance between the centers in a pattern width Pw in the longitudinal direction of the servo write head 113, and the size thereof is the servo read head pitch P1. The magnetic cores h0 to h4 are magnetically separated from each other, and are configured to be able to simultaneously record different types of servo patterns 6 in two or more servo bands.

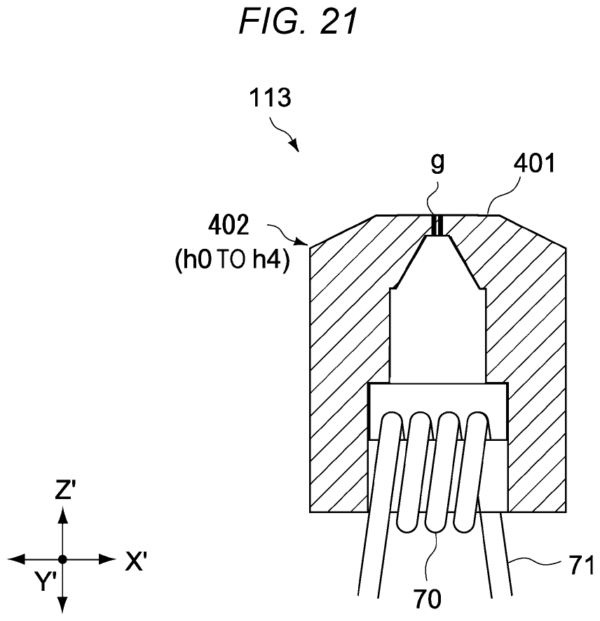

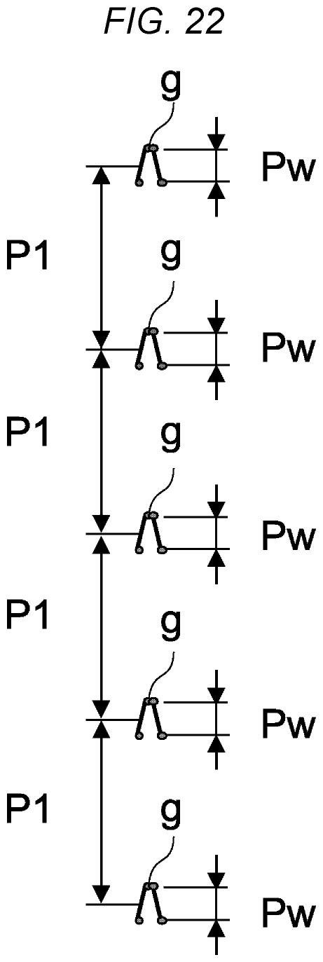

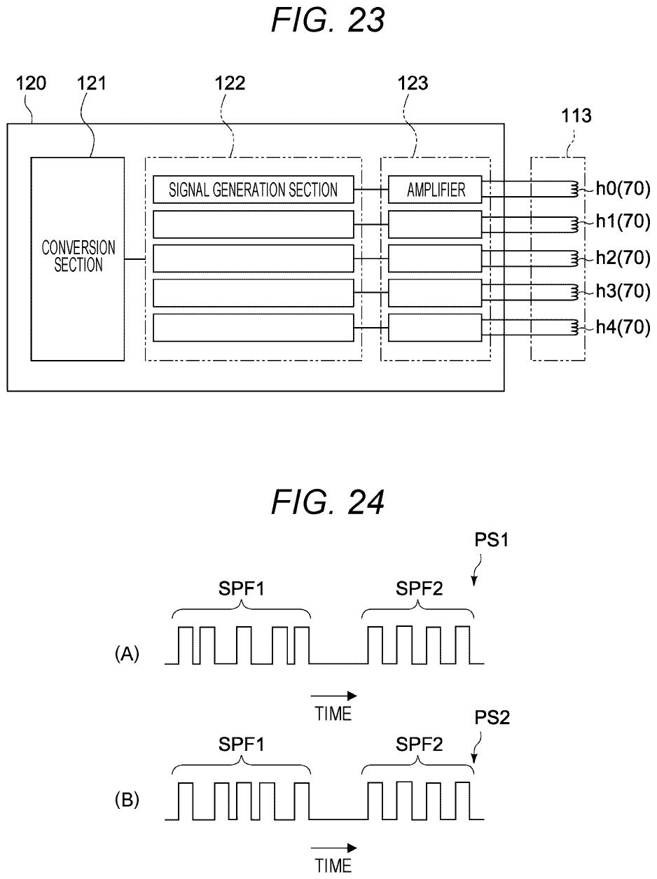

FIG. 23 is a block diagram illustrating a configuration of the drive section 120. As illustrated in FIG. 23, the drive section 120 includes a converter 121 that converts servo information into pulse information on the basis of an output from the controller 130 (see FIG. 18), a signal generation section 122 that generates a pulse signal on the basis of an output of the converter 121, and an amplifier 123 that amplifies the generated pulse signal. A plurality of the signal generation sections 122 and a plurality of the amplifiers 123 are provided corresponding to the magnetic cores h0 to h4, respectively, and are configured to be able to output unique pulse signals to the coils 70 wound around the magnetic cores h0 to h4, respectively.

The controller 130 includes a memory that stores data regarding the positions of the servo bands (in this example, the servo bands s0, s1, and s4) in which the first servo band identification information is to be recorded and the positions of the servo bands (in this example, the servo bands s2 and s3) in which the second servo band identification information is to be recorded. The controller 130 controls the drive section 120 on the basis of the data stored in the memory.

The converter 121 individually outputs pieces of information corresponding to the servo band identification information to be recorded in the respective servo bands s0 to s4 to the signal generation sections 122 corresponding to the respective magnetic cores h0 to h4. In the present embodiment, a first pulse signal PS1 for recording the first servo pattern 601 (FIG. 14(A)) including the first servo band identification information is output to the magnetic cores h0, h1, and h4 corresponding to the servo bands s0, s1, and s4, respectively, and a second pulse signal PS2 for recording the second servo pattern 602 (FIG. 14(B)) including the second servo band identification information is output to the head blocks h2 and h3 corresponding to the servo bands s2 and s3, respectively.

FIGS. 24(A) and 24(B) schematically illustrate the recording signal waveforms of the first servo sub-frames SSF1 in the first pulse signal PS1 and the second pulse signal PS2, respectively. As illustrated in the drawings, the first and second pulse signals PS1 and PS2 include a first pulse group SPF1 including five pulse groups and a second pulse group SPF2 including four pulse groups. The first pulse group SPF1 is a signal for recording each inclined portion of the A burst 6a, and the second pulse group SPF2 is a signal for recording each inclined portion of the B burst 6b.

As illustrated in FIGS. 24(A) and 24(B), second and fourth pulse rise times in the first pulse group SPF1 are different between the first pulse signal PS1 and the second pulse signal PS2, and second pulse rise time of the pulse signal PS2 is later than that of the pulse signal PS1, and is earlier than that of the fourth pulse rise time. Therefore, the first servo sub-frame SSF1 in which the arrangement intervals of the inclined portions of the A burst 6a are partially different from each other as illustrated in FIGS. 14(A) and 14(B) is formed.

Moreover, the first pulse signal PS1 and the second pulse signal PS2 are transmitted to the magnetic cores h0 to h4 at the same phase (the same timing). Therefore, in each of the magnetic cores h0 to h4, the first servo pattern 601 (first servo band identification information) is recorded in the servo bands s0, s1, and s4, and the second servo pattern 602 (second servo band identification information) is recorded in the servo bands s2 and s3, in the same phase.

### <Details of Present Technology>

As described above, the tape drive device 30 is configured to be able to change the tension applied when the magnetic tape MT travels in order to cope with the change in the width dimension of the magnetic tape MT. Specifically, in a case where the width dimension of the magnetic tape MT changes in a widening direction, the tension is increased, and in a case where the width dimension of the magnetic tape MT changes in a narrowing direction, the tension is decreased. By adjusting the magnitude of the tension according to the change in the width dimension of the magnetic tape MT in this manner, desired tracking control can be stably performed.

The width dimension of the magnetic tape MT fluctuates uniformly with respect to the servo band pitch of each data band. On the other hand, from the viewpoint of the tape traveling time in the tape drive device 30, a method is advantageous in which the relationship between the servo band pitch of one data band of the plurality of data bands and the tension is acquired by one round trip tape traveling and held in the cartridge memory 9, and the servo band pitch of the other remaining data bands is similarly applied based on the acquired servo band pitch and tension.

However, in a case where the difference between the reference servo band pitch and the remaining other servo band pitches is large, the relationship between the tension acquired in advance and the servo band pitch is different for the other servo band pitches. Therefore, it is difficult to ensure desired tracking control.

As a cause of the difference in the servo band pitch of each data band, first, there is a positional shift of the magnetic gap g formed in each of the magnetic cores h0 to h4 of the servo write head 113. Since the magnetic gap g is formed using a photolithography technique, dimensional accuracy is relatively high, but dimensional errors in units of submicrons may occur.

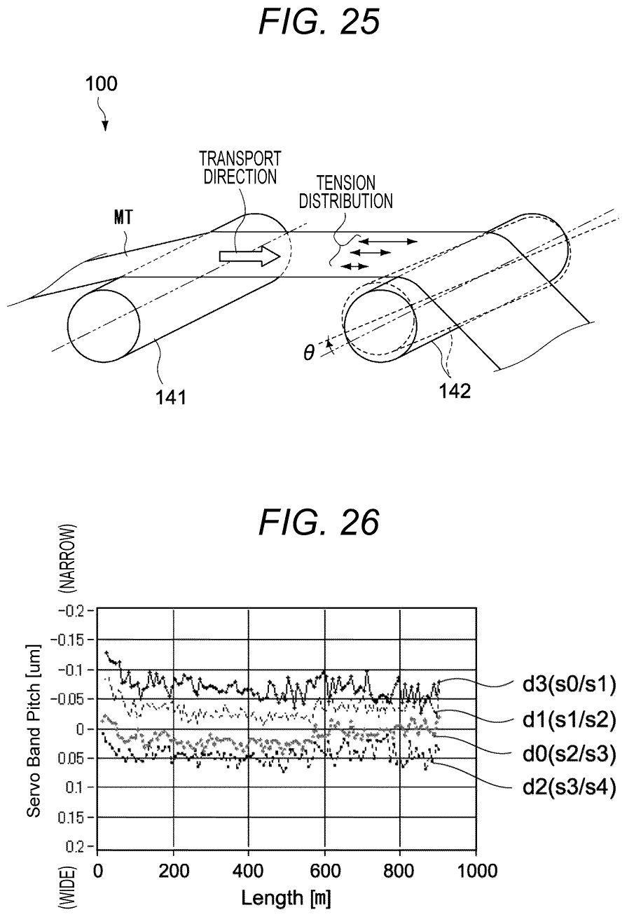

Furthermore, another cause of the difference in the servo band pitch between the data bands is a deviation in parallelism between the guide rollers that guide tape traveling during servo pattern recording. For example, FIG. 25 illustrates a pair of guide rollers 141 and 142 that guides the travel of the magnetic tape MT in the servo pattern recording device 100. The shaft centers of the guide rollers 141 and 142 are disposed in parallel to each other, so that uniform tension acts in the width direction of the magnetic tape MT. However, as indicated by a broken line in FIG. 25, in a case where the axis of the guide roller 142 is displaced by an angle θ (misalignment angle) in the vertical direction with respect to the axis of the guide roller 141, even if the magnitude of the angle θ is 1 degree or less, a tension distribution may be generated in the width direction of the magnetic tape MT.

As an example, FIG. 26 illustrates comparison of the servo band pitches of the data bands measured for the same magnetic tape. In the drawing, a horizontal axis represents a tape length, and a vertical axis represents a servo band pitch. Here, the servo band pitch on the vertical axis is indicated by a difference with the servo read head pitch P1 (2858.8 μm) as a reference value (Ref). The servo band pitch can be measured using the tape drive device 30 as described with reference to FIGS. 16 and 17. Note that, in the drawing, d0(s2/s3) means an interval (servo band pitch s2/s3) between two servo bands s2 and s3 adjacent to the data band d0, and d1(s1/s2) means an interval (servo band pitch s1/s2) between two servo bands s1 and s2 adjacent to the data band d1. Similarly, d2(s3/s4) means an interval (servo band pitch s3/s4) between two servo bands s3 and s4 adjacent to the data band d2, and d3(s0/s1) means an interval (servo band pitch s0/s1) between two servo bands s0 and s1 adjacent to the data band d0.

In the measurement example illustrated in FIG. 26, the servo band pitch spreads from the data band d3 to the data band d2, and when the servo band pitch (s0/s1) of the data band d3 is set to a maximum value and the servo band pitch (s3/s4) of the data band d2 is set to a minimum value, a maximum change amount of the servo band pitch represented by a width (absolute value) between the maximum value and the minimum value in the same tape length is about 0.13 μm on average.

Since it is well known that the servo band pitch depends on the tape tension, the variation in the servo band pitch in each data band may be related to the tension distribution in the width direction of the magnetic tape. For example, due to the deviation in parallelism of the guide rollers 141 and 142 illustrated in FIG. 25, it is assumed that the tension at the time of servo pattern recording is lower near the data band d3 (the width is narrowed because the tension is applied at the time of reproduction) and higher near the data band d2 (the width is widened because the tension is loosened at the time of reproduction) than the tension at the time of reproduction.

The tension distribution in the width direction of the magnetic tape is considered to be related to non-uniformity of strain stress of the magnetic tape, slight deviation of parallelism of the guide rollers located on the upstream side and the downstream side of the servo write head, and the like. However, since it is difficult to directly measure or grasp the tension distribution in the magnetic tape, it is more preferable to reduce the variation in the servo band pitch by grasping and adjusting the parameter that causes the change in the servo band pitch even by a method other than the tension.

When the servo band pitch varies, positioning accuracy of the recording/reproducing head with respect to each data band decreases, and it becomes difficult to realize stable tracking control for each data band. In particular, in the magnetic tape MT of the LTO-8 standard in which the total number of recording tracks exceeds 6500, not only the track pitch Wd (see FIG. 4) is as very small as 1.56 μm, but also it is assumed that the pitch becomes narrower in the future. Then, it is necessary to further improve the positioning accuracy of the recording/reproducing head with respect to the recording track. Specifically, considering the relationship between the track pitch Wd of each data band d and the width of the data read head 135 of the tape drive device 30, in order to secure the alignment margin of the data read head 135 with respect to the recording track, it is necessary to reduce the variation in the servo pattern pitch with accuracy of ±100 nm (0.1 μm) in the track width direction.

### [Details of Servo Pattern Recording Device]

In order to solve such a problem, the servo pattern recording device 100 of the present embodiment further includes a temperature adjustment section 80 as illustrated in FIG. 18.

### Application Example 1

The temperature adjustment section 80 is configured to individually raise the temperatures of the magnetic cores h0 to h4 constituting the recording section 401 of the servo write head 113. In the present embodiment, the temperature adjustment section 80 is configured as a part of the drive section 120, and individually adjusts the temperature of each recording section 401 (magnetic cores h0 to h4) of the servo write head 113 within a predetermined temperature range on the basis of a command from the controller 130. In the present embodiment, the temperature adjustment section 80 is configured to be able to individually adjust the temperature of each recording section 401 such that the average value of the differences in the servo band pitch over the entire tape length is less than or equal to a predetermined value (for example, 100 nm or less).

More specifically, for example, the temperature adjustment section 80 includes a heating mechanism. The heating mechanism includes a power adjustment section capable of individually adjusting power to be supplied to the coil 70 of each of the magnetic cores h0 to h4. The amplifier 123 (FIG. 23) that amplifies a pulse signal that is servo information to each coil 70 corresponds to the power adjustment section.

As a parameter for changing the servo band pitch, the present inventor has paid attention to the recording current (supply power to the coil 70) of the servo pattern 6 supplied to the coil 70 of each of the magnetic cores h0 to h4 of the servo write head 113, and has confirmed that the servo band pitch changes slightly by about 100 nm due to a change in the value of the recording current.

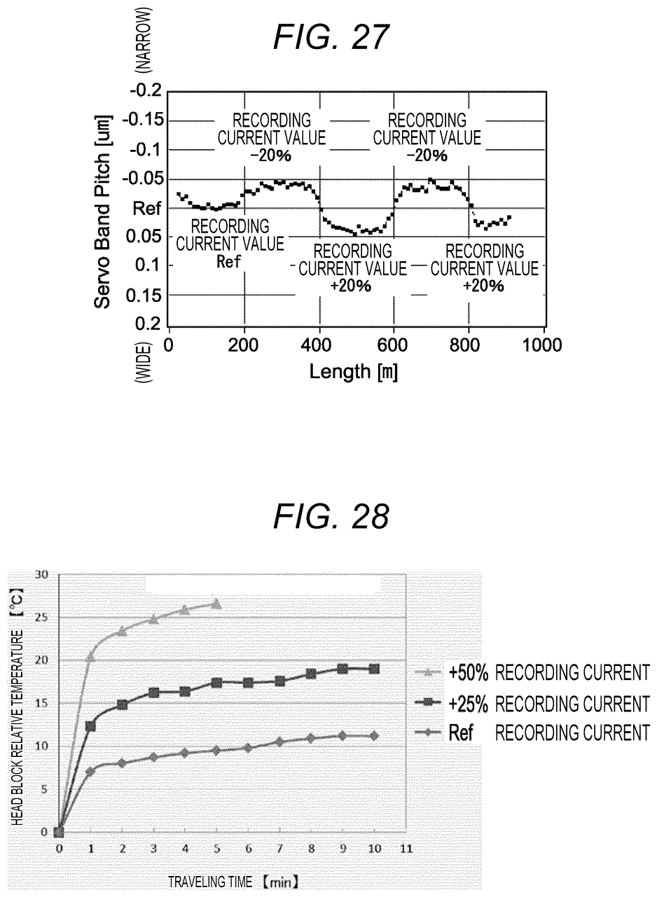

FIG. 27 is an experimental result illustrating a relationship between the recording current value and the servo band pitch. Similarly to FIG. 26, the horizontal axis represents the tape length and the vertical axis represents the servo band pitch. As illustrated in the figure, the servo band pitch changes depending on the current value (recording current value) at the time of servo pattern recording. Here, the recording current value was set to a reference value (Ref (1.8 A)) for the tape length of 0 to 200 m, the recording current value was set to a value (−20%) smaller than the reference value by 20% for the tape length of 200 m to 400 m, the recording current value was set to a value (+20%) larger than the reference value by 20% for the tape length of 400 m to 600 m, and thereafter, the servo band pitch was recorded by alternately repeating −20% and +20% of the recording current value every 200 m.

As illustrated in FIG. 27, it has been confirmed that the servo band pitch is narrowed by about 0.05 μm when the recording current value is 20% smaller than the reference value, and the servo band pitch is widened by 0.05 μm when the recording current value is 20% larger than the reference value. The maximum change amount of the servo band pitch, which is the difference between the maximum value and the minimum value, was about 100 nm.

A factor of the change in the servo band pitch is thermal expansion of the head block 402 of each of the magnetic cores h0 to h4 constituting the servo write head 113 due to Joule heat of the coil 70. Due to the thermal expansion of the head block 402, the arrangement interval of the magnetic gaps g changes between the adjacent other head blocks 402. Therefore, by adjusting the thermal expansion amount of the head block 402, the arrangement interval between the adjacent magnetic gaps g, that is, the servo band pitch can be adjusted in the sub-micron order.

In the present embodiment, the magnetic cores h0 to h4 includes a ferrite material. In this case, when the linear expansion coefficient is 11.7×10⁻⁶ [1/°C], for example, a dimensional change of 100 nm from a temperature change of 3 °C is obtained by calculation (11.7×10⁻⁶×3 °C×2.8588 mm). Note that when the reference value (Ref) of the recording current was 1.8 A, a temperature change of 7 °C or more was confirmed in the head block 402 of each of the magnetic cores h0 to h4. The difference from the result of FIG. 27 in which the maximum change amount of the servo band pitch is about 100 nm is presumed to be due to the influence of cooling of the head block 402 due to contact with the traveling magnetic tape MT.

The result of FIG. 27 indicates that the servo band pitch changes depending on the magnitude of the recording current. The larger the recording current value, the larger the change amount of the servo band pitch. For example, FIG. 28 illustrates an experimental result of a relationship among the magnitude of the recording current, the temperature change of the head block 402, and the traveling time of the magnetic tape. As illustrated in FIG. 28, in the same tape traveling time, a temperature rise amount of the head block increases as the recording current value increases. Furthermore, the temperature of the head block tends to slightly rise as the tape traveling time becomes longer.

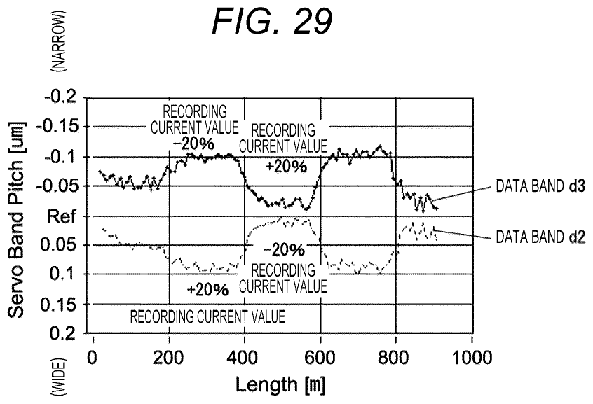

From the above experimental results, it was confirmed that the recording current value was a parameter of the change in the servo band pitch. Subsequently, a change in the servo band pitch of the data bands d2 and d3 when the servo pattern 6 was recorded in each servo band was measured while the magnitude of the recording current was varied between the set of servo bands s0 and s1 and the set of servo bands s3 and s4. The measurement results are illustrated in FIG. 29.

Similarly to the experiment of FIG. 27, FIG. 29 illustrates the change in the servo band pitch for the data bands d2 and d3 when the recording current of the servo pattern 6 is alternately changed to a value (−20%) smaller than the reference current value and a value (+20%) larger than the recording current value in the tape length range of 200 m. The experiment in FIG. 29 is different from the experiment in FIG. 27 in that the recording current values in the servo bands s3 and s4 are set to +20% of the reference current value when the recording current values in the servo bands s0 and s1 are −20% of the reference current value, and the recording current values in the servo bands s3 and s4 are set to −20% of the reference current value when the recording current values in the servo bands s0 and s1 are +20% of the reference current value. Furthermore, in the experiment, a magnetic tape from which the experimental results of FIG. 26 were obtained was used.

As a result, as illustrated in FIG. 29, there is a tape length region in which the difference in the servo band pitch decreases between the two data bands d2 and d3. In the result of the drawing, when the recording current values in the servo bands s0 and s1 are set to +20% of the reference current value and the recording current values in the servo bands s3 and s4 are set to −20% of the reference current value, the servo band pitch between the data bands d2 and d3 can be minimized. As a result, the difference in the servo band pitch between the data bands d2 and d3 can be made smaller than the experimental result illustrated in FIG. 26, and the average value of the differences over the entire length of the tape is 100 nm or less.

In this case, the recording current values in the data bands d1 and d4 other than the data bands d2 and d3 may be reference current values. As a result, since the servo band pitch having the value illustrated in FIG. 26 is obtained, the variation in the servo band pitch between the data bands d2 and d3 can be reduced. The present invention is not limited thereto, and the magnitude of the recording current may be optimized also for the data bands d1 and d4 in order to further reduce the variation in the servo band pitch between the data bands. The optimization of the magnitude of the recording current includes making the recording current supplied to the coil 70 of at least one of the magnetic cores h0 to h4 larger than the recording current supplied to the coil 70 of the other magnetic core.

As described above, according to Application Example 1 of the present embodiment, as illustrated in FIG. 26, even in a case where a tension distribution in which the tension on the data band d3 side is lower than the tension on the data band d2 side is generated at the time of recording the servo pattern 6, the variation in the servo band pitch between the data bands d3 and d2 can be reduced as illustrated in FIG. 29 by increasing the recording current value of the set of the servo bands s3 and s4 sandwiching the data band d2 than the set of the servo bands s0 and s1 sandwiching the data band d3.

As a method for determining the recording current of the servo pattern 6 to be recorded on each servo band s, for example, the servo pattern 6 is recorded on each servo band s with a constant recording current value (for example, a reference current value) over a predetermined tape length (for example, 200 m or more), and then the servo band pitch for each recorded data band is measured by the tape drive device 30. As a result, after the variation in the servo pattern pitch is confirmed for each data band as illustrated in FIG. 26, the recording current value to be supplied to the coil 70 is optimized for each of the magnetic cores h0 to h4 so that the servo band pitch between the data bands is minimized (for example, 100 nm or less). The recording current value is set by adjusting the amplification factor of the amplifier 123 of the drive section 120 in the servo pattern recording device 100. Thereafter, the servo pattern 6 is recorded on each servo band s of the magnetic tape MT with the adjusted recording current value.

### Application Example 2

The temperature adjustment section 80 may have a cooling mechanism capable of individually cooling each of the magnetic cores h0 to h4 constituting the recording section 401 of the servo write head 113 instead of the heating mechanism. The cooling mechanism includes the blower unit 90 configured to be able to individually cool the coil 70 of each of the magnetic cores h0 to h4 or the head block 402.

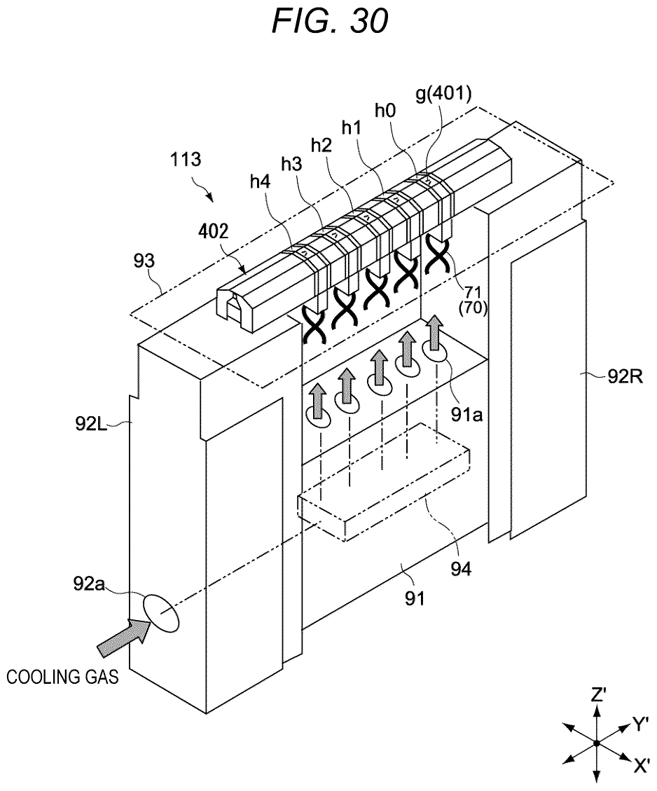

FIG. 30 is a schematic perspective view illustrating a configuration of the servo write head 113 including the blower unit 90.

The blower unit 90 includes a blowing block 91 disposed on a side opposite to the recording surface of the servo write head 113 on which the magnetic gap g is formed, and a pair of positioning blocks 92L and 92R that support both ends of the servo write head 113 in the longitudinal direction (Y′-direction) and position the blowing block 91 with respect to the servo write head 113.

The blowing block 91 is provided with a plurality of gas ejection ports 91a facing the coils 70 of the magnetic cores h0 to h4 in the Z′-axis direction. One positioning block 92L of the pair of positioning blocks 92L and 92R is provided with a gas introduction port 92a through which a cooling gas can be introduced. The gas introduction port 92a passes through the inside of the positioning block 92L and the inside of the blowing block 92 and communicates with the plurality of gas ejection ports 91a. As a result, since the coils 70 of the magnetic cores h0 to h4 are cooled by the cooling gas ejected from the gas ejection port 92a, thermal expansion due to temperature rise of the head block 402 due to Joule heat of the coil 70 is suppressed.

The cooling gas is typically air, but a gas such as nitrogen may be used. The temperature of the cooling gas is typically room temperature, but the cooling gas may be a gas cooled to room temperature or less. Furthermore, a nozzle having directivity in the gas ejection direction may be added to the gas ejection application 92a so that each gas ejection port 92a and each coil 70 individually correspond to each other. Furthermore, in order to prevent the cooling gas ejected from the gas ejection port 92a from going around the head block 402 and being blown against the magnetic tape MT traveling on the recording section 401 (see FIG. 30) of the servo write head 113, a shield plate 93 for windshield may be disposed around the head block 402.

The blower unit 90 may be configured to uniformly cool the coils 70 of the magnetic cores h0 to h4, but may be configured to be able to individually adjust the amount of gas ejected to each coil 70 so as to provide a temperature gradient to each of the magnetic cores h0 to h4.

In this case, the blower unit 90 further includes a valve mechanism 94 capable of individually adjusting an amount of the cooling gas ejected from each gas ejection port 91a. The valve mechanism 94 is configured such that the cooling gas introduced from the gas introduction port 92a is individually divided and ejected from each gas ejection port 92a, and the ejection amount of the cooling gas can be adjusted for each gas ejection port 91a. The adjustment of the ejection amount of the cooling gas by the valve mechanism 94 is executed by the controller 130 of the servo pattern recording device 100.

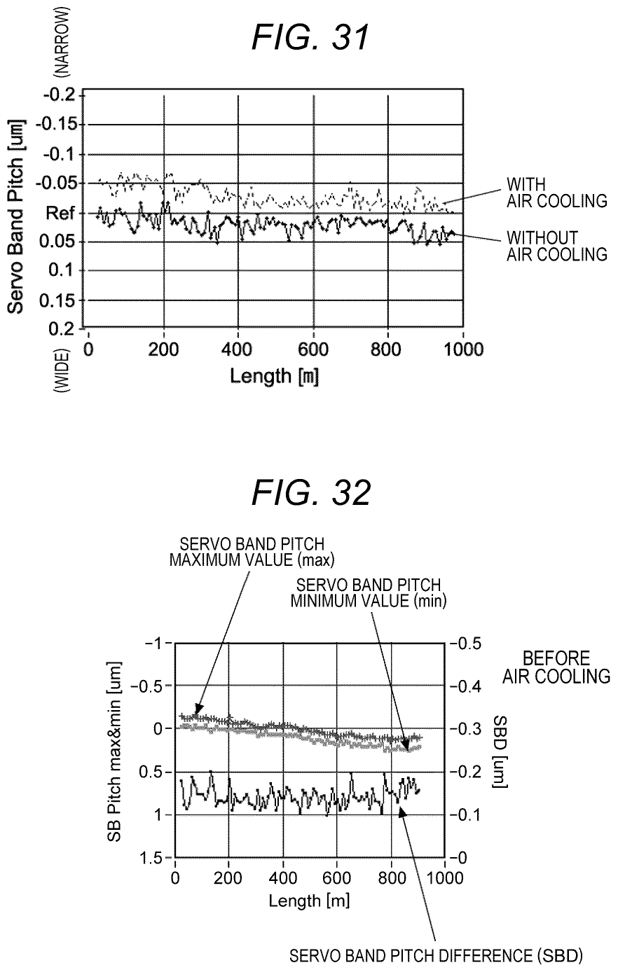

FIG. 31 is an experimental result illustrating how the servo pattern pitch changes depending on whether a cooling gas (air) is introduced. The horizontal axis represents the tape length, and the vertical axis represents the amount of change from the reference value (P1:2858.8 μm) of the servo band pitch. Here, the servo band pitch between the two servo bands s3 and s4 adjacent to the data band d2 was measured.

As illustrated in FIG. 31, it was confirmed that the servo band pitch was narrower by 0.05 μm (50 nm) in a case where the cooling gas was introduced than a case where the cooling gas was not introduced. As a result, by adjusting the flow rate of the cooling gas blown to the coil 70 of the magnetic cores h0 to h4 as the heat source, the temperature gradient is given to each of the magnetic cores h0 to h4, so that it is possible to reduce the variation in the servo band pitch for each data band. The adjustment of the flow rate of the cooling gas includes making the flow rate of the cooling gas supplied to the coil 70 of at least one of the magnetic cores h0 to h4 larger than the flow rate of the cooling gas supplied to the coil 70 of the other magnetic core.

FIGS. 32 to 34 are results of experiments in which a certain record current is supplied to the coil 70 of each of the magnetic cores h0 to h4 and a magnetic tape MT in which the servo pattern 6 is recorded on each servo band is produced, the results illustrating the maximum value (max) and the minimum value (min) of the servo band pitch, which is the interval between two adjacent servo bands, and the difference between the maximum value and the minimum value (servo band pitch difference: SBD).

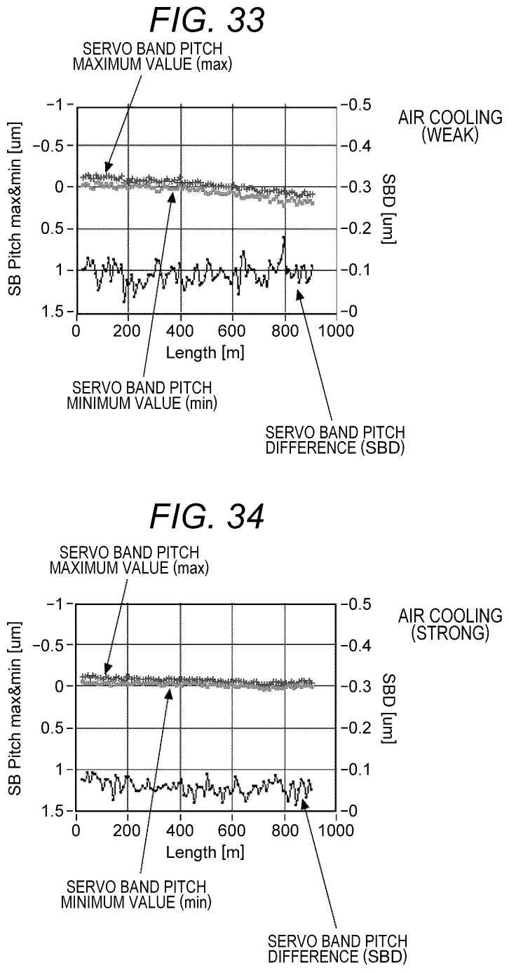

Here, FIG. 32 illustrates an experimental result when the servo pattern is recorded without cooling the servo write head 113 with the cooling gas, and FIG. 33 illustrates an experimental result when the servo pattern is recorded while cooling the servo write head 113 with the cooling gas at a flow rate of 3 L/min. Furthermore, FIG. 34 illustrates an experimental result when the servo pattern is recorded while the servo write head 113 is cooled with the cooling gas having a flow rate of 10 L/min. In each drawing, the horizontal axis represents the tape length, and the left vertical axis represents the amount of change from the reference value (P1:2858.8 μm) of the maximum value and the minimum value of the servo pattern pitch. Furthermore, the right vertical axis indicates a difference in the servo band pitch of the servo pattern pitch.

As a result of the experiment, when the servo patterns were recorded without cooling the servo write head 113, the average value of the differences of the servo band pitches over the entire tape length was 0.141 μm (FIG. 32). The difference in the servo band pitch is caused by a change in the distance between the magnetic cores (magnetic gaps g) caused by linear expansion of the head block 402 due to Joule heat of the coil 70 generated when a recording current flows to the magnetic cores h0 to h4.

On the other hand, when the servo pattern was recorded while the servo write head 113 was cooled with the cooling gas having the flow rate of 3 L/min, the average value of the differences of the servo band pitches over the entire length of the tape was 0.090 μm (FIG. 33). Furthermore, when the servo pattern was recorded while the servo write head 113 was cooled with the cooling gas having the flow rate of 10 L/min, the average value of the differences of the servo band pitches over the entire length of the tape was 0.057 μm (FIG. 34).

As described above, by cooling the coil 70 of each of the magnetic cores h0 to h4 with the cooling gas, thermal expansion of the head block 402 due to Joule heat of the coil 70 can be suppressed, and the difference in servo band pitch can be suppressed to 0.1 μm (100 nm) or less. Furthermore, since the above effect remarkably appears as the flow rate of the cooling gas is increased, the flow rate of the cooling gas can be optimized in consideration of the difference in the servo band pitch before cooling.

Furthermore, according to the application example of the present embodiment, it is also possible to improve the influence of the tension distribution along the width direction of the magnetic tape at the time of servo pattern recording. In this case, it is possible to adopt a method of suppressing the spread between the servo bands at the time of reproduction in the tape drive device 30 and reducing the difference between the servo band pitches by providing a temperature gradient between the magnetic cores h0 to h4 by increasing the flow rate of the cooling gas in the servo band region with high tension.

In this case, as a method of determining the flow rate of the cooling gas, for example, the servo pattern 6 is recorded in each servo band s with a constant recording current value (for example, a reference current value) over a predetermined tape length (for example, 200 m or more), and then the servo band pitch for each recorded data band is measured by the tape drive device 30. As a result, after the variation in the servo pattern pitch is confirmed for each data band as illustrated in FIG. 26, the flow rate of the cooling gas supplied to the coil 70 is optimized for each of the magnetic cores h0 to h4 so that the servo band pitch between the data bands is minimized (for example, 100 nm or less). Thereafter, the servo pattern 6 is recorded on each servo band s of the magnetic tape MT in a state where the ejection amount of the cooling gas from each gas ejection port 92a is adjusted by the valve mechanism 94 so as to have the set flow rate of the cooling gas.

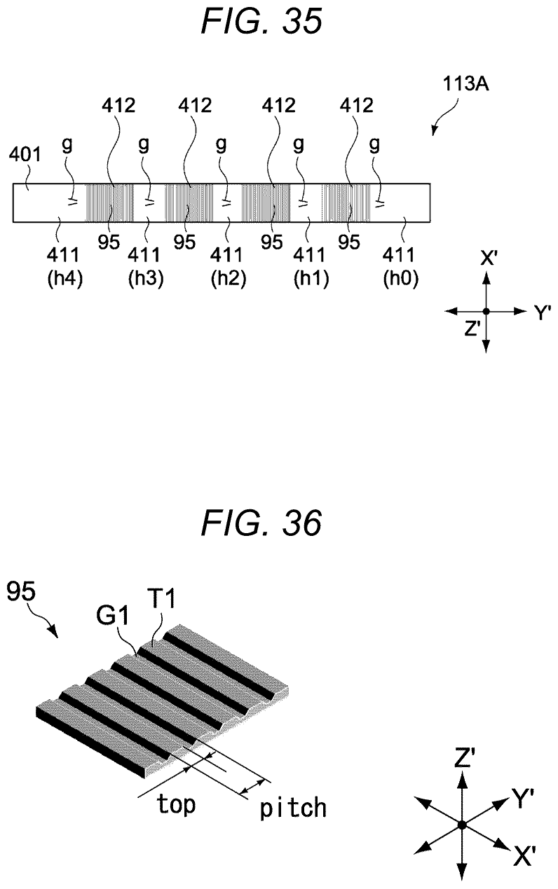

In order to enhance the cooling effect of the servo write head 113 by the blower unit 90, a plurality of grooves may be provided in the recording section 401 of the servo write head 113. FIG. 35 is a schematic plan view of the servo write head 113A including the plurality of groove portions.

The servo write head 113A includes a recording section 401 that records a servo pattern on the magnetic tape MT by a magnetic gap g of each of the magnetic cores h0 to h4. The recording section 401 includes a first region 411 corresponding to a position where the magnetic gap g is provided in the length direction (Y′ direction, width direction of magnetic tape MT), and a second region 412 corresponding to a position where the magnetic gap g is not provided in the length direction. The second region 412 is provided with a plurality of groove portions 95 extending from one end in a width direction (X′ direction, length direction of magnetic tape MT) orthogonal to the length direction to the other end in the width direction and crossing the one end.

The second region 412 is located between the magnetic cores h0 to h4 having the first region 411, and the groove portion 95 is formed between the magnetic gaps g of the magnetic cores h0 to h4. FIG. 36 is an enlarged perspective view illustrating details of each of the groove portions 95.

In the present embodiment, the plurality of groove portions 95 is arranged at intervals in the length direction (Y′-axis direction) of the recording section 401, and are linearly formed in parallel to the width direction (X′-axis direction) of the recording section 401. As illustrated in FIG. 36, the groove portion 95 includes a square groove G1 having a flat bottom portion. A flat top portion T1 is formed between two adjacent corner grooves G1. In this example, the depth of the square groove G1 is about 1 μm, the groove width of the bottom portion of the square groove G1 is about 5 μm, the width (top) of the top portion T1 is about 5 μm, and the arrangement pitch (pitch) of the square grooves G1 is about 10 μm. Note that the size of each part is not limited to the above example, and for example, the groove width of the bottom of the square groove G1 can be appropriately set to 5 μm to 20 μm, and the arrangement pitch of the square grooves G1 can be appropriately set to 10 μm to 25 μm.

Since the servo write head 113A is provided with the plurality of groove portions 95 in the second region 412, the magnetic tape MT can be floated from the second region 412 by increasing the amount of air flowing through the second region 412 when the magnetic tape MT travels. As a result, the magnetic tape MT can be caused to travel substantially in a non-contact manner with the second region 412 while the magnetic tape MT is stably brought into contact with the first region 411 having the magnetic gap g, so that friction between the recording section 401 and the magnetic tape MT can be reduced, and the accuracy of recording of the servo pattern 7 can be improved.

Furthermore, since the magnetic tape MT can be floated from the second region 412, the temperature rise of the servo write head 113A due to the contact frictional heat with the magnetic tape MT can be suppressed. Moreover, since the cooling effect of the second region 412 is obtained by the air flowing between the plurality of groove portions 95, the heat dissipation effect of the first region 411 having the magnetic gap g can be obtained. This makes it possible to reduce variations in the servo band pitch.

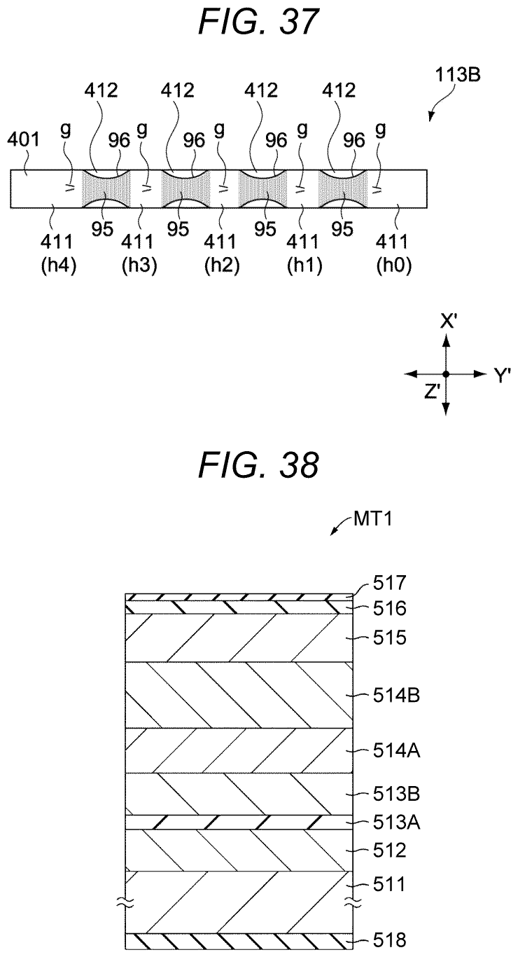

FIG. 37 is a schematic plan view of a servo write head 113B illustrating a modification of FIG. 35. The servo write head 113B is different from the servo write head 113A of FIG. 35 in that two cutout portions 96 facing each other in the width direction (X′-axis direction) are provided in the second region 412.

Each of the cutout portions 96 is formed by cutting out an end portion in the width direction (X′-axis direction) of the second region 412 in an arc shape. The shape of the cutout portion 96 is not limited to the arc shape, and may be a rectangular shape, a triangular shape, or the like. The plurality of groove portions 95 is formed on the surface of the second region 412 so as to be sandwiched by the cutout portions 96 in the width direction.

The dimension of the second region 412 in the width direction is reduced by the cutout portion 96. In particular, since the cutout portion 96 has an arc shape, the second region 412 is formed in a shape narrowed at the center in the length direction (Y′-axis direction). As a result, the air easily flows into the second region 412 from the cutout portion 96 located on the upstream side in the tape traveling direction, and the air easily passes between the second region 412 and the magnetic tape MT. Therefore, the magnetic tape MT is easily floated from the second region 412, and the cooling effect of the servo write head 113B can be further enhanced.

### (6) Operation and Effect

As described above, in the magnetic tape MT according to the first embodiment, the average width change amount ΔA of the magnetic tape MT before and after the magnetic tape MT is left still for 40 hours in an environment at a temperature of 50 °C and a relative humidity of 40% RH in a state where a tension of 0.55 N is applied in the longitudinal direction is 170 ppm or less, so that it is possible to sufficiently suppress the creep deformation of the magnetic tape MT in a high-temperature environment over a long period of time (for example, 10 years) in addition to the deformation of the magnetic tape MT caused by the environment. As a result, even in a case where the magnetic tape MT is stored or traveled under a high-temperature environment for a long period of time (for example, 10 years), a change in the width of the magnetic tape MT can be suppressed.

Furthermore, since the average tension responsiveness to the tension in the longitudinal direction in an environment of a temperature of 50 °C and a relative humidity of 40% RH is 700 ppm/N or more, it is possible to satisfactorily correct the width change of the magnetic tape MT in a high-temperature environment.

Therefore, even in a case where the magnetic tape MT is stored or traveled in a high-temperature environment for a long period of time (for example, 10 years), the width change of the magnetic tape MT can be corrected by adjusting the traveling tension of the magnetic tape MT.

Furthermore, the magnetic tape MT according to the first embodiment can be used in the tape drive device 30 capable of coping with a change in width of the magnetic tape MT by adjusting the azimuth angle θ of the drive head 36. In the tape drive device 30, typically, when the width of the magnetic tape MT becomes relatively wide, the azimuth angle θ of the drive head 36 is decreased, and conversely, when the width of the magnetic tape MT becomes relatively narrow, the azimuth angle θ of the drive head 36 is increased. As a result, the servo pattern 6 of the magnetic tape MT is accurately read even in a case where the width of the magnetic tape MT changes. Therefore, even in a case where the width of the magnetic tape MT changes in a high-temperature environment, the width change can be handled by adjusting the azimuth angle θ of the drive head 36.

### 2. Second Embodiment

In the first embodiment described above, the case where the magnetic tape MT is a coating type magnetic tape in which the underlayer, the magnetic layer, and the like are prepared by the coating step (wet process) has been described. However, the magnetic tape MT may be a vacuum thin film type magnetic tape in which the underlayer, the magnetic layer, and the like are prepared by a vacuum thin film preparation technique (dry process) such as sputtering.

### (1) Configuration of Magnetic Tape

FIG. 38 is a cross-sectional view illustrating an example of a configuration of a vacuum thin film type magnetic tape MT1 according to a second embodiment of the present technology. The magnetic tape MT1 is an elongated perpendicular magnetic recording medium, and includes a film-like base 511, a soft magnetic underlayer (hereinafter, referred to as “SUL”) 512, a first seed layer 513A, a second seed layer 513B, a first underlayer 514A, a second underlayer 514B, and a magnetic layer 515. The SUL 512, the first and second seed layers 513A and 513B, the first and second base layers 514A and 514B, and the magnetic layer 515 are, for example, vacuum thin films such as sputtered films.

The SUL 512, the first and second seed layers 513A and 513B, and the first and second underlayers 514A and 514B are provided between one principal surface (hereinafter, referred to as a “front surface”) of the base 511 and the magnetic layer 515, and the SUL 512, the first seed layer 513A, the second seed layer 513B, the first underlayer 514A, and the second underlayer 514B are laminated in order from the base 511 toward the magnetic layer 515.

The magnetic tape MT1 may further include a protective layer 516 provided on the magnetic layer 515 and a lubricating layer 517 provided on the protective layer 516 as needed. Furthermore, the magnetic tape MT1 may further include a back layer 518 provided on the other principal surface (hereinafter referred to as a “back surface”) of the base 511 as needed.

Hereinafter, the longitudinal direction of the magnetic tape MT1 (the longitudinal direction of the base 511) is referred to as a machine direction (MD). Here, the machine direction means a relative movement direction of the recording and reproducing head with respect to the magnetic tape MT1, that is, a direction in which the magnetic tape MT1 travels at the time of recording and reproducing.

The magnetic tape MT1 according to the second embodiment is suitable for use as a data archive storage medium, which is expected to increase in demand in the future. The magnetic tape MT1 can realize, for example, a surface recording density of 10 times or more the current coating type magnetic recording medium for storage, that is, a surface recording density of 50 Gb/in² or more. In a case where a general linear recording type data cartridge is configured using the magnetic tape MT1 having such a surface recording density, it is possible to perform large-capacity recording of 100 TB or more per data cartridge.

The magnetic tape MT1 according to the second embodiment is suitable for use in a recording/reproduction device (recording/reproduction device for recording/reproducing data) including a ring-type recording head and a giant magnetoresistive (GMR) type or tunneling magnetoresistive (TMR) type reproducing head. Furthermore, the magnetic tape MT1 according to the second embodiment preferably uses a ring type recording head as a servo signal writing head. In the magnetic layer 515, a data signal is vertically recorded by, for example, a ring type recording head. Furthermore, in the magnetic layer 515, a servo signal is vertically recorded by, for example, a ring type recording head.

The average thickness t_{T}, the average width change amount ΔA, and the average tension responsiveness of the magnetic tape MT1 in the second embodiment are similar to those in the first embodiment.

### [Base]

The base 511 is similar to the base 41 in the first embodiment.

### [SUL]

The SUL 512 contains a soft magnetic material in an amorphous state. The soft magnetic material includes, for example, at least one of a Co-based material or an Fe-based material. The Co-based material includes, for example, CoZrNb, CoZrTa, or CoZrTaNb. The Fe-based material includes, for example, FeCoB, FeCoZr, or FeCoTa.

The SUL 512 is a single-layer SUL and is provided directly on the base 511. An average thickness of the SUL 512 is preferably 10 nm or more and 50 nm or less, and more preferably 20 nm or more and 30 nm or less.

The average thickness of the SUL 512 is obtained in a manner similar to that of the magnetic layer 43 in the first embodiment. Note that an average thickness of the layer other than the SUL 512 (that is, an average thickness of each of the first and second seed layers 513A and 513B, the first and second underlayers 514A and 514B, and the magnetic layer 515) described later is also obtained by the similar method as the method of measuring the average thickness of the magnetic layer 43 in the first embodiment. However, magnification of the TEM image is appropriately adjusted according to the thickness of each layer.

### [First and Second Seed Layers]

The first seed layer 513A contains an alloy containing Ti and Cr, and has an amorphous state. Furthermore, the alloy may further contain oxygen (O). The oxygen may be impurity oxygen contained in a trace amount in the first seed layer 513A when the first seed layer 513A is formed by a film forming method such as a sputtering method or the like.

Here, the “alloy” means at least one of a solid solution containing Ti and Cr, a eutectic material, an intermetallic compound, or the like. The “amorphous state” means that a halo is observed by X-ray diffraction, electron beam diffraction, or the like, and a crystal structure cannot be specified.

An atomic ratio of Ti to the total amount of Ti and Cr contained in the first seed layer 513A is preferably in a range of 30 atomic % or more and less than 100 atomic % or less, and more preferably in a range of 50 atomic % or more and less than 100 atomic %. When the atomic ratio of Ti is less than 30%, a (100) plane of a body-centered cubic lattice (bcc) structure of Cr is oriented, and there is a possibility that the orientation of the first and second underlayers 514A and 514B formed on the first seed layer 513A is deteriorated.

The atomic ratio of Ti described above is determined as follows. Depth direction analysis (depth profile measurement) of the first seed layer 513A by auger electron spectroscopy (hereinafter, referred to as “AES”) is performed while ion-milling the magnetic tape MT1 from the magnetic layer 515 side. Next, an average composition (average atomic ratio) of Ti and Cr in a film thickness direction is determined from the obtained depth profile. Next, the atomic ratio of Ti described above is determined using the determined average composition of Ti and Cr.

In a case where the first seed layer 513A contains Ti, Cr, and O, an atomic ratio of O to the total amount of Ti, Cr, and O contained in the first seed layer 513A is preferably 15 atomic % or less, and more preferably 10 atomic % or less. When the atomic ratio of O exceeds 15 atomic %, a TiO₂ crystal is generated, such that crystal nucleation formation in the first and second underlayers 514A and 514B formed on the first seed layer 513A is affected, and the orientation of the first and second underlayers 514A and 514B may be deteriorated. The atomic ratio of O described above is determined using the analysis method similar to that of the atomic ratio of Ti described above.

The alloy contained in the first seed layer 513A may further contain elements other than Ti and Cr as additive elements. Examples of the additive element include one or more elements selected from the group consisting of Nb, Ni, Mo, Al, W, and the like.

An average thickness of the first seed layer 513A is preferably 2 nm or more and 15 nm or less, and more preferably 3 nm or more and 10 nm or less.

The second seed layer 513B contains, for example, NiW or Ta, and has a crystalline state. An average thickness of the second seed layer 513B is preferably 3 nm or more and 20 nm or less, and more preferably 5 nm or more and 15 nm or less.

The first and second seed layers 513A and 513B have a crystal structure similar to those of the first and second underlayers 514A and 514B, and are not seed layers provided for the purpose of crystal growth, but are seed layers that improve the vertical orientation of the first and second underlayers 514A and 514B by the amorphous state of the first and second seed layers 513A and 513B.

### [First and Second Underlayers]

The first and second underlayer 514A and 514B preferably have a crystal structure similar to that of the magnetic layer 515. In a case where the magnetic layer 515 contains a Co-based alloy, it is preferable that the first and second underlayers 514A and 514B contain a material having a hexagonal close-packed (hcp) structure similar to that of the Co-based alloy, and a c-axis of the structure is oriented in a direction perpendicular to the film surface (that is, a film thickness direction). This is because the orientation of the magnetic layer 515 can be enhanced, and a lattice constant matching between the second underlayer 514B and the magnetic layer 515 can be relatively preferable. As the material having a hexagonal close-packed (hcp) structure, a material containing Ru is preferably used, and specifically, Ru alone or a Ru alloy is preferable. Examples of the Ru alloy include Ru alloy oxides such as Ru—SiO₂, Ru—TiO₂, Ru—ZrO₂, and the like.

As described above, similar materials can be used as the materials of the first and second underlayers 514A and 514B. However, the targeted effects of the first and second underlayers 514A and 514B are different from each other. Specifically, the second underlayer 514B has a film structure that promotes a granular structure of the magnetic layer 515 as an upper layer thereof, and the first underlayer 514A has a film structure with high crystal orientation. In order to obtain such a film structure, it is preferable that film formation conditions such as sputtering conditions and the like of the first and second underlayers 514A and 514B are different from each other.

An average thickness of the first underlayer 514A is preferably 3 nm or more and 15 nm or less, and more preferably 5 nm or more and 10 nm or less. An average thickness of the second underlayer 514B is preferably 7 nm or more and 40 nm or less, and more preferably 10 nm or more and 25 nm or less.

### [Magnetic Layer]

The magnetic layer (also referred to as a recording layer) 515 may be a perpendicular magnetic recording layer in which a magnetic material is vertically oriented. The magnetic layer 515 may be a vacuum thin film such as a sputtered film. From the viewpoint of improving the recording density, the magnetic layer 515 is preferably a granular magnetic layer containing a Co-based alloy. The granular magnetic layer includes ferromagnetic crystal particles containing a Co-based alloy and a non-magnetic grain boundary (non-magnetic body) surrounding the ferromagnetic crystal particles. More specifically, the granular magnetic layer includes columns (columnar crystals) containing a Co-based alloy, and a non-magnetic grain boundary (for example, an oxide such as SiO2 or the like) that surrounds the column and magnetically separates each column. In the structure, the magnetic layer 515 having a structure in which the columns are magnetically separated can be configured.

The Co-based alloy has a hexagonal close-packed (hcp) structure, and a c-axis thereof is oriented in a direction perpendicular to the film surface (film thickness direction). As the Co-based alloy, a CoCrPt-based alloy containing at least Co, Cr, and Pt is preferably used. The CoCrPt-based alloy is not particularly limited, and the CoCrPt alloy may further contain an additive element. Examples of the additive element include one or more elements selected from the group consisting of Ni, Ta, and the like.

The non-magnetic grain boundary surrounding the ferromagnetic crystal grains contains a non-magnetic metal material. Here, the metal includes a semimetal. As the nonmagnetic metal material, for example, at least one of a metal oxide or a metal nitride can be used, and from the viewpoint of more stably maintaining the granular structure, it is preferable to use a metal oxide. Examples of the metal oxide include metal oxides including at least one element selected from the group consisting of Si, Cr, Co, Al, Ti, Ta, Zr, Ce, Y, Hf, and the like, and metal oxides including at least a Si oxide (that is, SiO₂) are preferable. Specific examples of the metal oxide include SiO₂, Cr₂O₃, CoO, Al₂O₃, TiO₂, Ta₂O₅, ZrO₂, HfO₂, and the like. Examples of the metal nitride include metal nitrides including at least one element selected from the group consisting of Si, Cr, Co, Al, Ti, Ta, Zr, Ce, Y, Hf, and the like. Specific examples of the metal nitride include SiN, TiN, AlN, and the like.

It is preferable that the CoCrPt-based alloy contained in the ferromagnetic crystal particles and the Si oxide contained in the non-magnetic grain boundary have an average composition represented by the following Formula (1). This is because it is possible to realize a saturation magnetization amount Ms capable of suppressing the influence of a demagnetizing field and securing a sufficient reproduction output, and therefore, the recording and reproducing characteristics can be further improved.

(CoₓPt_{y}Cr_{100-x-y})_{100-z}—(SiO₂)_{z} (1)

(Here, in Formula (1), x, y, and z are values within the ranges of 69≤X≤75, 10≤y≤16, and 9≤Z≤12, respectively.)

Note that the composition described above can be determined as follows. A depth direction of the magnetic layer 515 is analyzed by AES while ion-milling the magnetic tape MT1 from the magnetic layer 515 side, and an average composition (average atomic ratio) of Co, Pt, Cr, Si, and O in the film thickness direction is determined.

An upper limit value of an average thickness of the magnetic layer 515 is preferably 90 nm or less, especially preferably 80 nm or less, more preferably 70 nm or less, and still more preferably 60 nm or less, and particularly preferably 50 nm or lee, 20 nm or less or 15 nm or less. A lower limit value of the average thickness of the magnetic layer 515 is preferably 9 nm or more. When the average thickness of the magnetic layer 515 is 9 nm or more and 90 nm or less, electromagnetic conversion characteristics can be improved.

### [Protective Layer]

The protective layer 516 contains, for example, a carbon material or silicon dioxide (SiO2), and preferably contains a carbon material from the viewpoint of the film strength of the protective layer 516. Examples of the carbon material include graphite, diamond-like carbon (DLC), diamond, and the like.

### [Lubricating Layer]

The lubricating layer 517 contains at least one lubricant. The lubricating layer 517 may further contain various additives, for example, a corrosion inhibitor and the like, as needed. As a material of the lubricant, a material similar to that of the magnetic layer 43 in the first embodiment can be exemplified.

Note that the lubricant is not only held as the lubricating layer 517 on the surface of the magnetic tape MT1 as described above, but may also be included and held in layers such as the magnetic layer 515, the protective layer 516, and the like constituting the magnetic tape MT1.

### [Back Layer]

The back layer 518 is similar to the back layer 44 in the first embodiment.

### (2) Configuration of Sputtering Device

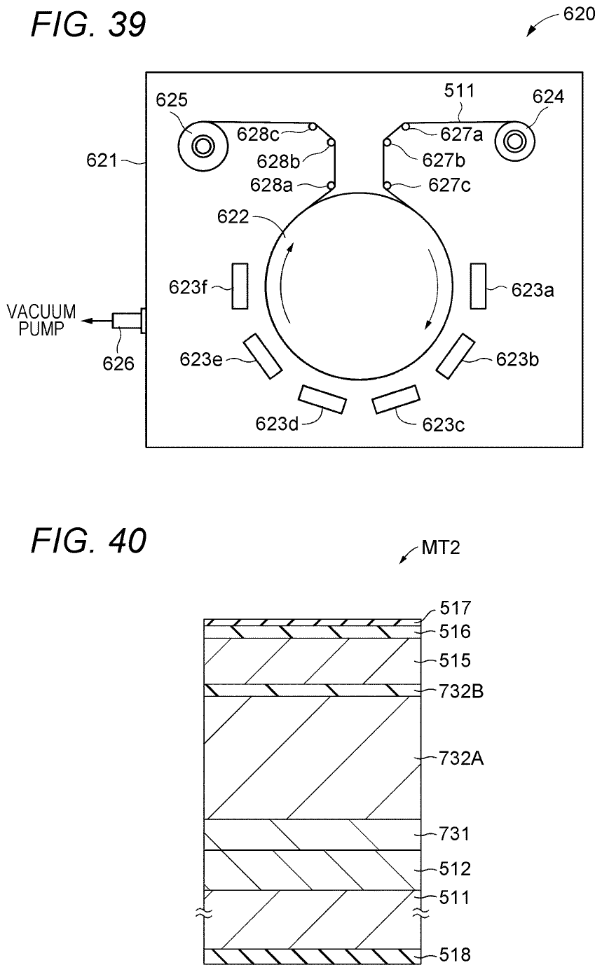

Hereinafter, an example of a configuration of a sputtering device 620 used for manufacturing the magnetic tape MT1 according to the second embodiment will be described with reference to FIG. 39. The sputtering device 620 is a continuous winding type sputtering device used for forming a film of the SUL 512, the first seed layer 513A, the second seed layer 513B, the first underlayer 514A, the second underlayer 514B, and the magnetic layer 515, and includes a film forming chamber 621, a drum 622 which is a metal can (rotating body), cathodes 623a to 623f, a supply reel 624, a winding reel 625, and a plurality of guide rollers 627a to 627c and 628a to 628c. The sputtering device 620 is, for example, a direct current (DC) magnetron sputtering system device, but the sputtering system is not limited to this system.

The film forming chamber 621 is connected to a vacuum pump (not illustrated) via an exhaust port 626, and the atmosphere in the film forming chamber 621 is set to a predetermined degree of vacuum by the vacuum pump. In the inside of the film forming chamber 621, the drum 622 having a rotatable configuration, the supply reel 624, and the winding reel 625 are disposed. The inside of the film forming chamber 621 is provided with the plurality of guide rollers 627a to 627c for guiding the transport of the base 511 between the supply reel 624 and the drum 622, and the plurality of guide rollers 628a to 628c for guiding the transport of the base 511 between the drum 622 and the winding reel 625. At the time of sputtering, the base 511 unwound from the supply reel 624 is wound around the winding reel 625 via the guide rollers 627a to 627c, the drum 622, and the guide rollers 628a to 628c. The drum 622 has a cylindrical shape, and the elongated base 511 is transported along a cylindrical circumferential surface of the drum 622. The drum 622 is provided with a cooling mechanism (not illustrated), and is cooled to, for example, about −20 °C during sputtering. In the inside of the film forming chamber 621, the plurality of cathodes 623a to 623f is arranged so as to face the circumferential surface of the drum 622. Targets are set for these cathodes 623a to 623f, respectively. Specifically, targets for forming the SUL 512, the first seed layer 513A, the second seed layer 513B, the first underlayer 514A, the second underlayer 514B, and the magnetic layer 515 are set in the cathodes 623a, 623b, 623c, 623d, 623e, and 623f, respectively. These cathodes 623a to 623f simultaneously form a plurality of types of films, that is, the SUL 512, the first seed layer 513A, the second seed layer 513B, the first underlayer 514A, the second underlayer 514B, and the magnetic layer 515.

In the sputtering device 620 having the configuration described above, the SUL 512, the first seed layer 513A, the second seed layer 513B, the first underlayer 514A, the second underlayer 514B, and the magnetic layer 515 can be continuously formed by a roll-to-roll method.

### (3) Manufacturing Method of Magnetic Tape

The magnetic tape MT1 according to the second embodiment can be manufactured, for example, as follows.

First, the SUL 512, the first seed layer 513A, the second seed layer 513B, the first underlayer 514A, the second underlayer 514B, and the magnetic layer 515 are sequentially formed on the surface of the base 511 using the sputtering device 620 illustrated in FIG. 39. Specifically, the film is formed as follows. First, the film forming chamber 621 is evacuated until a predetermined pressure is reached. Thereafter, the targets set in the cathodes 623a to 623f are sputtered while a process gas such as an Ar gas or the like is introduced into the film forming chamber 621. Therefore, the SUL 512, the first seed layer 513A, the second seed layer 513B, the first underlayer 514A, the second underlayer 514B, and the magnetic layer 515 are sequentially formed on the surface of the running base 511.

The atmosphere of the film forming chamber 621 during sputtering is set to, for example, about 1×10⁻⁵ Pa to 5×10⁻⁵ Pa. The film thicknesses and characteristics of the SUL 512, the first seed layer 513A, the second seed layer 513B, the first underlayer 514A, the second underlayer 514B, and the magnetic layer 515 can be controlled by adjusting the tape line speed at which the base 511 is wound up, the pressure (sputtering gas pressure) of a process gas such as an Ar gas or the like introduced during sputtering, the input power, and the like.

Next, the protective layer 516 is formed on the magnetic layer 515. As a method of forming the protective layer 516, for example, a chemical vapor deposition (CVD) method or a physical vapor deposition (PVD) method can be used.

Next, a binder, inorganic particles, a lubricant, and the like are kneaded and dispersed in a solvent to prepare a paint for forming a back layer. Next, the back layer 518 is deposited on the back surface of the base 511 by applying a coating material for deposition of the back layer on the back surface of the base 511 and drying the coating material.

Next, for example, a lubricant is applied onto the protective layer 516 to form the lubricating layer 517. As a method of applying the lubricant, for example, various coating methods such as gravure coating, dip coating, and the like can be used. Next, the magnetic tape MT1 is cut into a predetermined width as needed. Therefore, the magnetic tape MT1 illustrated in FIG. 38 can be obtained.

### (4) Operation and Effect

In the magnetic tape MT1 according to the second embodiment, as in the first embodiment, even in a case where the magnetic tape MT1 is stored or traveled under a high-temperature environment for a long period of time (for example, 10 years), the width change of the magnetic tape MT1 can be corrected by adjusting the traveling tension of the magnetic tape MT1. Furthermore, even in a case where the width of the magnetic tape MT1 changes in a high-temperature environment, the width change can be handled by adjusting the azimuth angle θ of the drive head 36.

### 3. Third Embodiment

### (1) Configuration of Magnetic Tape

FIG. 40 is a cross-sectional view illustrating an example of a configuration of a vacuum thin film type magnetic tape MT2 according to a third embodiment of the present technology. The magnetic tape MT2 includes a base 511, an SUL 512, a seed layer 731, a first underlayer 732A, a second underlayer 732B, and a magnetic layer 515. Note that, in the third embodiment, a portion similar to that in the second embodiment is assigned with the same reference sign and the description thereof is omitted.

The SUL 512, the seed layer 731, and the first and second underlayers 732A and 732B are provided between one principal surface of the base 511 and the magnetic layer 515, and the SUL 512, the seed layer 731, the first underlayer 732A, and the second underlayer 732B are laminated in order from the base 511 toward the magnetic layer 515.

### [Seed Layer]

The seed layer 731 contains Cr, Ni, and Fe and has a face-centered cubic lattice (fcc) structure, and a (111) plane of the face-centered cubic structure is preferentially oriented so as to be parallel to the surface of the base 511. Here, the preferential orientation means a state in which a diffraction peak intensity from the (111) plane of the face-centered cubic lattice structure is larger than diffraction peaks from other crystal planes in the θ-2θ scan of an X-ray diffraction method, or a state in which only the diffraction peak intensity from the (111) plane of the face-centered cubic lattice structure is observed in the θ-2θ scan of the X-ray diffraction method.

An intensity ratio of the X-ray diffraction of the seed layer 731 is preferably 60 cps/nm or more, more preferably 70 cps/nm or more, and still more preferably 80 cps/nm or more, from the viewpoint of improving the SNR. Here, the intensity ratio of the X-ray diffraction of the seed layer 731 is a value (I/D (cps/nm)) determined by dividing an intensity I (cps) of the X-ray diffraction of the seed layer 731 by an average thickness D (nm) of the seed layer 731.

Cr, Ni, and Fe contained in the seed layer 731 preferably have an average composition represented by the following Formula (2).

Cr_{X}(Ni_{Y}Fe_{100-Y})_{100-X} (2)

(In Formula (2), X and Y fall within the ranges of 10≤X≤45 and 60≤Y≤90, respectively.)

Similarly, when X is within the range described above, the (111) orientation of the face-centered cubic lattice structure of Cr, Ni, and Fe can be improved, and a more excellent SNR can be obtained. Similarly, when Y is within the range described above, the (111) orientation of the face-centered cubic lattice structure of Cr, Ni, and Fe can be improved, and a more excellent SNR can be obtained.

An average thickness of the seed layer 731 is preferably 5 nm or more and 40 nm or less. When the average thickness of the seed layer 731 is within the range, the (111) orientation of the face-centered cubic lattice structure of Cr, Ni, and Fe is improved, and a more excellent SNR can be obtained. Note that the average thickness of the seed layer 731 is determined in a manner similar to that of the magnetic layer 43 in the first embodiment. However, magnification of the TEM image is appropriately adjusted according to the thickness of the seed layer 731.

### [First and Second Underlayers]

The first underlayer 732A contains Co and O having a face-centered cubic lattice structure, and has a column (columnar crystal) structure. In the first underlayer 732A containing Co and O, an effect (function) substantially similar to that of the second underlayer 732B containing Ru can be obtained. A concentration ratio of an average atomic concentration of O to an average atomic concentration of Co ((average atomic concentration of O)/(average atomic concentration of Co)) is 1 or more. When the concentration ratio is 1 or more, the effect of providing the first underlayer 732A can be improved, and a more excellent SNR can be obtained.

The column structure is preferably inclined from the viewpoint of improving the SNR. The direction of the inclination is preferably the longitudinal direction of the elongated magnetic tape MT2. The reason why the longitudinal direction is preferable is as follows. The magnetic tape MT2 according to the present embodiment is a so-called magnetic recording medium for linear recording, and a recording track is parallel to the longitudinal direction of the magnetic tape MT2. Furthermore, the magnetic tape MT2 according to the present embodiment is also a so-called perpendicular magnetic recording medium, and from the viewpoint of recording characteristics, it is preferable that the crystal orientation axis of the magnetic layer 515 is in the vertical direction. However, there is a case where the crystal orientation axis of the magnetic layer 515 is inclined due to the influence of the inclination of the column structure of the first underlayer 732A. In the magnetic tape MT2 for linear recording, the configuration in which the crystal orientation axis of the magnetic layer 515 is inclined in the longitudinal direction of the magnetic tape MT2 due to the head magnetic field at the time of recording can reduce the influence on the recording characteristics due to the inclination of the crystal orientation axis as compared with the configuration in which the crystal orientation axis of the magnetic layer 515 is inclined in the width direction of the magnetic tape MT2. In order to incline the crystal orientation axis of the magnetic layer 515 in the longitudinal direction of the magnetic tape MT2, it is preferable to set the inclination direction of the column structure of the first underlayer 732A to the longitudinal direction of the magnetic tape MT2 as described above.

An inclination angle of the column structure is preferably more than 0° and 600 or less. If the inclination angle is in a range of more than 0° and 60° or less, the change in the tip shape of the column included in the first underlayer 732A is large and becomes substantially triangular, such that the effect of the granular structure is enhanced, noise is reduced, and the SNR tends to be improved. On the other hand, if the inclination angle exceeds 60°, the change in the tip shape of the column included in the first underlayer 732A is small, and the column hardly has a substantially triangular shape, such that the low noise effect tends to be weakened.

An average particle size of the column structure is 3 nm or more and 13 nm or less. If the average particle size is less than 3 nm, the average particle size of the column structure included in the magnetic layer 515 is small, and thus the ability of the current magnetic material to hold recording may be deteriorated. On the other hand, if the average particle size is 13 nm or less, noise can be suppressed, and a more excellent SNR can be obtained.

An average thickness of the first underlayer 732A is preferably 10 nm or more and 150 nm or less. If the average thickness of the first underlayer 732A is 10 nm or more, the (111) orientation of the face-centered cubic lattice structure of the first underlayer 732A can be improved, and a more excellent SNR can be obtained. On the other hand, if the average thickness of the first underlayer 732A is 150 nm or less, it is possible to suppress an increase in the particle size of the column. Therefore, the noise can be suppressed, and a more excellent SNR can be obtained. Note that the average thickness of the first underlayer 732A is determined in a manner similar to that of the magnetic layer 43 in the first embodiment. However, magnification of the TEM image is appropriately adjusted according to the thickness of the first underlayer 732A.

The second underlayer 732B preferably has a crystal structure similar to that of the magnetic layer 515. In a case where the magnetic layer 515 contains a Co-based alloy, it is preferable that the second underlayer 732B contains a material having a hexagonal close-packed (hcp) structure similar to that of the Co-based alloy, and a c-axis of the structure is oriented in a direction perpendicular to the film surface (that is, a film thickness direction). This is because the orientation of the magnetic layer 515 can be enhanced, and a lattice constant matching between the second underlayer 732B and the magnetic layer 515 can be relatively preferable. As the material having a hexagonal close-packed structure, a material containing Ru is preferably used, and specifically, Ru alone or a Ru alloy is preferable. Examples of the Ru alloy include Ru alloy oxides such as Ru—SiO₂, Ru—TiO₂, Ru—ZrO₂, and the like.

An average thickness of the second underlayer 732B may be thinner than the underlayer (for example, an underlayer containing Ru) in a general magnetic recording medium, and can be, for example, 1 nm or more and 5 nm or less. Since the seed layer 731 and the first underlayer 732A having the configuration described above are provided below the second underlayer 732B, an excellent SNR can be obtained even if the average thickness of the second underlayer 732B is thin as described above. Note that the average thickness of the second underlayer 732B is determined in a manner similar to that of the magnetic layer 43 in the first embodiment. However, magnification of the TEM image is appropriately adjusted according to the thickness of the second underlayer 732B.

The average thickness t_{T}, the average width change amount ΔA, and the average tension responsiveness of the magnetic tape MT2 in the third embodiment are similar to those in the first embodiment.

(2) Operation and effect

In the magnetic tape MT2 according to the third embodiment, as in the first embodiment, even in a case where the magnetic tape MT2 is stored or traveled under a high-temperature environment for a long period of time (for example, 10 years), the width change of the magnetic tape MT2 can be corrected by adjusting the traveling tension of the magnetic tape MT2. Furthermore, even in a case where the width of the magnetic tape MT2 changes in a high-temperature environment, the width change can be handled by adjusting the azimuth angle θ of the drive head 36.

The magnetic tape MT2 according to the third embodiment includes a seed layer 731 and a first base layer 732A between the base 511 and the second base layer 732B. The seed layer 731 contains Cr, Ni, and Fe and has a face-centered cubic lattice structure, and a (111) plane of the face-centered cubic structure is preferentially oriented so as to be parallel to the surface of the base 511. The first underlayer 732A has a column structure containing Co and O, in which a ratio of an average atomic concentration of O to an average atomic concentration of Co is 1 or more, and an average particle size is 3 nm or more and 13 nm or less. Therefore, it is possible to realize a magnetic layer 515 having good crystal orientation and high coercive force without using Ru, which is an expensive material, as much as possible by reducing the thickness of the second underlayer 732B.

Ru contained in the second underlayer 732B has the same hexagonal close-packed lattice structure as Co which is a main component of the magnetic layer 515. Therefore, Ru has an effect of achieving both improvement in crystal orientation of the magnetic layer 515 and granularity promotion. Furthermore, in order to further improve the crystal orientation of Ru contained in the second underlayer 732B, the first underlayer 732A and the seed layer 731 are provided under the second underlayer 732B. In the magnetic tape MT2 according to the third embodiment, an effect (function) substantially similar to that of the second underlayer 732B containing Ru is realized by the first underlayer 732A containing inexpensive CoO having a face-centered cubic lattice structure. Therefore, the thickness of the second underlayer 732B can be reduced. Furthermore, in order to enhance the crystal orientation of the first underlayer 732A, a seed layer 731 containing Cr, Ni, and Fe is provided.

### (4) Modifications

### <Modification 1>

In the first embodiment described above, a case where the magnetic tape cartridge is the one-reel type cartridge 10 has been described; however, the magnetic tape cartridge may be a two-reel type cartridge.

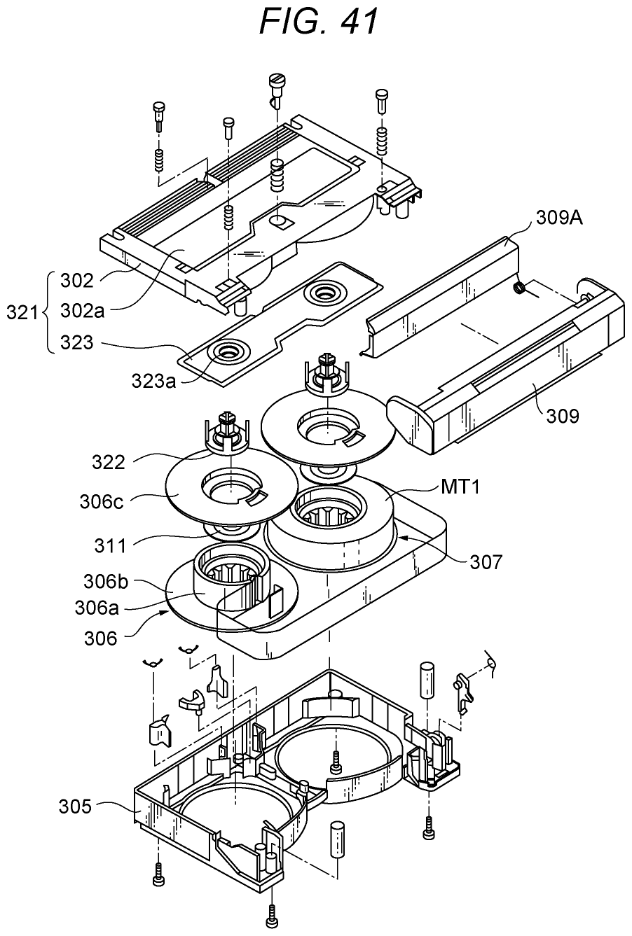

FIG. 41 is an exploded perspective view illustrating an example of a configuration of a two-reel cartridge 321. The cartridge 321 includes an upper half 302 including a synthetic resin, a transparent window member 323 fitted and fixed to a window portion 302a opened in an upper surface of the upper half 302, a reel holder 322 fixed to an inner side of the upper half 302 and preventing uplift of reels 306 and 307, a lower half 305 corresponding to the upper half 302, the reels 306 and 307 accommodated in a space formed by combining the upper half 302 and the lower half 305, a magnetic tape MT wound around the reels 306 and 307, a front lid 309 closing a front side opening formed by combining the upper half 302 and the lower half 305, and a back lid 309A protecting the magnetic tape MT exposed at the front side opening.

The reels 306 and 307 are for winding the magnetic tape MT. The reel 306 includes a lower flange 306b having a cylindrical hub portion 306a around which the magnetic tape MT is wound in a central portion, an upper flange 306c having substantially the same size as the lower flange 306b, and a reel plate 311 interposed between the hub portion 306a and the upper flange 306c. The reel 307 has a configuration similar to that of the reel 306.

The window member 323 is provided with attachment holes 323a at positions corresponding to the reels 306 and 307, respectively, for assembling the reel holder 322 as a reel holding unit for preventing the reels from being lifted up. The magnetic tape MT is similar to the magnetic tape MT in the first embodiment.

### <Modification 2>

The magnetic tape MT1 according to the second embodiment may further include an underlayer between the base 511 and the SUL 512. Since the SUL 512 has an amorphous state, it does not play a role of promoting epitaxial growth of a layer formed on the SUL 512, but is required not to disturb the crystal orientation of the first and second underlayers 514A and 514B formed on the SUL 512. For this reason, it is preferable that the soft magnetic material has a fine structure that does not form a column, but in a case where the influence of the release of gas such as moisture or the like from the base 511 is large, the soft magnetic material becomes coarse, and there is a possibility that the crystal orientation of the first and second underlayers 514A and 514B formed on the SUL 512 is disturbed. In order to suppress the influence of the release of gas such as moisture or the like from the base 511, it is preferable to provide an underlayer containing an alloy containing Ti and Cr and having an amorphous state between the base 511 and the SUL 512 as described above. As a specific configuration of the underlayer, a configuration similar to that of the first seed layer 513A of the second embodiment can be adopted.

The magnetic tape MT1 may not include at least one layer of the second seed layer 513B and the second underlayer 514B. However, from the viewpoint of improving the SNR, it is more preferable to include both the second seed layer 513B and the second underlayer 514B.

The magnetic tape MT1 may include an antiparallel coupled SUL (APC-SUL) instead of the single-layer SUL.

### 5. Examples

Hereinafter, the present technology will be described in detail with reference to Examples, but the present technology is not limited only to these Examples.

In the following Examples and Comparative Examples, the average width change amount ΔA, the average tension responsiveness ΔW, the average thickness of the base, the average thickness of the magnetic tape, the average thickness of the magnetic layer, the average thickness of the underlayer, the average thickness of the back layer, the squareness ratio S2 in the longitudinal direction, and the like are values obtained by the measurement method described in the first embodiment.

### Example 1

### (SUL Film Forming Step)

First, under the following film forming conditions, a CoZrNb layer (SUL) having an average thickness of 10 nm was formed on a surface of a long polymer film as a non-magnetic support. As the polymer film, a PEN film having an average thickness of 3.8 μm, an average storage elastic modulus in the longitudinal direction under an environment at a temperature of 50 °C of 5.5 GPa, and an average Young's modulus in the longitudinal direction of 6.3 GPa was used.
Film forming method: DC magnetron sputtering method
Target: CoZrNb target
Gas type: Ar
Gas pressure: 0.1 Pa

### (First Seed Layer Forming Step)

Next, a TiCr layer (first seed layer) having an average thickness of 5 nm was formed on the CoZrNb layer under the following film forming conditions.
Sputtering method: DC magnetron sputtering method
Target: TiCr target
Ultimate degree of vacuum: 5×10⁻⁵ Pa
Gas type: Ar
Gas pressure: 0.5 Pa

### (Second Seed Layer Forming Step)

Next, a NiW layer (second seed layer) having an average thickness of 10 nm was formed on the TiCr layer under the following film forming conditions.
Sputtering method: DC magnetron sputtering method
Target: NiW target
Ultimate degree of vacuum: 5×10⁻⁵ Pa
Gas type: Ar
Gas pressure: 0.5 Pa

### (First Underlayer Forming Step)

Next, a Ru layer (first underlayer) having an average thickness of 10 nm was formed on the NiW layer under the following film forming conditions.
Sputtering method: DC magnetron sputtering method
Target: Ru target
Gas type: Ar
Gas pressure: 0.5 Pa

### (Second Underlayer Forming Step)

Next, on the Ru layer, a Ru layer (second underlayer) having an average thickness of 20 nm was formed under the following film forming conditions.
Sputtering method: DC magnetron sputtering method
Target: Ru target
Gas type: Ar
Gas pressure: 1.5 Pa

### (Magnetic Layer Forming Step)

Next, a (CoCrPt)—(SiO₂) layer (magnetic layer) having an average thickness of 9 nm was formed on the Ru layer under the following film forming conditions.
Film forming method: DC magnetron sputtering method
Target: (CoCrPt)—(SiO₂) target
Gas type: Ar
Gas pressure: 1.5 Pa

### (Protective Layer Forming Step)

Next, a carbon layer (protective layer) having an average thickness of 5 nm was formed on the magnetic layer under the following film forming conditions.
Film forming method: DC magnetron sputtering method
Target: carbon target
Gas type: Ar
Gas pressure: 1.0 Pa

### (Lubricating Layer Forming Step)

Next, a lubricant was applied onto the protective layer to form a lubricating layer.

### (Back Layer Forming Step)

Next, the back layer forming paint was applied onto the other principal surface of the polymer film and dried to form the back layer having an average thickness t_{b} of 0.3 μm. As a result, a magnetic tape having an average thickness t_{T} of 4.2 μm was obtained.

### (Cutting Step)

The magnetic tape obtained as described above was cut into a width of ½ inch (12.65 mm). With this, a target elongated magnetic tape (average thickness: 4.2 μm) was obtained.

### (Demagnetization Step and Servo Pattern Writing Step)

Next, after demagnetization of the magnetic tape is performed, the servo pattern was written on the magnetic tape. The servo pattern included a first servo pattern and a second servo pattern asymmetric with respect to the width direction of the magnetic tape. Furthermore, the servo patterns in the servo bands adjacent to each other had a phase difference.

In Example 1, the average width change amount ΔA and the average tension responsiveness OW were set to the values shown in Table 1 by using a sputtered film as the magnetic layer, using a PEN film as the polymer film, and adjusting the stretching strength of the PEN film in the width direction and the longitudinal direction.

### Example 2

As a polymer film, a reinforced PET film having an average thickness of 3.8 μm, an average storage elastic modulus in the longitudinal direction at a temperature of 50 °C of 3.9 GPa, and an average Young's modulus in the longitudinal direction of 4.6 GPa was used. Here, the reinforced PET film means a film reinforced by adding a polyamide to the PET film. A sputtered film was used as the magnetic layer, a reinforced PET film was used as the polymer film, and the stretching strength in the width direction and the longitudinal direction of the reinforced PET film was adjusted to set the average width change amount ΔA and the average tension responsiveness ΔW to the values shown in Table 1.

Other than the above, the magnetic tape having an average thickness of 4.2 μm was obtained in a manner similar to that in Example 1.

### Example 3

### (Step of Preparing Magnetic Layer Forming Coating Material)

A coating material for forming a magnetic layer was prepared as follows. First, a first composition having the following formulation was kneaded with an extruder. Next, the kneaded first composition and a second composition having the following formulation were added to a stirring tank equipped with a disperser and premixing was performed. Subsequently, sand mill mixing was further performed, and filter treatment was performed to prepare a coating material for forming a magnetic layer.

### (First Composition)

Barium ferrite (BaFe₁₂O₁₉) magnetic powder (hexagonal plate shape, average aspect ratio: 3.0, average particle volume: 1,600 nm³): 100 parts by mass
Vinyl chloride-based resin (cyclohexanone solution: mass %): 35 parts by mass
(vinyl chloride-based resin: degree of polymerization 300, number average molecular weight Mn=10,000, containing OSO:K=0.07 mmol/g, and secondary OH=0.3 mmol/g as a polar group)
Polyurethane resin (resin solution: amount of polyurethane resin blended: 30 mass %, amount of cyclohexanone blended: 70 mass %): 10 parts by mass
(Polyurethane resin: number average molecular weight Mn=25000, glass transition temperature Tg=110 °C) Aluminum oxide powder: 6 parts by mass (α-Al₂O₃, average particle size 0.1 μm)

### (Second Composition)

Carbon black: 2.0 parts by mass (manufactured by TOKAI CARBON CO., LTD., trade name: SEAST S, arithmetic average particle size 70 nm)
Polyurethane resin (resin solution: amount of polyurethane resin blended: 30 mass %, amount of cyclohexanone blended: 70 mass %): 5.0 parts by mass
(Polyurethane resin: number average molecular weight Mn=25000, glass transition temperature Tg=110 °C) n-butyl stearate: 2 parts by mass
Methyl ethyl ketone: 121.0 parts by mass
Toluene: 121.0 parts by mass
Cyclohexanone: 116.0 parts by mass

Finally, 3.3 parts by mass of polyisocyanate (trade name: Coronate L, manufactured by Tosoh Corporation) as a curing agent and 2 parts by mass of stearic acid were added to the coating material for forming a magnetic layer prepared as described above.

### (Step of Preparing Underlayer Forming Paint)

A paint for forming an underlayer was prepared as follows. First, a third composition having the following formulation was kneaded with an extruder. Next, the kneaded third composition and a fourth composition having the following formulation were added to a stirring tank equipped with a disperser, and premixing was performed. Subsequently, dyno mill mixing was further performed and filter treatment was performed to prepare the underlayer forming paint.

### (Third Composition)

Acicular iron oxide powder: 100 parts by mass
(α-Fe₂O₃, average long axis length 0.11 μm)
Vinyl chloride-based resin (cyclohexanone solution 30 mass %): 46 parts by mass
(vinyl chloride-based resin: degree of polymerization 300, number average molecular weight Mn=10,000, containing OSO₃K=0.07 mmol/g, and secondary OH=0.3 mmol/g as a polar group)
Aluminum oxide powder: 3 parts by mass (α-Al₂O₃, average particle diameter: 0.1 μm)

### (Fourth Composition)

Carbon black (manufactured by Asahi Carbon Co., Ltd., trade name: #80): 30 parts by mass
Polyurethane resin (resin solution: amount of polyurethane resin blended: 30 mass %, amount of cyclohexanone blended: 70 mass %): 40 parts by mass
(Polyurethane resin: number average molecular weight Mn=25000, glass transition temperature Tg=70 °C) n-butyl stearate: 2 parts by mass
methyl ethyl ketone: 108.2 parts by mass
Toluene: 108.2 parts by mass
Cyclohexanone: 100.0 parts by mass

Finally, 1.5 parts by mass of polyisocyanate (trade name: Coronate L, manufactured by Tosoh Corporation) as a curing agent and 1.5 parts by mass of stearic acid were added to the paint for forming an underlayer prepared as described above.

### (Step of Preparing Back Layer Forming Paint)

A paint for forming a back layer was prepared as follows. The following raw materials were mixed in a stirring tank equipped with a disper and subjected to filter treatment to prepare the back layer forming paint. Carbon black (manufactured by Asahi Carbon Co., Ltd., trade name: #80): 100 parts by mass
polyester polyurethane: 100 parts by mass
(manufactured by Nippon Polyurethane Industry Co., Ltd., trade name: N-2304)
Methyl ethyl ketone: 500 parts by mass
Toluene: 400 parts by mass
cyclohexanone: 100 parts by mass

### (Film Forming Step)

Using the paint prepared as described above, an underlayer and a magnetic layer were formed on one principal surface of a long polymer film as a nonmagnetic support in the following manner.

Next, the magnetic layer forming paint was applied onto the underlayer and dried to form the magnetic layer on the underlayer. At this time, the coating conditions were adjusted so that the average thickness of the base layer after the calendering treatment was 0.8 μm. As the polymer film, PEN having an average thickness of 4.0 μm was used.

Next, the magnetic layer forming coating material was applied onto the underlayer and dried to form the magnetic layer on the underlayer. At this time, the coating conditions were adjusted so that the average thickness of the magnetic layer after the calendering treatment was 0.08 μm. During drying of the magnetic layer forming paint, the magnetic powder was magnetically oriented in the thickness direction of the polymer film by the neodymium magnet. Drying conditions (drying temperature and drying time) of the magnetic layer forming coating material were adjusted, and the squareness ratio in the longitudinal direction was set to 33%.

Subsequently, the paint for forming a back layer was applied onto the other principal surface of the PEN film on which the underlayer and the magnetic layer were formed, the paint was dried, and thus a back layer was formed so that the back layer in a final product had an average thickness of 0.30 μm. At this time, the coating conditions were adjusted so that the average thickness of the back layer after the calendering treatment was 0.32 μm. With this, the magnetic tape was obtained.

### (Curing Step)

After the magnetic tape is wound into a roll shape, the magnetic tape is heated in this state to cure the underlayer and the magnetic layer.

### (Calendering Step)

Next, the obtained magnetic tape MT is subjected to calender treatment to smooth the surface of the magnetic layer.

### (Cutting Step)

The magnetic tape obtained as described above was cut into a width of ½ inch (12.65 mm). With this arrangement, a target elongated magnetic tape (average thickness: 5.2 μm) was obtained.

### (Demagnetization Step and Servo Pattern Writing Step)

Next, after demagnetization of the magnetic tape is performed, the servo pattern was written on the magnetic tape. The servo pattern included a first servo pattern and a second servo pattern asymmetric with respect to the width direction of the magnetic tape. Furthermore, the servo patterns in the servo bands adjacent to each other had a phase difference.

In Example 3, the coating film was used as the magnetic layer, the PEN film was used as the polymer film, and the stretching strength in the width direction and the longitudinal direction of the PEN film was adjusted, so that the average width change amount ΔA and the average tension responsiveness ΔW were set to the values shown in Table 1.

### Example 4

The stretching strength in the width direction and the longitudinal direction of the PEN film was adjusted, and after the calendering step, a strain relaxation treatment (held in an environment at 60 °C for 48 hours) was performed. As a result, the average width change amount ΔA and the average tension responsiveness ΔW were set to the values shown in Table 1.

Other than the above, the magnetic tape having an average thickness of 5.2 μm was obtained in a manner similar to that in Example 3.

### Comparative Example 11

As a polymer film, a PET film having an average thickness of 4.8 μm, an average storage elastic modulus in the longitudinal direction under an environment at a temperature of 50 °C of 3.9 GPa, and an average Young's modulus in the longitudinal direction of 4.7 GPa was used. The average width change amount ΔA and the average tension responsiveness OW were set to the values shown in Table 1 by using a sputtered film as the magnetic layer, using a PET film as the polymer film, and adjusting the stretching strength of the PET film in the width direction and the longitudinal direction.

Other than the above, the magnetic tape having an average thickness of 5.2 μm was obtained in a manner similar to that in Example 1.

### Comparative Example 2

By adjusting the stretching strength in the width direction and the longitudinal direction of the PEN film, the average width change amount ΔA and the average tension responsiveness OW were set to the values shown in Table 1.

Other than the above, the magnetic tape having an average thickness of 5.2 μm was obtained in a manner similar to that in Example 3.

### Comparative Example 3

As the polymer film, a reinforced PET film having an average thickness of 4.6 μm was used.

By adjusting the stretching strength in the width direction and the longitudinal direction of the reinforced PET film, the average width change amount ΔA and the average tension responsiveness OW were set to the values shown in Table 1.

Other than the above, the magnetic tape having an average thickness of 5.6 μm was obtained in a manner similar to that in Example 3.

### Comparative Example 4

As the polymer film, a reinforced PET film having an average thickness of 4.0 μm was used.

By adjusting the stretching strength in the width direction and the longitudinal direction of the reinforced PET film, the average width change amount ΔA and the average tension responsiveness OW were set to the values shown in Table 1.

Other than the above, the magnetic tape having an average thickness of 5.2 μm was obtained in a manner similar to that in Example 3.

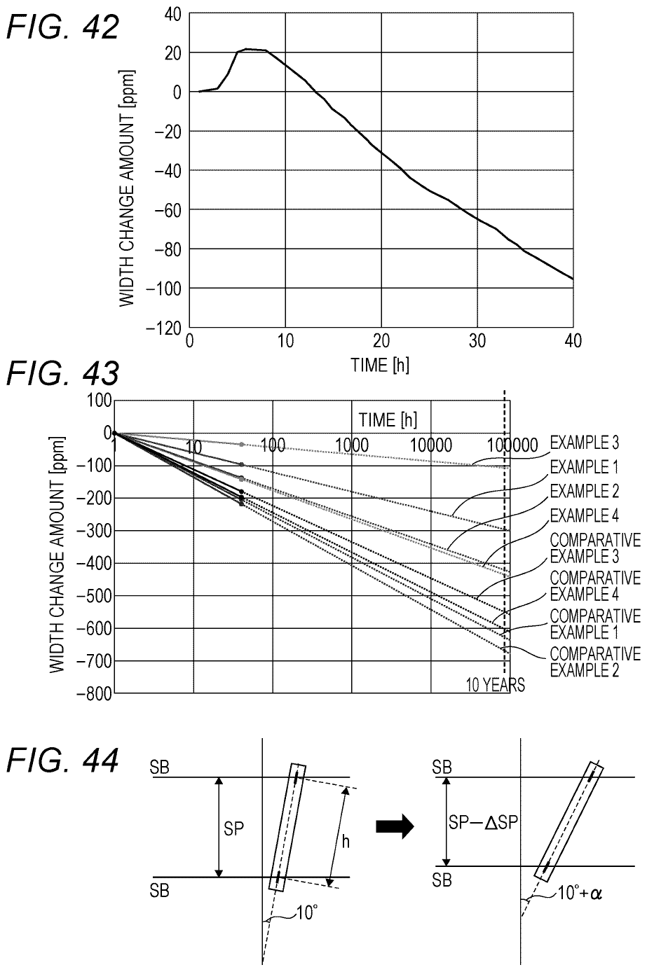

Each of the magnetic recording tapes of Examples 1 to 4 and Comparative Examples 1 to 4 was evaluated. Specifically, for each of the magnetic recording tapes, the average width change amount ΔA, the average tension responsiveness ΔW, the average thickness of the magnetic tape, the average thickness of the substrate, the squareness ratio S2 of the magnetic layer in the longitudinal direction of the magnetic tape, and the average Young's modulus in the longitudinal direction of the magnetic tape were measured. These are obtained by the measurement method described in the above 1.(2). These measurement results are described in Table 1. Furthermore, FIG. 42 is a graph illustrating a measurement result of a width change amount of the magnetic tape according to Example 1.

For each of the magnetic recording tapes of Examples 1 to 4 and Comparative Examples 1 to 4, the servo band pitch difference was measured by the measurement method described in the above 1.(4). Furthermore, for each of the magnetic recording tapes of Examples 1 to 4 and Comparative Examples 1 to 4, the width change amount assuming 10 years, the tension necessary for adjusting the width change assuming 10 years, and the movement angle of the drive head disposed in an inclined manner were calculated. These calculation methods will be described below.

### [Calculation Method of Amount of Width Change Assuming 10 Years]

In accordance with the measurement method of the average width change amount ΔA described in the above 1.(2), the width change amount after 1 hour and the width change amount after 40 hours from the start of the width measurement were measured for the three samples acquired from the magnetic tape. The width change amounts of the three samples after one hour were arithmetically averaged to obtain an average width change amount after one hour from the start of measurement. Furthermore, the width change amounts of the three samples after 40 hours were arithmetically averaged to obtain an average width change amount after 40 hours from the start of the measurement. With the time axis X as a logarithm, the change in width after 10 years was assumed by extrapolating from the average width change amount after 1 hour from the start of measurement (this is defined as an initial value 0) and the average width change amount after 40 hours. FIG. 43 is a graph illustrating a width change amount assuming years in each of Examples and Comparative Examples.

### [Calculation Method of Tension Necessary for Adjusting Width Change Assuming 10 Years]

The measurement environment of LTO7 Drive was fixed at 32 °C and 55%.

The cartridge was stored while being wound around the cartridge at a tension of 0.55 N. Note that the measurement was started after 1 hour under each environment.

The number of measurements was 1 time/day, and measurement was performed for 14 days.

The measurement band was a DBO portion in the normal Creep evaluation.

Assumption after 10 years

From the storage time and the creep change amount, a Creep rate was calculated from the point at the start of measurement and the point 14 days later (336 hours) by an approximate expression.

From this Creep rate, 10 years later (87600 hrs) was calculated.

The tension is required to adjust the width change assuming that the creep change amount/tension responsiveness after 10 years=10 years.

### [Measurement Method of Servo Band Pitch]

By the measurement method described in 1.(4) described above, the magnetic tape runs by the tape drive device, each of the servo trace lines T on each servo band of the two servo read heads is measured, and the servo band pitch is measured from the relative position of each measured servo trace line T to the servo pattern.

### [Calculation Method of Movement Angle of Drive Head Disposed in Inclined Manner]

FIG. 44 is a schematic diagram for explaining a calculation method of a movement angle of a drive head disposed in an inclined manner. The movement angle is a movement angle of the drive head necessary for coping with a width change assuming 10 years.

The left side of FIG. 44 illustrates an interval (h) between two servo read heads of the drive head, a servo band pitch (SP), and an inclination angle (10°) of the drive head in the initial (before width change) magnetic tape. In the case of the left side of FIG. 44, Cos 10°=SP/h.

On the right side of FIG. 44, the servo band pitch (SP−ΔSP), the movement angle (α) of the drive head, and the inclination angle (100+α) after the movement of the drive head in the magnetic tape after the servo band pitch is narrowed (after the width change) are illustrated. In the case on the right side of FIG. 44, Cos(10°+α)=(SP−ΔSP)/h. From this formula, the movement angle (α) of the drive head is calculated as follows.

10°+α=Cos−1[(SP−ΔSP)/h]

α=Cos−1[(SP−ΔSP)/h]−10°

These calculation results are shown in Table 1.

TABLE 1

| | 50 °C | | | | | | | | | | Tension | Movement |
|---|---|---|---|---|---|---|---|---|---|---|---|---|
| | Average | | | | | | | | | Width | necessary | angle of |
| | width | 50 °C | | | | | Square- | | Tension | change | for | drive head |
| | change | Average | | | | | ness | Servo | necessary | amount | adjusting | disposed in |
| | amount | tension | | Magnetic | Base | | ratio in | band | for | assuming | width | inclined |
| | absolute | respon- | | tape | average | | longi- | pitch | adjusting | 10 years | change | manner |
| | value | siveness | Magnetic | average | thick- | | tudinal | differ- | width | absolute | assuming | (initial |
| | ΔA | ΔW | layer | thickness | ness | Base | direction | ence | change | value | 10 years | inclination |
| | (ppm) | (ppm/N) | type | (μm) | (μm) | material | (%) | (μm) | (N) | (ppm) | (N) | angle 10°) |
| Example 1 | 97.7 | 759 | Spatter | 4.2 | 3.8 | PEN | 4.7 | 0.095 | −0.13 | 303 | −0.40 | 0.095° |
| Example 2 | 138.2 | 715 | Spatter | 4.2 | 3.8 | PET | 4.7 | 0.095 | −0.19 | 428 | −0.60 | 0.140° |
| Example 3 | 35.4 | 715 | Coating | 5.2 | 4.0 | PEN | 33 | 0.095 | −0.04 | 110 | −0.12 | 0.028° |
| Example 4 | 142.8 | 841 | Coating | 5.2 | 4.0 | PEN | 30 | 0.095 | −0.18 | 443 | −0.56 | 0.151° |
| Comparative | 206.2 | 618 | Spatter | 5.2 | 4.8 | PET | 4.7 | 0.095 | −0.33 | 639 | −1.03 | 0.208° |
| Example 1 | | | | | | | | | | | | |
| Comparative | 220.0 | 759 | Coating | 5.2 | 4.0 | PEN | 37 | 0.095 | −0.29 | 682 | −0.90 | 0.219° |
| Example 2 | | | | | | | | | | | | |
| Comparative | 180.7 | 715 | Coating | 5.6 | 4.6 | PET | 38 | 0.095 | −0.25 | 560 | −0.78 | 0.181° |
| Example 3 | | | | | | | | | | | | |
| Comparative | 198.2 | 802 | Coating | 5.2 | 4.0 | PET | 33 | 0.095 | −0.25 | 614 | −0.77 | 0.208° |
| Example 4 | | | | | | | | | | | | |

As shown in Table 1, the magnetic tape of each of Examples 1 to 4 is a magnetic tape satisfying the conditions that the absolute value of the average width change amount DA is 170 ppm or less, the average tension responsiveness ΔW is 700 ppm/N or more, and the average value of the differences between two adjacent servo band pitches in a plurality of servo bands over the entire length of the magnetic recording medium is 100 nm or less. Comparative Examples 1 to 4 is a magnetic tape not satisfying this condition.

In the tape drive device, it is considered that it is practically difficult to adjust the tension having an absolute value exceeding 0.75 N. In the case of Comparative Examples 1 to 4, the absolute value of the tension necessary for adjusting the width change assuming years exceeds 0.75 N. Therefore, in the case of the magnetic tape of Comparative Examples 1 to 4, it is considered difficult to correct the width change assumed after 10 years by adjusting the tension. On the other hand, in the case of Examples 1 to 4, the absolute value of the tension required to adjust the width change assuming 10 years is 0.56 N or less. Therefore, in the case of the magnetic tape of Examples 1 to 4, it is considered that the width change assumed after 10 years can be corrected by adjusting the tension.

From these results, it is considered that by setting the absolute value of the average width change amount ΔA to 170 ppm or less and setting the average tension responsiveness OW to 700 ppm/N or more, the width change of the magnetic tape can be corrected by adjusting the tension even in a case where the magnetic tape is stored or traveled under a high-temperature environment for a long period of time (for example, 10 years).

When the absolute value of the width change amount assuming 10 years exceeds 500 ppm (when the absolute value of the width change amount exceeds 500 ppm), there is a possibility that the movement angle of the drive head becomes excessively large in a case where all factors (for example, a change in temperature and humidity or the like) other than creep deformation that causes the width change are considered. That is, when an attempt is made to cope with the width change after 10 years caused by the creep deformation and other factors (for example, a change in temperature and humidity or the like) by adjusting the angle of the drive head, the movement angle of the drive head may become too large. If the movement angle becomes too large, the followability of the drive head deteriorates, and there is a possibility that it is not possible to sufficiently cope with the width change of the magnetic tape.

In the case of the magnetic tape of Examples 1 to 4, since the absolute value of the width change amount assuming 10 years does not exceed 500 ppm, it is considered that the width change assumed 10 years later can be handled by adjusting the angle of the drive head. Therefore, it is considered that the magnetic tape of the present technology can cope with the width change of the magnetic tape by adjusting the angle of the drive head even in a case where the magnetic tape is stored or traveled under a high-temperature environment for a long period of time (for example, 10 years).

Although the embodiments and the modifications thereof of the present technology are specifically described above, the present technology is not limited to the above-described embodiments and modifications, and various modifications based on the technical idea of the present technology may be made. For example, configurations, methods, processes, shapes, materials, numerical values, and the like in the above-described embodiments and modifications are merely examples, and different configurations, methods, processes, shapes, materials, numerical values, and the like may be employed as necessary. The configurations, methods, processes, shapes, materials, numerical values, and the like of the above-described embodiments and modifications can be combined with each other without departing from the gist of the present technology.

The present technology can also employ the following configurations.

[1]

A magnetic recording medium formed in a tape shape, the magnetic recording medium including a magnetic layer including a plurality of servo bands in which a plurality of servo patterns adjacent in a width direction is recorded, in which
an absolute value of an average width change amount of the magnetic recording medium before and after being left still for 40 hours in an environment of a temperature of 50 °C and a relative humidity of 40% RH in a state where a tension of 0.55 N per ½ inch of a width of the magnetic recording medium is applied in a longitudinal direction is 170 ppm or less, and an average tension responsiveness to the tension in the longitudinal direction in the environment of a temperature of 50 °C and a relative humidity of 40% RH is 700 ppm/N or more, and
an average value of a difference between two adjacent servo band pitches over an entire length of the magnetic recording medium in the plurality of servo bands is 100 nm or less.
   [2]

The magnetic recording medium according to [1], in which the average tension responsiveness is 715 ppm/N or more and 15000 ppm/N or less.

[3]

The magnetic recording medium according to [1] or [2], in which the absolute value of the average width change amount is 140 ppm or less.

[4]

The magnetic recording medium according to any one of [1] to [3], further including a base, an underlayer, and a magnetic layer sequentially, in which
the base includes polyesters.
   [5]

The magnetic recording medium according to any one of [1] to [4], in which the polyesters include at least one selected from the group consisting of polyethylene terephthalate and polyethylene naphthalate.

[6]

The magnetic recording medium according to [4] or [5], in which an average thickness of the base is 4.4 μm or less.

[7]

The magnetic recording medium according to any one of [1] to [6], in which the magnetic layer includes a vacuum thin film.

[8]

The magnetic recording medium according to any one of [1] to [6], in which the magnetic layer includes a coating film.

[9]

The magnetic recording medium according to [8], in which the magnetic layer includes magnetic powder.

[10]

The magnetic recording medium according to [9], in which the magnetic powder includes ε iron oxide magnetic powder, hexagonal ferrite magnetic powder, or Co-containing spinel ferrite magnetic powder.

[11]

The magnetic recording medium according to any one of [4] to [10], in which an average thickness of the magnetic layer is 90 nm or less.

[12]

The magnetic recording medium according to any one of [4] to [11], in which an average thickness of the underlayer is 1.0 μm or less.

[13]

The magnetic recording medium according to any one of [1] to [12], in which an average thickness of the magnetic recording medium is 5.3 μm or less.

[14]

The magnetic recording medium according to any one of [1] to [13], in which a squareness ratio of the magnetic layer in the longitudinal direction of the magnetic recording medium is 35% or less.

[15]

The magnetic recording medium according to any one of [1] to [14], in which the magnetic layer includes five or more servo bands.

[16]

The magnetic recording medium according to [15], in which a width of each of the servo bands is 98 μm or less.

[17]

The magnetic recording medium according to any one of [1] to [16], in which the magnetic layer is configured to be able to form a plurality of data tracks, and a width of each of the data tracks is 1100 nm or less.

[18]

The magnetic recording medium according to any one of [1] to [17], in which a Young's modulus is 8 GPa or less.

[19]

A manufacturing method of a magnetic recording medium in which a plurality of servo patterns adjacent in a width direction of the magnetic recording medium is recorded on a magnetic layer of the magnetic recording medium, the manufacturing method of the magnetic recording medium including: running the magnetic recording medium, and individually adjusting temperatures of a plurality of recording sections of a servo write head; and
recording the plurality of servo patterns on the magnetic layer by the plurality of recording sections.
   [20]

A cartridge including: the magnetic recording medium according to [1]; and a storage section configured to be able to write adjustment information for adjusting a tension applied in a longitudinal direction of the magnetic recording medium.

### REFERENCE SIGNS LIST

MT Magnetic tape
5 Recording track
6 Servo pattern
9 Cartridge memory
10 Tape cartridge
10S Sample
11 Cartridge case
11a Upper shell
11b Lower shell
13 Tape reel
14 Opening
15 Metal plate
16 Reel spring
17 Reel lock member
18 Spider
19 Tape lead-out port
20 Slide door
21 Torsion spring
22 Leader pin
23 Pin holding portion
24 Elastic holding tool
25 Safety tab
30 Tape drive device
31 Spindle
32 Winding reel
33 Spindle driving device
34 Reel driving device
35 Guide roller
36 Drive head
36a First drive head
36b Second drive head
37 Reader/writer
38 Control device
39 Thermometer
40 Hygrometer
41 Base
42 Underlayer
43 Magnetic layer
44 Back layer
70 Coil
80 Temperature adjustment section
91 Blowing block
91a Gas ejection port
92a Gas ejection port
92L Positioning block
92R Positioning block
93 Shield plate
94 Valve mechanism
95 Groove portion
96 Cutout portion
G1 Corner groove
T1 Top portion
100 Servo pattern recording device
111 Feeding roller
112 Pre-processing section
112a Permanent magnet
113 Servo write head
114 Reproducing head unit
115 Winding roller
120 Drive section
121 Converter
122 Signal generation section
123 Amplifier
130 Controller
131 Head main body
132 Servo read head
133 Data write/read head
134 Data write head
135 Data read head
141 Guide roller
142 Guide roller
231 Fixing portion
232₁ First support member
232₂ Second support member
232₃ Third support member
232₄ Fourth support member
232₅ Fifth support member
232A Slit
233 Weight
234 Light emitter
235 Light receiver
L Light
321 Cartridge
302 Upper half
302a Window
305 Lower half
306 Reel
306a Hub portion
306b Lower flange
306c Upper flange
307 Reel
309 Front lid
309A Back lid
311 Reel plate
322 Reel holder
323 Window member
323a Mounting hole
401 Recording section
402 Head block
411 First region
412 Second region
511 Base
512 SUL
513A First seed layer
513B Second seed layer
514A First underlayer
514B Second underlayer
515 Magnetic layer
516 Protective layer
517 Lubricating layer
518 Back layer
601 First servo pattern
602 Second servo pattern
620 Sputtering device
621 Film formation chamber
622 Drum
623a Cathode
623b Cathode
623c Cathode
623d Cathode
623e Cathode
623f Cathode
624 Supply reel
625 Winding reel
626 Exhaust port
627a Guide roller
627b Guide roller
627c Guide roller
628a Guide roller
628b Guide roller
628c Guide roller
731 Seed layer
732A First underlayer
732B Second underlayer

1. A magnetic recording medium formed in a tape shape, the magnetic recording medium comprising a magnetic layer including a plurality of servo bands in which a plurality of servo patterns adjacent in a width direction is recorded, wherein
an absolute value of an average width change amount of the magnetic recording medium before and after being left still for 40 hours in an environment of a temperature of 50 °C and a relative humidity of 40% RH in a state where a tension of 0.55 N per ½ inch of a width of the magnetic recording medium is applied in a longitudinal direction is 170 ppm or less, and an average tension responsiveness to the tension in the longitudinal direction in the environment of a temperature of 50 °C and a relative humidity of 40% RH is 700 ppm/N or more, and
an average value of a difference between two adjacent servo band pitches over an entire length of the magnetic recording medium in the plurality of servo bands is 100 nm or less.

2. The magnetic recording medium according to claim 1, wherein the average tension responsiveness is 715 ppm/N or more and 15000 ppm/N or less.

3. The magnetic recording medium according to claim 1, wherein the absolute value of the average width change amount is 140 ppm or less.

4. The magnetic recording medium according to claim 1, further comprising a base, an underlayer, and a magnetic layer sequentially, wherein
the base includes polyesters.

5. The magnetic recording medium according to claim 4, wherein the polyesters include at least one selected from a group consisting of polyethylene terephthalate and polyethylene naphthalate.

6. The magnetic recording medium according to claim 4, wherein an average thickness of the base is 4.4 μm or less.

7. The magnetic recording medium according to claim 1, wherein the magnetic layer includes a vacuum thin film.

8. The magnetic recording medium according to claim 1, wherein the magnetic layer includes a coating film.

9. The magnetic recording medium according to claim 8, wherein the magnetic layer includes magnetic powder.

10. The magnetic recording medium according to claim 9, wherein the magnetic powder includes ε iron oxide magnetic powder, hexagonal ferrite magnetic powder, or Co-containing spinel ferrite magnetic powder.

11. The magnetic recording medium according to claim 1, wherein an average thickness of the magnetic layer is 90 nm or less.

12. The magnetic recording medium according to claim 4, wherein an average thickness of the underlayer is 1.0 μm or less.

13. The magnetic recording medium according to claim 1, wherein an average thickness of the magnetic recording medium is 5.3 μm or less.

14. The magnetic recording medium according to claim 1, wherein a squareness ratio of the magnetic layer in the longitudinal direction of the magnetic recording medium is 35% or less.

15. The magnetic recording medium according to claim 1, wherein the magnetic layer includes five or more servo bands.

16. The magnetic recording medium according to claim 1, wherein a width of each of the servo bands is 98 μm or less.

17. The magnetic recording medium according to claim 1, wherein the magnetic layer is configured to be able to form a plurality of data tracks, and a width of each of the data tracks is 1100 nm or less.

18. The magnetic recording medium according to claim 1, wherein a Young's modulus is 8 GPa or less.

19. A manufacturing method of a magnetic recording medium in which a plurality of servo patterns adjacent in a width direction of the magnetic recording medium is recorded on a magnetic layer of the magnetic recording medium, the manufacturing method of the magnetic recording medium comprising: running the magnetic recording medium, and individually adjusting temperatures of a plurality of recording sections of a servo write head; and
recording the plurality of servo patterns on the magnetic layer by the plurality of recording sections.

20. A cartridge comprising: the magnetic recording medium according to claim 1; and a storage section configured to be able to write adjustment information for adjusting a tension applied in a longitudinal direction of the magnetic recording medium.
